(19) United States
(12) Patent Application Publication
(10) Pub. No.: US 2021/0045150 A1
(43) Pub. Date: Feb. 11, 2021

(54) METHOD FOR PROVIDING LOW LATENCY SERVICE IN COMMUNICATION SYSTEM AND APPARATUS FOR THE SAME

(71) Applicant: ELECTRONICS AND TELECOMMUNICATIONS RESEARCH INSTITUTE, Daejeon (KR)

(72) Inventors: Eun Kyung KIM, Daejeon (KR); Hyun Seo PARK, Daejeon (KR); An Seok LEE, Daejeon (KR); Yu Ro LEE, Daejeon (KR); Hyun LEE, Daejeon (KR); Hee Soo LEE, Daejeon (KR)

(73) Assignee: ELECTRONICS AND TELECOMMUNICATIONS RESEARCH INSTITUTE, Daejeon (KR)

(21) Appl. No.: 17/082,932

(22) Filed: Oct. 28, 2020

Related U.S. Application Data
(63) Continuation of application No. 16/197,317, filed on Nov. 20, 2018.

(30) Foreign Application Priority Data
Nov. 21, 2017 (KR) 10-2017-0155854
Jan. 4, 2018 (KR) 10-2018-0001382
Nov. 14, 2018 (KR) 10-2018-0139647

(51) Int. Cl. H04W 72/12; H04W 72/04; H04L 5/00; H04L 1/18

(52) U.S. Cl. CPC H04W 72/1289; H04L 1/1812; H04L 5/0055; H04W 72/0446

(57) ABSTRACT

Disclosed are a method and an apparatus for providing low-latency services in a communication system. A downlink communication method may comprise receiving downlink control information (DCI) including resource allocation information from a base station through a control channel of a subframe #n; receiving downlink data from the base station through a data channel of a subframe #n+k indicated by the resource allocation information included in the DCI; and transmitting a first hybrid automatic repeat request (HARQ) response for the downlink data to the base station through a control channel of a subframe #n+k+l. Thus, the performance of the communication system can be improved.

### CROSS-REFERENCE TO RELATED APPLICATIONS

This application is a Continuation application of co-pending U.S. application Ser. No. 16/197,317, filed on Nov. 20, 2018, and claims priorities to Korean Patent Applications No. 10-2017-0155854 filed on Nov. 21, 2017, No. 10-2018-0001382 filed on Jan. 4, 2018, and No. 10-2018-0139647 filed on Nov. 14, 2018 in the Korean Intellectual Property Office (KIPO), the entire contents of which are hereby incorporated by reference.

### BACKGROUND

### 1. Technical Field

The present disclosure relates to techniques for supporting low-latency services in a communication system, and more specifically, to management and control techniques for reducing a transmission latency.

### 2. Related Art

With the development of information and communication technology, various wireless communication technologies are being developed. Typical wireless communication technologies include long term evolution (LTE), new radio (NR), etc. defined in the 3rd generation partnership project (3GPP) standard. The LTE may be one of the fourth generation (4G) wireless communication technologies, and the NR may be one of the fifth generation (5G) wireless communication technologies.

The 5G communication system (e.g., the communication system supporting the NR) using a frequency band (e.g., frequency band above 6 GHz) higher than a frequency band (e.g., frequency band below 6 GHz) of the 4G communication system (e.g., the communication system supporting the LTE) as well as the frequency band of the 4G communication system is being considered for processing of rapidly increasing wireless data after commercialization of the 4G communication system. The 5G communication system can support enhanced mobile broadband (eMBB) services, ultra-reliable and low-latency communication (URLLC) service, and massive machine type communication (mMTC) services.

There is a need for a method to improve the quality of the communication service as the number of users of the communication system increases. In order to improve the quality of the communication service, a method for reducing transmission latency, a method for improving reliability by improving transmission and retransmission performance of data, a method for providing communication services having flexibility and scalability in consideration of characteristics of terminals and characteristics of the communication services, a method for providing communication services by reflecting a frequency operation regulation and frequency characteristics of frequency bands, and a method for transmitting high-speed data (or high-capacity data) according to a user's request are required.

### SUMMARY

Accordingly, embodiments of the present disclosure provide a method and an apparatus for reducing a transmission latency through efficient utilization of radio resources.

In order to achieve the objective of the present disclosure, a downlink communication method according to a first embodiment of the present disclosure may comprise receiving downlink control information (DCI) including resource allocation information from a base station through a control channel of a subframe #n; receiving downlink data from the base station through a data channel of a subframe #n+k indicated by the resource allocation information included in the DCI; and transmitting a first hybrid automatic repeat request (HARQ) response for the downlink data to the base station through a control channel of a subframe #n+k+l, wherein each of the subframe #n, the subframe #n+k, and the subframe #n+k+l includes a plurality of mini-slots, the receiving of the downlink data and the transmitting of the first HARQ response are performed on a mini-slot basis, and each of n, k, and 1 is an integer equal to or greater than 0.

Here, the DCI may be received through a control channel included in a mini-slot in the subframe #n.

Here, the resource allocation information may be scheduling information for the plurality of mini-slots included in the subframe #n+k.

Here, each of the plurality of mini-slots may include a dedicated control channel used for transmission of transmission characteristic information of the downlink data.

Here, the first HARQ response may be transmitted through a first mini-slot after a processing latency of the downlink data from a reception end time point of the downlink data.

Here, when the downlink data is received through the plurality of mini-slots included in the subframe #n+k, the HARQ response may be generated by bundling HARQ responses for the plurality of mini-slots.

Here, when a subframe includes 14 symbols and a mini-slot includes 2 symbols, a downlink subframe may include 6 mini-slots, and an uplink subframe may include 7 mini-slots.

Here, when a subframe includes 14 symbols and a mini-slot includes 4 symbols, a downlink subframe may include 3 mini-slots, and an uplink subframe may include 3 or 4 mini-slots.

Here, the downlink communication method may further comprise receiving the downlink data from the base station through a data channel of a subframe #n+k+l+o when the first HARQ response is a negative acknowledgment (NACK); and transmitting a second HARQ response for the downlink data to the base station through a control channel of a subframe #n+k+l+o+p, wherein each of o and p is an integer equal to or greater than 0.

Here, the downlink data may be repeatedly received in a plurality of mini-slots included in the subframe #n+k+l+o.

In order to achieve the objective of the present disclosure, an uplink communication method according to a second embodiment of the present disclosure may comprise receiving, from a base station, first DCI including first resource allocation information through a control channel of a subframe #n; and transmitting uplink data to the base station through a data channel of subframe #n+k indicated by the first resource allocation information included in the first DCI, wherein each of the subframe #n and the subframe #n+k includes a plurality of mini-slots, the transmitting of the uplink data is performed on a mini-slot basis, and each of n and k is an integer equal to or greater than 0.

Here, the first DCI may be received through a control channel included in a mini-slot in the subframe #n.

Here, the first resource allocation information may be scheduling information for the plurality of mini-slots included in the subframe #n+k.

Here, the uplink communication method may further comprise receiving, from the base station, a second DCI including second resource allocation information through a control channel of a subframe #n+k+l when the uplink data is not successfully received at the base station; and transmitting the uplink data to the base station through a data channel of a subframe #n+k+l+o indicated by the second resource allocation information included in the second DCI, wherein each of l and o is an integer equal to or greater than 0.

Here, a NACK for the uplink data may be received through the control channel of the subframe #n+k+l.

Here, the second DCI may be received through a first mini-slot after a processing latency of the uplink data from a reception end time point of the uplink data.

In order to achieve the objective of the present disclosure, a downlink communication method according to a third embodiment of the present disclosure may comprise transmitting DCI including resource allocation information to a terminal through a control channel of a subframe #n; transmitting downlink data to the terminal through a data channel of subframe #n+k indicated by the resource allocation information included in the DCI; and receiving a first HARQ response for the downlink data from the terminal through a control channel of a subframe #n+k+l, wherein each of the subframe #n, the subframe #n+k, and the subframe #n+k+l includes a plurality of mini-slots, the receiving of the downlink data and the transmitting of the first HARQ response are performed on a mini-slot basis, and each of n, k, and l is an integer equal to or greater than 0.

Here, each of the plurality of mini-slots may include a dedicated control channel used for transmission of transmission characteristic information of the downlink data.

Here, the first HARQ response may be received through a first mini-slot after a processing latency of the downlink data from a reception end time point of the downlink data.

Here, the downlink communication method may further comprise transmitting the downlink data to the terminal through a data channel of a subframe #n+k+l+o when the first HARQ response is a NACK; and receiving a second HARQ response for the downlink data from the terminal through a control channel of a subframe #n+k+l+o+p, wherein each of o and p is an integer equal to or greater than 0.

According to the present invention, downlink (re)transmission or uplink (re)transmission can be performed in units of mini-slots (e.g. mini-slots consisting of two or four symbols), and accordingly, the radio (re)transmission latency can be reduced. Also, a downlink control channel can be configured within a mini-slot, and transmission characteristic information for the mini-slot can be transmitted through the downlink control channel within the mini-slot. Using the downlink control channel configured within the mini-slot, the radio (re)transmission latency can be reduced.

In addition, the feedback interval for transmission of an HARQ response to downlink data may be configured to be shorter than a transmission unit of uplink data, and the radio (re)transmission latency can be reduced in this case. When a self-contained (SC) subframe is used in the communication system, a reception operation of downlink data and a transmission operation of an HARQ response to the received downlink data are performed in one SC subframe, so that the radio (re)transmission latency can be reduced.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram showing a first embodiment of a communication system;

FIG. 2 is a block diagram showing a first embodiment of a communication node constituting a communication system;

FIG. 3 is a conceptual diagram showing a first embodiment of a communication system supporting low-latency services;

FIG. 4 is a conceptual diagram showing a first embodiment of a communication system supporting ultra-low-latency services;

FIG. 5 is a conceptual diagram showing latencies in layers included in a communication node;

FIG. 6 is a conceptual diagram showing a first embodiment of a downlink transmission latency in a communication system;

FIG. 7 is a conceptual diagram showing a first embodiment of an uplink transmission latency in a communication system;

FIG. 8 is a table showing a first embodiment of numerologies in a communication system;

FIG. 9 is a conceptual diagram showing latencies in downlink and uplink transmissions in a communication system;

FIG. 10 is a conceptual diagram showing a first embodiment of a radio transmission latency in a communication system;

FIG. 11A is a conceptual diagram showing a first embodiment of a DL radio transmission latency in a communication system;

FIG. 11B is a conceptual diagram showing a first embodiment of a UL radio transmission latency in a communication system;

FIG. 12 is a conceptual diagram showing a first embodiment of a data (re)transmission latency in a communication system;

FIG. 13A is a graph showing measurement results of DL radio transmission latencies in a communication system;

FIG. 13B is a graph showing measurement results of UL radio transmission latencies in a communication system;

FIG. 14A is a conceptual diagram showing a first embodiment of a downlink data retransmission procedure in a communication system;

FIG. 14B is a conceptual diagram showing a first embodiment of a DL radio retransmission latency in a communication system;

FIG. 15A is a conceptual diagram showing a first embodiment of an uplink data retransmission procedure in a communication system;

FIG. 15B is a conceptual diagram showing a first embodiment of a UL radio retransmission latency in a communication system;

FIG. 16A is a graph showing measurement results of DL radio retransmission latencies in a communication system;

FIG. 16B is a graph showing measurement results of UL radio retransmission latencies in a communication system;

FIG. 17 is a table showing a length of a slot for each subcarrier spacing in a communication system;

FIG. 18 is a conceptual diagram showing a first embodiment of numerologies of a mini-slot in a communication system;

FIG. 19A is a conceptual diagram showing a first embodiment of a downlink subframe structure in an FDD based communication system;

FIG. 19B is a conceptual diagram showing a second embodiment of a downlink subframe structure in an FDD based communication system;

FIG. 19C is a conceptual diagram showing a third embodiment of a downlink subframe structure in an FDD based communication system;

FIG. 19D is a conceptual diagram showing a fourth embodiment of a downlink subframe structure in an FDD based communication system;

FIG. 20 is a conceptual diagram showing a first embodiment of an M-DL CTRL in a communication system;

FIG. 21A is a conceptual diagram showing a first embodiment of an uplink subframe structure in an FDD-based communication system;

FIG. 21B is a conceptual diagram showing a second embodiment of an uplink subframe structure in an FDD-based communication system;

FIG. 21C is a conceptual diagram showing a third embodiment of an uplink subframe structure in an FDD-based communication system;

FIG. 21D is a conceptual diagram showing a fourth embodiment of an uplink subframe structure in an FDD-based communication system;

FIG. 21E is a conceptual diagram showing a fifth embodiment of an uplink subframe structure in an FDD-based communication system;

FIG. 22 is a conceptual diagram showing a first embodiment of an M-UL CTRL in a communication system;

FIG. 23 is a conceptual diagram showing a first embodiment of a subframe structure in a TDD based communication system;

FIG. 24 is a conceptual diagram showing a first embodiment of a mini-slot structure in a downlink subframe;

FIG. 25 is a conceptual diagram showing a first embodiment of a mini-slot structure in an uplink subframe;

FIG. 26 is a conceptual diagram showing a first embodiment of a mini-slot structure in a special subframe;

FIG. 27A is a timing diagram showing a first embodiment of a processing latency in a signal transmission procedure;

FIG. 27B is a timing diagram showing a second embodiment of a processing latency in a signal transmission procedure;

FIG. 27C is a timing diagram showing a third embodiment of a processing latency in a signal transmission procedure;

FIG. 27D is a timing diagram showing a fourth embodiment of a processing latency in a signal transmission procedure;

FIG. 28A is a timing diagram showing a first embodiment of a processing latency in a signal reception procedure;

FIG. 28B is a timing diagram showing a second embodiment of a processing latency in a signal reception procedure;

FIG. 28C is a timing diagram showing a third embodiment of a processing latency in a signal reception procedure;

FIG. 28D is a timing diagram showing a fourth embodiment of a processing latency in a signal reception procedure;

FIG. 29A is a graph showing a processing latency for each transmission unit;

FIG. 29B is a graph showing a one-way transmission latency for each transmission unit;

FIG. 30 is a graph showing the number of cycle counts for each FFT;

FIG. 31A is a conceptual diagram showing a first embodiment of a downlink radio transmission latency in an FDD based communication system;

FIG. 31B is a conceptual diagram showing a first embodiment of a downlink radio transmission latency in an SC TDD based communication system;

FIG. 32A is a graph showing a first embodiment of a downlink radio transmission latency in an FDD based communication system;

FIG. 32B is a graph showing a first embodiment of a downlink radio transmission latency in an SC TDD based communication system;

FIG. 33 is a conceptual diagram showing a first embodiment of an uplink radio transmission latency in a communication system;

FIG. 34 is a graph showing a first embodiment of an uplink radio transmission latency in a communication system;

FIG. 35A is a conceptual diagram showing a second embodiment of an uplink radio transmission latency in a communication system;

FIG. 35B is a conceptual diagram showing a third embodiment of an uplink radio transmission latency in a communication system;

FIG. 36A is a conceptual diagram showing a first embodiment of a frequency-first RE mapping scheme;

FIG. 36B is a conceptual diagram showing a first embodiment of a time-first RE mapping scheme;

FIG. 37 is a graph showing a first embodiment of a processing latency according to an RE mapping scheme;

FIG. 38A is a conceptual diagram showing a first embodiment of an RS mapping scheme;

FIG. 38B is a conceptual diagram showing a second embodiment of an RS mapping scheme;

FIG. 38C is a conceptual diagram showing a third embodiment of an RS mapping scheme;

FIG. 39 is a graph showing a first embodiment of a processing latency according to an RS mapping scheme;

FIG. 40 is a conceptual diagram showing a first embodiment of a radio retransmission latency in an FDD-based communication system;

FIG. 41 is a conceptual diagram showing a second embodiment of a radio retransmission latency in an FDD based communication system;

FIG. 42A is a graph showing a first embodiment of a DL radio retransmission latency according to a subframe configuration;

FIG. 42B is a graph showing a first embodiment of a UL radio retransmission latency according to a subframe configuration;

FIG. 43 is a conceptual diagram showing a first embodiment of a downlink retransmission method when a mini-slot comprising 4 symbols is used in an FDD based communication system;

FIG. 44 is a conceptual diagram showing a first embodiment of an uplink retransmission method when a mini-slot comprising 4 symbols is used in an FDD based communication system;

FIG. 45 is a conceptual diagram showing a first embodiment of a downlink retransmission method when a mini-slot comprising 2 symbols is used in an FDD based communication system;

FIG. 46 is a conceptual diagram showing a first embodiment of an uplink retransmission method when a mini-slot comprising 2 symbols is used in an FDD-based communication system;

FIG. 47 is a table showing a DL radio retransmission latency and a UL radio retransmission latency according to a subframe configuration.

FIG. 48A is a graph showing a second embodiment of a DL radio retransmission latency according to a subframe configuration;

FIG. 48B is a graph showing a second embodiment of a UL radio retransmission latency according to a subframe configuration;

FIG. 49 is a conceptual diagram showing a second embodiment of a downlink retransmission method when a mini-slot comprising 4 symbols is used in an FDD based communication system;

FIG. 50 is a conceptual diagram showing a second embodiment of a downlink retransmission method when a mini-slot comprising 2 symbols is used in an FDD based communication system;

FIG. 51 is a conceptual diagram showing a second embodiment of an uplink retransmission method when a mini-slot comprising 4 symbols is used in an FDD based communication system;

FIG. 52 is a conceptual diagram showing a third embodiment of an uplink retransmission method when a mini-slot comprising 4 symbols is used in an FDD based communication system;

FIG. 53 is a conceptual diagram showing a second embodiment of an uplink retransmission method when a mini-slot comprising 2 symbols is used in an FDD based communication system;

FIG. 54 is a conceptual diagram showing a third embodiment of an uplink retransmission method when a mini-slot comprising 2 symbols is used in an FDD based communication system;

FIGS. 55A and 55B are tables showing a DL radio retransmission latency and a UL radio retransmission latency according to a subframe configuration;

FIG. 56A is a graph showing a third embodiment of a DL radio retransmission latency according to a subframe configuration;

FIG. 56B is a graph showing a third embodiment of a UL radio retransmission latency according to a subframe configuration;

FIG. 57A is a conceptual diagram showing a first embodiment of a downlink retransmission method when a short feedback period is used in an FDD based communication system;

FIG. 57B is a conceptual diagram showing a second embodiment of a downlink retransmission method when a short feedback period is used in an FDD based communication system;

FIG. 57C is a conceptual diagram showing a third embodiment of a downlink retransmission method when a short feedback period is used in an FDD based communication system;

FIG. 57D is a conceptual diagram showing a fourth embodiment of a downlink retransmission method when a short feedback period is used in an FDD based communication system;

FIGS. 58A and 58B are tables showing a DL radio retransmission latency and a UL radio retransmission latency according to a subframe configuration;

FIG. 59 is a graph showing a fourth embodiment of a DL radio retransmission latency according to a subframe configuration;

FIG. 60A is a conceptual diagram showing a third embodiment of a downlink retransmission method when a mini-slot comprising 4 symbols is used in an FDD based communication system;

FIG. 60B is a conceptual diagram showing a third embodiment of a downlink retransmission method when a mini-slot comprising 2 symbols is used in an FDD based communication system;

FIG. 61A is a conceptual diagram showing a fourth embodiment of an uplink retransmission method when a mini-slot comprising 4 symbols is used in an FDD based communication system;

FIG. 61B is a conceptual diagram showing a fourth embodiment of an uplink retransmission method when a mini-slot comprising 2 symbols is used in an FDD based communication system;

FIG. 61C is a conceptual diagram showing a fifth embodiment of an uplink retransmission method when a mini-slot comprising 2 symbols is used in an FDD based communication system;

FIG. 62A is a graph showing a fifth embodiment of a DL radio retransmission latency according to a subframe configuration;

FIG. 62B is a graph showing a fourth embodiment of a UL radio retransmission latency according to a subframe configuration;

FIG. 63A is a conceptual diagram showing a first embodiment of downlink communication based on a single resource allocation scheme in a self-contained (SC) TDD based communication system;

FIG. 63B is a conceptual diagram showing a first embodiment of downlink communication based on a multi-resource allocation scheme in an SC TDD based communication system;

FIG. 63C is a conceptual diagram showing a second embodiment of downlink communication based on a multi-resource allocation scheme in an SC TDD based communication system;

FIG. 64A is a conceptual diagram showing a first embodiment of a downlink data transmission method in a multi-resource allocation scheme;

FIG. 64B is a conceptual diagram showing a second embodiment of a downlink data transmission method in a multi-resource allocation scheme;

FIG. 64C is a conceptual diagram showing a third embodiment of a downlink data transmission method in a multi-resource allocation scheme;

FIG. 65 is a conceptual diagram showing a first embodiment of a downlink retransmission method based on a single resource allocation scheme in a communication system;

FIG. 66 is a conceptual diagram showing a first embodiment of a downlink retransmission method based on a multi-resource allocation scheme in a communication system;

FIG. 67 is a conceptual diagram showing a second embodiment of a downlink retransmission method based on a multi-resource allocation scheme in a communication system;

FIG. 68 is a conceptual diagram showing a third embodiment of a downlink retransmission method based on a multi-resource allocation scheme in a communication system;

FIG. 69 is a conceptual diagram showing a fourth embodiment of a downlink data retransmission method based on a multi-resource allocation scheme in a communication system;

FIG. 70 is a conceptual diagram showing a fifth embodiment of a downlink data retransmission method based on a multi-resource allocation scheme in a communication system;

FIG. 71A is a conceptual diagram showing a first embodiment of uplink communication based on a single resource allocation scheme in an SC TDD based communication system;

FIG. 71B is a conceptual diagram showing a first embodiment of uplink communication based on a multi-resource allocation scheme in an SC TDD based communication system;

FIG. 71C is a conceptual diagram showing a second embodiment of uplink communication based on a multi-resource allocation scheme in an SC TDD based communication system;

FIG. 72 is a conceptual diagram showing a first embodiment of an uplink retransmission method based on a multi-resource allocation scheme in a communication system;

FIG. 73 is a conceptual diagram showing a second embodiment of an uplink retransmission method based on a multi-resource allocation scheme in a communication system;

FIG. 74 is a conceptual diagram showing a third embodiment of an uplink retransmission method based on a multi-resource allocation scheme in a communication system;

FIG. 75 is a conceptual diagram showing a fourth embodiment of an uplink retransmission method based on a multi-resource allocation scheme in a communication system;

FIG. 76 is a graph showing radio retransmission latencies according to the number of repeated transmissions of data;

FIG. 77A is a block diagram showing a first embodiment of an SC subframe in a communication system;

FIG. 77B is a block diagram showing a second embodiment of an SC subframe in a communication system;

FIG. 78A is a block diagram showing a third embodiment of an SC subframe in a communication system;

FIG. 78B is a block diagram showing a fourth embodiment of an SC subframe in a communication system;

FIG. 79A is a block diagram showing a fifth embodiment of an SC subframe in a communication system;

FIG. 79B is a block diagram showing a sixth embodiment of an SC subframe in a communication system;

FIG. 80 is a conceptual diagram showing a first embodiment of a radio retransmission latency when an SC subframe is used in a communication system;

FIG. 81 is a conceptual diagram showing a second embodiment of a radio retransmission latency when an SC subframe is used in a communication system;

FIG. 82 is a conceptual diagram showing a third embodiment of a radio retransmission latency when an SC subframe is used in a communication system;

FIG. 83 is a conceptual diagram showing a fourth embodiment of a radio retransmission latency when an SC subframe is used in a communication system;

FIG. 84 is a conceptual diagram showing an embodiment of a radio retransmission latency when an SC subframe shown in FIG. 83 is used;

FIG. 85A is a conceptual diagram showing a fifth embodiment of a radio retransmission latency when an SC subframe is used in a communication system;

FIG. 85B is a conceptual diagram showing a sixth embodiment of a radio retransmission latency when an SC subframe is used in a communication system;

FIG. 86A is a conceptual diagram showing a first embodiment of an uplink radio retransmission latency when an SC subframe is used in a communication system;

FIG. 86B is a conceptual diagram showing a second embodiment of an uplink radio retransmission latency when an SC subframe is used in a communication system;

FIG. 86C is a conceptual diagram showing a third embodiment of an uplink radio retransmission latency when an SC subframe is used in a communication system;

FIG. 87A is a conceptual diagram showing a third embodiment of an uplink radio retransmission latency when an SC subframe is used in a communication system;

FIG. 87B is a conceptual diagram showing a fifth embodiment of an uplink radio retransmission latency when an SC subframe is used in a communication system;

FIG. 87C is a conceptual diagram showing a sixth embodiment of an uplink radio retransmission latency when an SC subframe is used in a communication system;

FIG. 88A is a conceptual diagram showing a seventh embodiment of a radio retransmission latency when an SC subframe is used in a communication system;

FIG. 88B is a conceptual diagram showing an eighth embodiment of a radio retransmission latency when an SC subframe is used in a communication system;

FIG. 88C is a conceptual diagram showing a ninth embodiment of a radio retransmission latency when an SC subframe is used in a communication system;

FIG. 89A is a conceptual diagram showing a tenth embodiment of a radio retransmission latency when an SC subframe is used in a communication system;

FIG. 89B is a conceptual diagram showing an eleventh embodiment of a radio retransmission latency when an SC subframe is used in a communication system;

FIG. 89C is a conceptual diagram showing a twelfth embodiment of a radio retransmission latency when an SC subframe is used in a communication system;

FIG. 90A is a conceptual diagram showing a thirteenth embodiment of a radio retransmission latency when an SC subframe is used in a communication system;

FIG. 90B is a conceptual diagram showing a fourteenth embodiment of a radio retransmission latency when an SC subframe is used in a communication system;

FIG. 91 is a conceptual diagram showing a first embodiment of a collision between transmission of non-low-latency data and transmission of low-latency data in a communication system;

FIG. 92 is a conceptual diagram showing a first embodiment of a method of transmitting non-low-latency data and low-latency data in a communication system;

FIG. 93 is a conceptual diagram showing a second embodiment of a method of transmitting non-low-latency data and low-latency data in a communication system;

FIG. 94 is a conceptual diagram showing a first embodiment of an RE mapping method of non-low-latency data and low-latency data in a communication system;

FIG. 95A is a conceptual diagram showing a first embodiment of a method for repeatedly transmitting non-low-latency data in a communication system;

FIG. 95B is a conceptual diagram showing a first embodiment of a method for repeatedly transmitting low-latency data in a communication system;

FIG. 96A is a conceptual diagram showing a first embodiment of a method for repeatedly transmitting data in a communication system;

FIG. 96B is a conceptual diagram showing a second embodiment of a method for repeatedly transmitting data in a communication system;

FIG. 97 is a conceptual diagram showing a third embodiment of a method of transmitting non-low-latency data and low-latency data in a communication system;

FIG. 98 is a conceptual diagram showing a second embodiment of a collision between transmission of non-low-latency data and transmission of low-latency data in a communication system;

FIG. 99 is a conceptual diagram showing a fourth embodiment of a method of transmitting non-low-latency data and low-latency data in a communication system;

FIG. 100 is a conceptual diagram showing a fifth embodiment of a method of transmitting non-low-latency data and low-latency data in a communication system;

FIG. 101 is a conceptual diagram showing a sixth embodiment of a method of transmitting non-low-latency data and low-latency data in a communication system;

FIG. 102 is a conceptual diagram showing a first embodiment of a downlink communication method according to a DRX cycle in a communication system;

FIG. 103 is a conceptual diagram showing a first embodiment of an uplink communication method according to a DRX cycle in a communication system;

FIG. 104 is a conceptual diagram showing a second embodiment of a downlink communication method according to a DRX cycle in a communication system; and

FIG. 105 is a conceptual diagram showing a second embodiment of an uplink communication method according to a DRX cycle in a communication system.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

Hereinafter, wireless communication networks to which exemplary embodiments according to the present disclosure will be described. However, wireless communication networks to which exemplary embodiments according to the present disclosure are applied are not restricted to what will be described below. That is, exemplary embodiments according to the present disclosure may be applied to various wireless communication networks. Here, a communication system may be used in the same sense as a communication network.

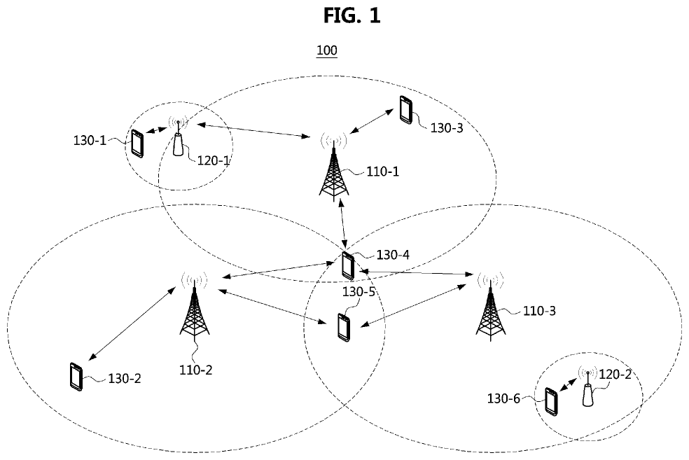

FIG. 1 is a conceptual diagram showing a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support the 4G communication (e.g., LTE, LTE-Advanced (LTE-A), etc.), the 5G communication (e.g., NR), or the like specified by the 3^{rd} generation partnership project (3GPP) standards. The 4G communication may be performed in a frequency band below 6 GHz, and the 5G communication may be performed in a frequency band above 6 GHz as well as the frequency band below 6 GHz.

For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix (CP)-OFDM based communication protocol, a discrete Fourier transform-spread-OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may include a serving gateway (S-GW), a packet data network (PDN) gateway (P-GW), a mobility management entity (MME), and the like. When the communication system 100 supports the 5G communication, the core network may include a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 may have the following structure.

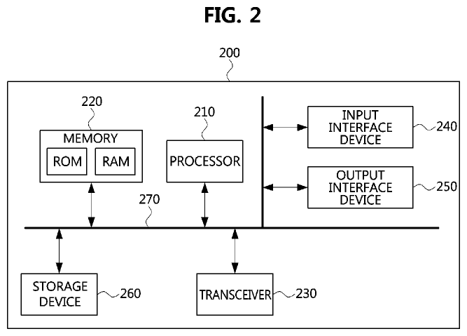

FIG. 2 is a block diagram showing a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), a gNB, a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or the non-ideal backhaul link. Also, each of the plurality of base stations 110-1, 110-2, 110-3, 120-1, and 120-2 may be connected to the core network through the ideal or the non-ideal backhaul link. Each of the plurality of base stations 110-1, 110-2, 110-3, 120-1, and 120-2 may transmit a signal received from the core network to the corresponding terminal(s) 130-1, 130-2, 130-3, 130-4, 130-5, or 130-6, and transmit a signal received from the corresponding terminal(s) 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Next, methods for reducing transmission latencies in a communication system will be described. Even when a method (e.g., transmission or reception of a signal) to be performed at a first communication node among the communication nodes is described, the corresponding second communication node may perform a method (e.g., reception or transmission of a signal) corresponding to the method performed at the first communication node. That is, when the operation of the terminal is described, the corresponding base station may perform an operation corresponding to the operation of the terminal. Conversely, when the operation of the base station is described, the corresponding terminal may perform an operation corresponding to the operation of the base station.

A communication node providing enhanced services in the following embodiments may be an enhanced mobile broadband (eMBB) device (e.g., a communication node that transmits and receives high capacity data), a low-latency enabled (LL) device (e.g., a communication node that supports a transmission latency reduction function), a coverage enhanced (CE) device (e.g., a communication node that supports an extended coverage providing function), or a low complexity (LC) device (e.g., a communication node that supports enhanced complexity).

The eMBB device, the LL device, the CE device, and the LC device may be referred to as an ‘S-device.’ The S-device may be a base station, a relay, or a terminal. Also, the S-device may be mounted on a vehicle, a train, an unmanned aerial vehicle (e.g., drone), a manned aircraft, or the like. A communication node that provides reliability in addition to the eMBB device, the LL device, the CE device, and the LC device may perform the following embodiments.

The S-device may operate as a transmitting device, a receiving device, or a relay device. In a downlink communication procedure, a base station may operate as a transmitting device, and a terminal may operate as a receiving device. In an uplink communication procedure, the base station may operate as a receiving device, and the terminal may operate as a transmitting device.

Meanwhile, the meanings of the abbreviations mentioned in the following embodiments may be as shown in Table 1 below.

TABLE 1

| Abbreviation | Meaning | Abbreviation | Meaning |
|---|---|---|---|
| 3GPP | Third Generation | OS | OFDM Symbol |
| | Partnership Project | | |
| 5G | 5th Generation | PDCCH | Physical Downlink |
| | | | Control CH |
| ACK | ACKnowledgement | PDCP | Packet Data |
| | | | Convergence |
| | | | Protocol |
| BER | Bit Error Rate | PDSCH | Physical Downlink |
| | | | Shared CH |
| BS | Base Station | PUCCH | Physical Uplink |
| | | | Control CH |
| CH | CHannel | PUSCH | Physical Uplink |
| | | | Shared CH |
| CTRL | ConTRoL | RE | Resource Element |
| DCI | Downlink Control | RF | Radio Frequency |
| | Information | | |
| DL | DownLink | RRC | Radio Resource |
| | | | Control |
| DRX | Discontinuous | RTD | Round Trip Delay |
| | Reception | | time |
| eMBB | enhanced Mobile | RTT | Round Trip Time |
| | BroadBand | | |
| FB | FeedBack | RV | Redundancy Version |
| FDD | Frequency Division | SC- | Self-contained |
| | Duplexing | (sub)frame | (sub)frame |
| GP | Guard Period | SCS | SubCarrier |
| | | | Spacing |
| HARQ | Hybrid Automatic | SG | Scheduling Grant |
| | Repeat reQuest | | |
| ISD | Inter-Site Distance | SP | Switching Period |
| LLC | Low Latency | SPS | Semi-Persistent |
| | Communication | | Scheduling |
| LTE | Long Term | SR | Scheduling Request |
| | Evolution | | |
| MAC | Medium Access | TA | Timing Advance |
| | Control | | |
| MCS | Modulation and | TBS | Transport Block |
| | Coding Scheme | | Size |
| MS | Mobile Station | TDD | Time Division |
| | | | Duplexing |
| m-Control | mini-slot specific | TTI | Transmission Time |
| | Control | | Interval |
| NACK | Negative ACK | UCI | Uplink Control |
| | | | Information |
| NDI | New Data Indication | UE | User Equipment |
| NR | New Radio | UL | UpLink |
| OFDM | Orthogonal | URLLC | Ultra Low Latency |
| | Frequency Division | | Communication |
| | Multiplexing | | |

Meanwhile, in a communication system that provides a high-capacity data service (e.g., eMBB service), a high-quality voice call service, a high-quality video call service, an accurate/quick data sharing service in a dense living space, and a high-speed data (e.g., video data) service may be provided.

In addition, the communication system may provide a real-time interaction based convergence service (e.g., low latency services or ultra-low latency services). For example, the real-time interaction based convergence service may include a vehicle-to-everything (V2X) communication service, a drone communication service, a remote medical service, an industrial Internet of Things (IoT) service, an augmented reality (AR) service, and a virtual reality (VR) service. The low-latency services may be performed as follows.

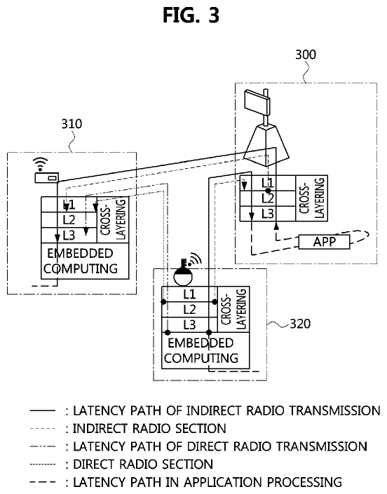

FIG. 3 is a conceptual diagram showing a first embodiment of a communication system supporting low-latency services.

Referring to FIG. 3, a communication system may comprise a base station 300, a first terminal 310, and a second terminal 320. The first terminal 310 may be an actuator and the second terminal 320 may be a sensor node or a utility node. The base station 300 may include a layer 1 (L1), a layer 2 (L2), a layer 3 (L3), and an application layer (APP). The base station 300 may be connected to a mobile edge cloud (MEC) server. Cross-layering may be applied to the layers included in the base station 300. Each of the first terminal 310 and the second terminal 320 may include a layer 1 (L1), a layer 2 (L2), and a layer 3 (L3). Also, each of the first terminal 310 and the second terminal 320 may further include a layer that performs an embedded computing function. Cross-layering may be applied to the layers included in each of the first terminal 310 and the second terminal 320.

A radio transmission latency may be classified into a direct radio transmission latency and an indirect radio transmission latency. In order to support a high transmission rate, a high transmission efficiency, a short transmission latency, and a robust data transmission in communication between communication nodes (e.g., the base station 300, the first terminal 310, and the second terminal 320), a strict time latency may be required.

In the communication system that provides ultra-low-latency services, the radio transmission latency may include a transmission processing latency, a radio link latency, and a reception processing latency. The transmission processing latency may include a transmission latency (e.g., L2 processing latency) from the application layer (APP) to the layer 1 (L1) and an L1 processing latency. The reception processing latency may include an L1 processing latency and a transmission latency from the layer 1 (L1) to the application layer (APP) (e.g., L2 processing latency). The L1 processing latency may be determined based on a processing performance of a baseband and a processing performance of a radio frequency (RF).

FIG. 4 is a conceptual diagram showing a first embodiment of a communication system supporting ultra-low-latency services.

Referring to FIG. 4, a communication system may comprise a base station and a terminal. The base station may include a layer 1 (L1), a layer 2 (L2), a layer 3 (L3), and an application layer (APP). The base station may be connected to a MEC server. The terminal may include a layer 1 (L1), a layer 2 (L2), and a layer 3 (L3). Also, the terminal may further include an application layer (APP). Cross-layering may be applied to the layers included in the terminal.

For example, requirement for a one-way radio transmission latency between communication nodes (e.g., base station and terminal) may be within 0.2 ms, and requirement for a one-way end-to-end radio transmission latency between communication nodes may be within 0.25 ms. Also, requirement of a radio retransmission latency between communication nodes may be within 0.5 ms, and requirement of a handover latency may be within 2 ms.

The one-way radio transmission latency, the one-way end-to-end radio transmission latency, and the radio retransmission latency may be defined according to a start time and an end time of the signal processing.
One-way radio transmission latency: The one-way radio transmission latency may be a time from when data is received from a layer 2 (L2) at a transmitting end to when the data is transferred to a layer 2 (L2) at a receiving end. For example, the one-way radio transmission latency may include a layer 1 (L1) processing time (e.g., modulation processing time, encoding processing time) at the transmitting end, a transmission time through a radio link, and a layer (L1) processing time (e.g., demodulation processing time, decoding processing time) at the receiving end.
One-way end-to-end radio transmission latency: The one-way end-to-end radio transmission latency may be a time from when data is received from an application layer (APP) at a transmitting end to when the data is transferred to an application layer (APP) at a receiving end. For example, the one-way end-to-end radio transmission latency may include a layer 2/3 (L2/3) processing time (e.g., generation time of a data header) at the transmitting end, the layer 1 (L1) processing time at the transmitting end, the transmission time through a radio link, the layer 1 (L1) processing time at the receiving end, and a layer 2/3 (L2/3) processing time at the receiving end.
Radio retransmission latency: The radio retransmission latency may be a time from when data is transmitted from the layer 1 (L1) at the transmitting end to when a preparation of a retransmission based on a feedback signal (e.g., acknowledgment (ACK) or a negative ACK (NACK)) for the data is completed. For example, the radio retransmission latency may include the transmission time of the data through a radio link, the processing time of the data in the layer 1 (L1) at the receiving end, a transmission time of the feedback signal through the radio link, and a processing time of the feedback signal in the layer 1 at the transmitting end.

In order to provide ultra-low-latency services to the terminal in the communication system, a radio access latency and a handover service latency may be defined.
Radio access latency: In order to reduce battery consumption of a terminal, an operation state of the terminal may be defined as an inactive state or an active state, and the radio access latency may be a time required for the operation state of the terminal to transit from the inactive state to the active state. The inactive state may be referred to as an idle state, and the active state may be referred to as a connected state.
Handover service latency: The handover service latency may be a time (e.g., mobility interruption time (MIT)) during which data transmission and reception are suspended during a handover procedure.

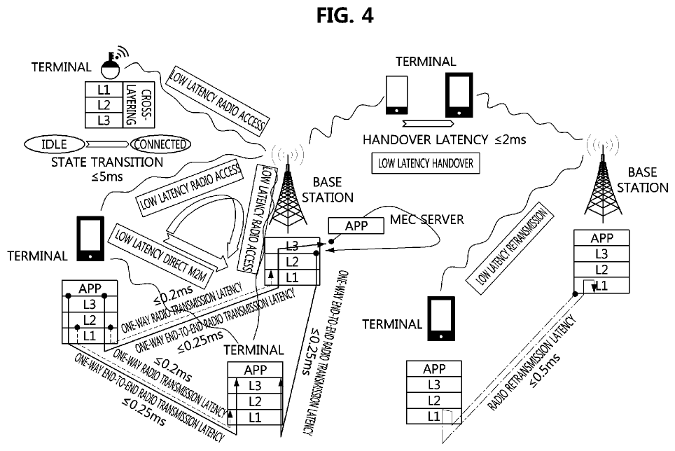

FIG. 5 is a conceptual diagram showing latencies in layers included in a communication node.

Referring to FIG. 5, latencies may be classified into a communication link latency, an L1 processing latency, and an L2 processing latency. The communication link latency, the L1 processing latency, and the L2 processing latency may be defined as shown in Table 2 below.

TABLE 2

| | Functional | |
|---|---|---|
| Latency | block | Function |
| L2 | RLC/MAC | Data classification |
| processing | | Data (de)segmentation |
| latency | | Data (de)ciphering |
| | | Header (de)compress |
| L1 | Scheduling | Data queuing, buffering |
| processing | | Resource allocation |
| latency | | HARQ retransmission (including |
| | | ACK/NACK feedback) |
| | Baseband | (de)modulation |
| | processing | Channel (de)coding |
| | | Pilot (e.g., reference signal) design |
| | Resource | Frame (TTI, duplexing) alignment |
| | (de)mapping | Resource element (RE) (de)mapping |
| | Antenna | Transition time (RF BW adaptation |
| | (de)mapping | time, transition time for the same |
| | | center frequency (e.g., 20 us) |
| | | Antenna (de)mapping |
| Communication | Air interface | Short TTI and/or new numerology |
| link latency | transmission | TA |

The communication link latency may be determined according to a transmission frame for data transmission. Specifically, the communication link latency may be determined based on a transmission time interval (TTI), the number of symbols (e.g., the number of symbols used for data transmission), and a duration of each symbol. For example, when a normal cyclic prefix (CP) is used in the LTE communication system, one TTI may include 14 symbols, and the length of one TTI may be 1 ms. In this case, the minimum communication link latency may be 1 ms.

In the NR communication system, the length of one TTI may be shorter than 1 ms. For example, in the NR communication system, the length of one TTI may be 0.5 ms, 0.25 ms, or the like. The number of symbols included in one TTI may be 1 to 14. When a subcarrier spacing of 60 kHz is used in a communication system supporting a frequency band of 6 GHz or less, one TTI may be composed of 2 symbols, in which case the minimum communication link latency may be 35.71 μs.

The L1 processing latency may be determined based on the modulation operation, the demodulation operation, the encoding operation, the decoding operation, the resource mapping operation, the resource demapping operation, the antenna mapping operation, and the antenna demapping operation. The L2 processing latency may be determined based on the ciphering operation, the header generation operation, and the header compression operation on the data received from the application layer (APP), and the decoding operation and the header decompression operation on the data received from the layer 1.

Meanwhile, the radio transmission latency may be classified into a downlink transmission latency and an uplink transmission latency. The downlink transmission latency may be as follows.

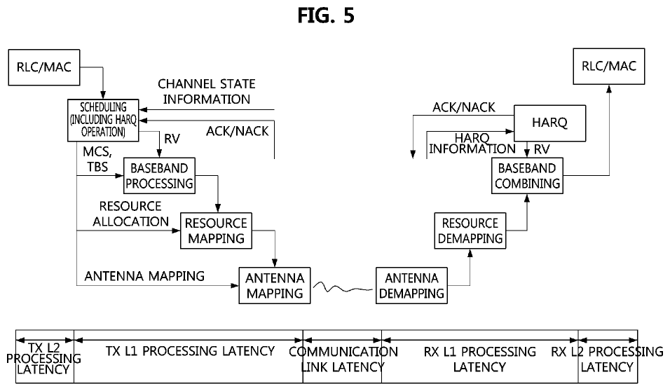

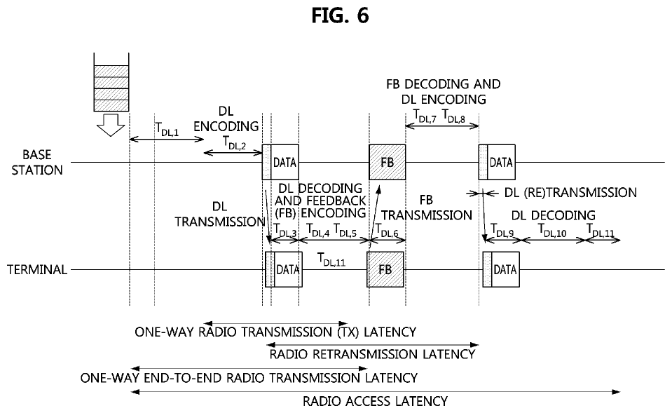

FIG. 6 is a conceptual diagram showing a first embodiment of a downlink transmission latency in a communication system.

Referring to FIG. 6, a downlink transmission latency may be classified into a one-way radio transmission (TX) latency, a radio retransmission latency, a one-way end-to-end radio transmission latency, and a radio access latency. T_{DL,1} to T_{DL,11} may be defined as shown in Table 3 below. Table 3 shows mapping relationship between the functional elements and the latencies in the downlink transmission. The ‘end-to-end’ in Table 3 may indicate the one-way end-to-end radio transmission latency of FIG. 6, the ‘one-way’ in Table 3 may indicate the one-way radio transmission latency of FIG. 6. The ‘retransmission’ in Table 3 may indicate the radio retransmission latency of FIG. 6, and the ‘access’ in Table 3 may indicate the radio access latency of FIG. 6.

TABLE 3

| | | Base | | | | | |
|---|---|---|---|---|---|---|---|
| | Description | station | terminal | End-to-end | One-way | retransmission | access |
| T_{DL,1} | L2/L3 processing | X | | X | | | X |
| | latency for | | | | | | |
| | incoming data | | | | | | |
| T_{DL,2} | L1 processing | X | | X | X | | X |
| | latency for DL | | | | | | |
| | encoding (including | | | | | | |
| | TTI alignment) | | | | | | |
| T_{DL,3} | Time for | X | | X | X | X | X |
| | transmission of | | | | | | |
| | DL data | | | | | | |
| T_{DL,4} | L1 processing | | X | X | X | X | X |
| | latency for DL | | | | | | |
| | decoding | | | | | | |
| T_{DL,5} | L1 processing | | X | | | X | X |
| | latency for HARQ | | | | | | |
| | ACK/NACK | | | | | | |
| | encoding | | | | | | |
| T_{DL,6} | Feedback time | | X | | | X | X |
| T_{DL,7} | L1 processing | X | | | | X | X |
| | latency for feed- | | | | | | |
| | back decoding | | | | | | |
| T_{DL,8} | L1 processing | X | | | | X | X |
| | latency for DL | | | | | | |
| | encoding | | | | | | |
| T_{DL,9} | Time for | X | | | | | X |
| | retransmission | | | | | | |
| | of DL data | | | | | | |
| T_{DL,10} | L1 processing | | X | | | | X |
| | latency for DL | | | | | | |
| | data decoding | | | | | | |
| T_{DL,11} | L2/L3 processing | | X | X | | | X |
| | latency for out- | | | | | | |
| | going data | | | | | | |

Meanwhile, the uplink transmission latency may be as follows.

FIG. 7 is a conceptual diagram showing a first embodiment of an uplink transmission latency in a communication system.

Referring to FIG. 7, the uplink transmission latency may be classified into a one-way radio transmission (TX) latency, a radio retransmission latency, a one-way end-to-end radio transmission latency, and a radio access latency. T_{UL,0} to T_{UL,16} may be defined as shown in Table 4 below. Table 4 shows mapping relationship between the functional elements and the latencies in the downlink transmission. The ‘end-to-end’ in Table 4 may indicate the one-way end-to-end radio transmission latency of FIG. 7, the ‘one-way’ in Table 4 may indicate the one-way radio transmission latency of FIG. 7. The ‘retransmission’ in Table 4 may indicate the radio retransmission latency of FIG. 7, and the ‘access’ in Table 4 may indicate the radio access latency of FIG. 7.

TABLE 4

| | | Base | | | | | |
|---|---|---|---|---|---|---|---|
| | Description | station | terminal | End-to-end | One-way | retransmission | access |
| T_{UL,0} | Average wait time | | X | X | | | X |
| | for scheduling | | | | | | |
| | request (SR) | | | | | | |
| | (including L2/L3 | | | | | | |
| | processing latency | | | | | | |
| | for incoming data) | | | | | | |
| T_{UL,1} | L1 processing | | X | X | | | X |
| | latency for | | | | | | |
| | scheduling grant | | | | | | |
| | (SG) decoding | | | | | | |
| T_{UL,2} | Time for | | X | X | | | X |
| | transmission of SR | | | | | | |
| T_{UL,3} | L1 processing | X | | X | | | X |
| | latency for SR | | | | | | |
| | decoding | | | | | | |
| T_{UL,4} | L1 processing | X | | X | | | X |
| | latency for SG | | | | | | |
| | encoding | | | | | | |
| T_{UL,5} | Time for | X | | X | | | X |
| | transmission of SG | | | | | | |
| T_{UL,6} | Processing latency | | X | X | | | X |
| | for SG decoding | | | | | | |
| T_{UL,7} | L1 processing | | X | X | X | | X |
| | latency for UL data | | | | | | |
| | encoding | | | | | | |
| T_{UL,8} | Time for | | X | X | X | X | X |
| | transmission of UL | | | | | | |
| | data | | | | | | |
| T_{UL,9} | L1 processing | X | | X | X | X | X |
| | latency for UL | | | | | | |
| | decoding | | | | | | |
| T_{UL,10} | L1 processing | X | | | | X | X |
| | latency for SG | | | | | | |
| | encoding | | | | | | |
| T_{UL,11} | Time for | X | | | | X | X |
| | transmission of SG | | | | | | |
| T_{UL,12} | L1 processing | | X | | | X | X |
| | latency for SG | | | | | | |
| | decoding | | | | | | |
| T_{UL,13} | L1 processing | | X | | | X | X |
| | latency for UL data | | | | | | |
| | encoding | | | | | | |
| T_{UL,14} | Time for | | X | | | | X |
| | transmission of UL | | | | | | |
| | data | | | | | | |
| T_{UL,15} | L1 processing | X | | | | | X |
| | latency for UL data | | | | | | |
| | decoding | | | | | | |
| T_{UL,16} | L2 processing | X | | X | | | X |
| | latency for outgoing | | | | | | |
| | data | | | | | | |

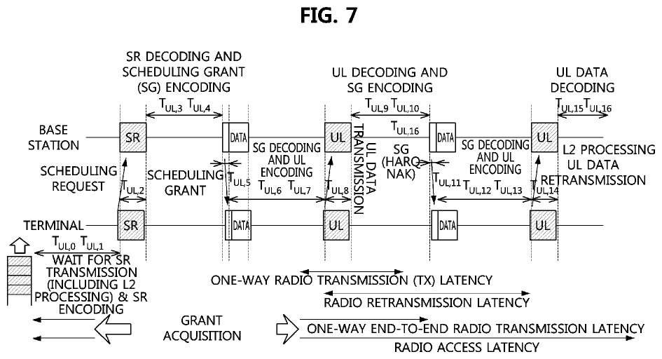

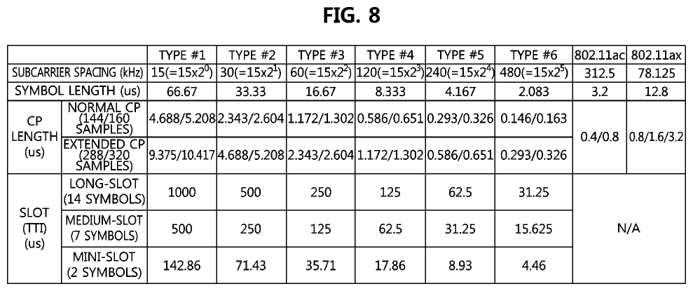

FIG. 8 is a table showing a first embodiment of numerologies in a communication system.

Referring to FIG. 8, a communication system operating in a frequency band of 6 GHz or lower may support types #1 to #3, and a communication system operating in a frequency band of 6 GHz or higher may support types #3 to #6. In the types #1 to #6, the TTI may be the smallest unit for data transmission, and one TTI may include one or more slots. A slot may comprise one or more physical channels (e.g., physical data channel and/or physical control channel). Each of the TTI, slot, and physical channel may be configured on a slot basis.

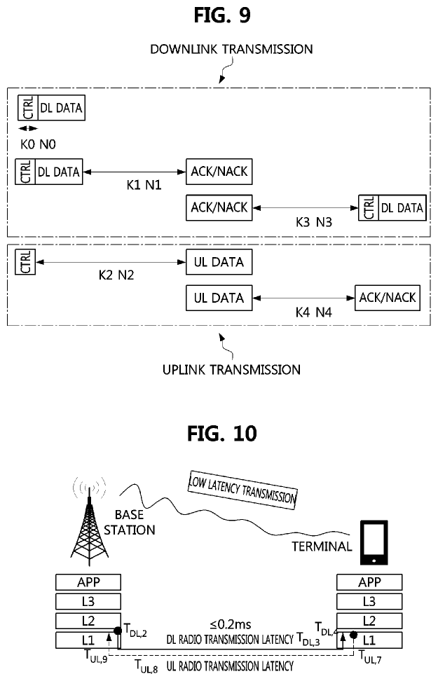

FIG. 9 is a conceptual diagram showing latencies in downlink and uplink transmissions in a communication system.

Referring to FIG. 9, a base station may transmit a control channel (CTRL) including a downlink (DL) grant to a terminal, and transmit a data channel including downlink data scheduled by the DL grant to the terminal. The terminal may receive the control channel (CTRL) from the base station, and identify the DL grant included in the control channel (CTRL). The terminal may receive the data channel by monitoring time-frequency resources indicated by the DL grant, and obtain the downlink data included in the data channel. However, when the downlink data is not successfully decoded, the terminal may transmit a NACK to the base station in response to the downlink data. When the NACK is received from the terminal, the base station may retransmit the downlink data.

In the uplink transmission, the base station may transmit a control channel (CTRL) including an uplink (UL) grant to the terminal. The terminal may receive the control channel (CTRL) from the base station, and identify the UL grant included in the control channel (CTRL). The terminal may transmit a data channel including uplink data to the base station through time-frequency resources indicated by the UL grant. The base station may receive the data channel by monitoring time-frequency resources indicated by the UL grant, and obtain the uplink data included in the data channel. The base station may transmit a feedback signal (e.g., ACK or NACK) according to a decoding result of the uplink data to the terminal.

In FIG. 9, the meaning of K0 to K4 and N0 to N4 may be as shown in Table 5 below. In Table 5 below, a latency unit of K0 to K4 may be a TTI, and a latency unit of N0 to N4 may be a symbol.

TABLE 5

| latency | Definition |
|---|---|
| K0 | Reception latency of DL grant and |
| | the corresponding DL Data (PDSCH) |
| | (latency in units of TTIs) |
| K1 | Reception latency of DL data (PDSCH) |
| | and transmission latency of the |
| | corresponding ACK/NACK (latency |
| | in units of TTIs) |
| K2 | Reception latency of UL grant and |
| | transmission latency of UL data |
| | (PUSCH) (latency in units of TTIs) |
| K3 | Reception latency of ACK/NACK |
| | and retransmission latency of the |
| | corresponding DL data (PDSCH) |
| | (latency in units of TTIs) |
| K4 | Transmission latency of UL data (PUSCH) |
| | and reception latency of the |
| | corresponding ACK/NACK |
| | (latency in units of TTIs) |
| N0 | The number of symbols from the end |
| | of DL grant transmission to the |
| | transmission start time of the corresponding |
| | PDSCH. That is, the number |
| | of symbols is the time required for |
| | processing at the base station. |
| | The number of symbols from the end |
| | of DL grant reception to the |
| | reception start time of the corresponding |
| | PDSCH. That is, the number of |
| | symbols is the time required for processing |
| | at the terminal. |
| N1 | The number of symbols from the |
| | end of PDSCH reception to the |
| | transmission start time of the corresponding |
| | ACK/NACK. That is, the |
| | number of symbols is the time required |
| | for processing at the terminal. |
| N2 | The number of symbols from the end of |
| | reception of PDSCH containing UL |
| | grant to the transmission start time of |
| | the corresponding PUSCH. That is, |
| | the number of symbols is the time |
| | required for processing at the terminal. |
| N3 | The number of symbols from the end |
| | of ACK/NACK reception to the |
| | retransmission start time of the |
| | corresponding PDSCH. That is, the |
| | number of symbols is the time required |
| | for processing at the base station. |
| N4 | The number of symbols from the end |
| | of PUSCH reception to the |
| | transmission start time of the corresponding |
| | ACK/NACK. That is, the |
| | number of symbols is the time required |
| | for processing at the base station. |
| | The number of symbols from the end |
| | of PUSCH transmission to the |
| | reception start time of the corresponding |
| | ACK/NACK. That is, the |
| | number of symbols is the time required |
| | for processing at the terminal. |

Meanwhile, the processing latency may include a propagation delay, an RF processing latency, and a baseband processing latency. The processing latency may be determined by hardware performance. The RF processing latency may include a switching latency between the downlink communication and the uplink communication, a bandwidth adaptation latency, and the like. The baseband processing latency may include latencies according to encoding/decoding operations, modulation/demodulation operations, and resource mapping/demapping operations.

In the following embodiments, the propagation delay may be assumed to be 0.5 symbols when an inter-site distance (ISD) is 3 km, and may be assumed to be 0.2 symbols when the ISD is 100 m. The L1 processing latency may be assumed to be 1.5 times the length of transmission data, the encoding processing latency may be assumed to be 0.6 times the length of transmission data, and the decoding processing latency may be assumed to be 0.9 times the length of reception data. Also, in the following embodiments, a symbol may refer to an OFDM symbol, and a symbol length may be determined according to a CP type.

The communication system may support the types #1 to #3 defined in FIG. 8. In this case, the subcarrier spacing in the communication system may be 15 kHz, 30 kHz, or 60 kHz. A control channel (e.g., a physical downlink control channel (PDCCH), a physical uplink control channel (PUCCH)), and a data channel (e.g., a physical downlink shared channel (PDSCH), a physical uplink shared channel (PUSCH)) may be configured in units of symbols. The processing latency and GP may be defined in units of symbols. When the processing latency and GP are present at the same time, the latency including the processing latency and the GP may be defined in units of symbols.

The downlink control channel may include at least one of scheduling information (e.g., resource allocation information) of downlink data, scheduling information (e.g., resource allocation information) of uplink data, a hybrid automatic repeat request (HARQ) response (e.g., ACK or NACK) for the uplink data, and scheduling information (e.g., resource allocation information) of the uplink control channel. The uplink control channel may include an HARQ response (e.g., ACK or NACK) for the downlink data, channel quality information (e.g., channel quality indicator (CQI)), and the like. A sounding reference signal (SRS) may be transmitted through the uplink channel.

FIG. 10 is a conceptual diagram showing a first embodiment of a radio transmission latency in a communication system.

Referring to FIG. 10, a communication system may comprise a base station and a terminal, each of which includes a layer 1 (L1), a layer 2 (L2), a layer 3 (L3), and an application layer (APP). A DL radio transmission latency may occur in the downlink transmission between the base station and the terminal, and requirement of the DL radio transmission latency may be equal to or less than 0.2 ms. For example, the DL radio transmission latency may be a time from when a signal is received from the layer 2 (L2) of the base station to when the corresponding signal is transmitted to the layer 2 (L2) of the terminal. The DL radio transmission latency may include an L1 processing latency of the base station, a DL propagation delay, and an L1 processing latency of the terminal. The DL radio transmission latency may be as follows.

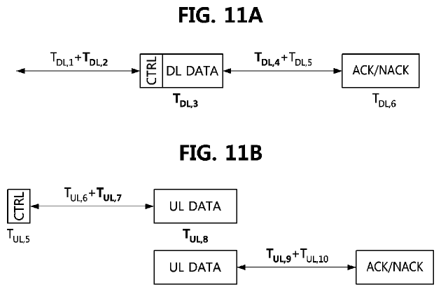

FIG. 11A is a conceptual diagram showing a first embodiment of a DL radio transmission latency in a communication system.

Referring to FIG. 11A, the DL radio transmission latency may be defined as ‘T_{DL,2}+T_{DL,3}+T_{DL,4},’ and the meanings of T_{DL,2}, T_{DL,3}, and T_{DL,4} are as shown in Table 3.

Referring again to FIG. 10, a UL radio transmission latency may occur in the uplink transmission between the base station and the terminal, and requirement of the UL radio transmission latency may be equal to or less than 0.2 ms. For example, the UL radio transmission latency may be a time from when a signal is received from the layer 2 (L2) of the terminal to when the corresponding signal is transmitted to the layer 2 (L2) of the base station. The UL radio transmission latency may include an L1 processing latency of the terminal, a UL propagation delay, and an L1 processing latency of the base station. The UL radio transmission latency may be as follows.

FIG. 11B is a conceptual diagram showing a first embodiment of a UL radio transmission latency in a communication system.

Referring to FIG. 11B, the UL radio transmission latency may be defined as ‘T_{UL,7}+T_{UL,8}+T_{UL,9},’ and the meanings of T_{UL,7}, T_{UL,8}, and T_{UL,9} are as shown in Table 4.

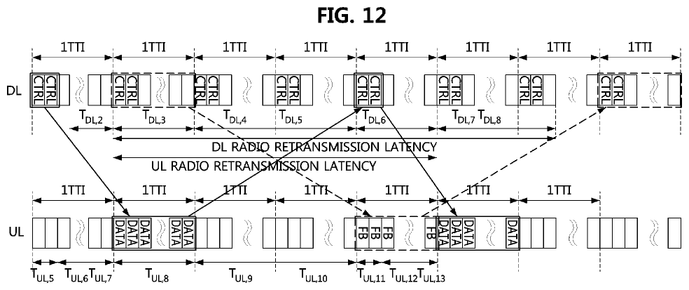

FIG. 12 is a conceptual diagram showing a first embodiment of a data (re)transmission latency in a communication system.

Referring to FIG. 12, a base station may transmit a control channel (CTRL) including a DL grant and a data channel scheduled by the DL grant to a terminal. The terminal may receive the control channel (CTRL) from the base station, and receive the data channel through time-frequency resources indicated by the DL grant included in the control channel (CTRL). The terminal may perform a decoding operation on downlink data included in the data channel, and transmit a feedback signal FB as a result of the decoding operation to the base station. The base station may receive the feedback signal FB for the downlink data from the terminal, and perform a data retransmission procedure or a new data transmission procedure based on the feedback signal FB. Here, a transmission unit of the data may include one TTI composed of 14 symbols.

In the downlink communication, the DL radio transmission latency may be defined as ‘T_{DL,2}+T_{DL,3}+T_{DL,4}.’ When each of T_{DL,2}, T_{DL,3}, and T_{DL,4} is defined as follows, the DL radio transmission latency may be 2.5T_{DL,TTI}. T_{DL,TTI} may be the length of the TTI in the downlink communication.
T_{DL,2}: 0.6T_{DL,TTI}
T_{DL,3}: 1T_{DL,TTI}
T_{DL,4}: 0.9T_{DL,TTI}

In the uplink communication, the base station may transmit a control channel (CTRL) including a UL grant to the terminal. The terminal may receive the control channel (CTRL) from the base station, and transmit a data channel including uplink data to the base station through time-frequency resources indicated by the UL grant included in the control channel (CTRL). The base station may receive the data channel through the time-frequency resources indicated by the UL grant, and perform a decoding operation on the uplink data included in the data channel. The base station may transmit to the terminal a control channel (CTRL) including a feedback signal as a result of the decoding operation. The terminal may receive the control channel (CTRL) from the base station, and perform a data retransmission procedure or a new data transmission procedure based on the feedback signal included in the control channel (CTRL).

In the uplink communication, the UL radio transmission latency may be defined as ‘T_{UL,7}+T_{UL,8}+T_{UL,9}.’ When each of T_{UL,7}, T_{UL,8}, and T_{UL,9} is defined as follows, the UL radio transmission latency may be 2.5T_{UL,TTI}. T_{UL,TTI} may be the length of the TTI in the uplink communication.
T_{UL,7}: 0.6T_{UL,TTI}
T_{UL,8}: 1T_{UL,TTI}
T_{UL,9}: 0.9T_{UL,TTI}

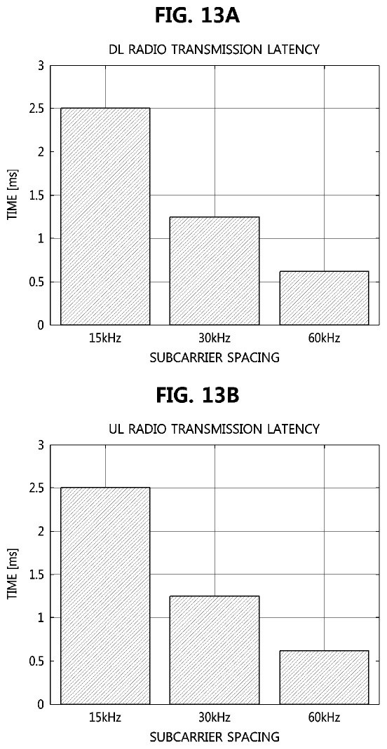

FIG. 13A is a graph showing measurement results of DL radio transmission latencies in a communication system, and FIG. 13B is a graph showing measurement results of UL radio transmission latencies in a communication system.

Referring to FIGS. 13A and 13B, when a subcarrier spacing of 60 kHz is used, each of the DL radio transmission latency and the UL radio transmission latency may be less than 1 ms. However, even when the subcarrier spacing of 60 kHz is used, each of the DL radio transmission latency and UL radio transmission latency is equal to or greater than 0.5 ms, and therefore, a method for further reducing the latency is required to satisfy the above-described requirement (0.2 ms).

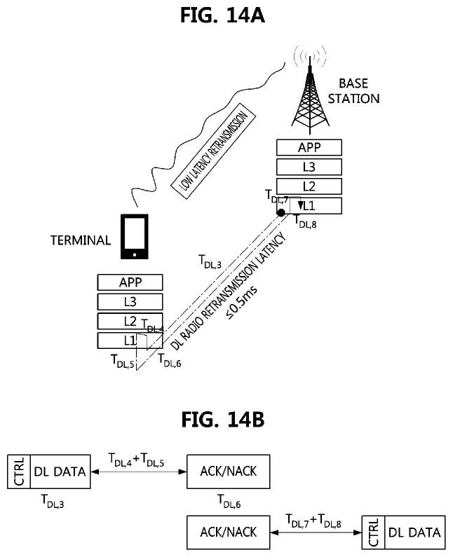

FIG. 14A is a conceptual diagram showing a first embodiment of a downlink data retransmission procedure in a communication system, and FIG. 14B is a conceptual diagram showing a first embodiment of a DL radio retransmission latency in a communication system. The requirement for the radio retransmission latency may be equal to or less than 0.5 ms.

Referring to FIGS. 14A and 14B, a communication system may comprise a base station and a terminal, each of which may include a layer 1 (L1), a layer 2 (L2), a layer 3 (L3), and an application layer (APP). Also, the base station and the terminal may support low-latency communications. One TTI may be composed of 14 symbols. The DL radio retransmission latency may a time from when downlink data is transmitted from the layer 1 (L1) of the base station to when a preparation of retransmission of the downlink data according to an HARQ response for the downlink data is completed at the layer 1 (L1) of the base station. The DL radio retransmission latency may be defined as ‘T_{DL,3}+T_{DL,4}+T_{DL,5}+T_{DL,6}+T_{DL,7}+T_{DL,8},’ and the meanings of the T_{DL,3}, T_{DL,4}, T_{DL,5}, T_{DL,6}, T_{DL,7}, and T_{DL,8} may be as shown in Table 3.

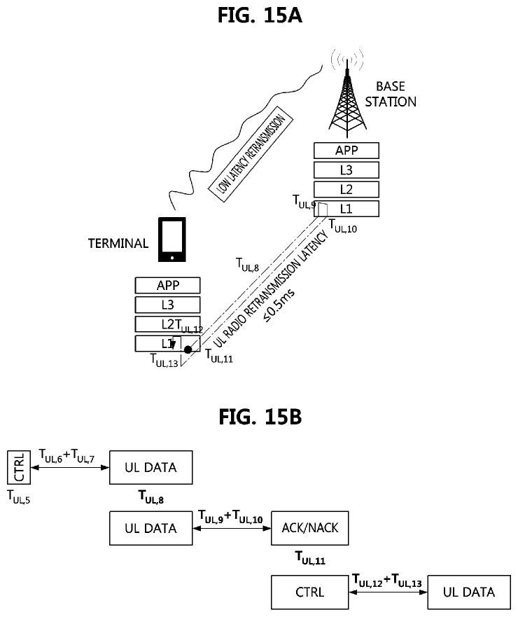

FIG. 15A is a conceptual diagram showing a first embodiment of an uplink data retransmission procedure in a communication system, and FIG. 15B is a conceptual diagram showing a first embodiment of a UL radio retransmission latency in a communication system. The requirement for the radio retransmission latency may be equal to or less than 0.5 ms.

Referring to FIGS. 15A and 15B, a communication system may comprise a base station and a terminal, each of which may include a layer 1 (L1), a layer 2 (L2), a layer 3 (L3), and an application layer (APP). Also, the base station and the terminal may support low-latency communications. One TTI may be composed of 14 symbols. The UL radio retransmission latency may a time from when uplink data is transmitted from the layer 1 (L1) of the terminal to when a preparation of retransmission of the uplink data according to an HARQ response (i.e., feedback signal) for the uplink data is completed at the layer 1 (L1) of the terminal. The UL radio retransmission latency may be defined as ‘T_{UL,8}+T_{UL,9}+T_{UL,10}+T_{UL,11}+T_{UL,12}+T_{UL,13},’ and the meanings of the T_{UL,8}, T_{UL,9}, T_{UL,10}, T_{UL,11}, T_{UL,12}, and T_{UL,13} may be as shown in Table 4.

Meanwhile, when the data is retransmitted n times, a probability Pₛ(n) that the data is successfully received may be defined as Equation 1 below. Here, n may be an integer equal to or greater than 1.

Pₛ(n)=pⁿ⁻¹(1−p) [Equation 1]

p may indicate a transmission failure probability (or a reception failure probability) of the data. p may be a value which is equal to or greater than 0 and equal to or less than 1. A time (e.g., transmission latency) at which the data is expected to be successfully received may be defined as Equation 2 below.

$$\begin{matrix}E ( T ) = {\sum }_{k = 1}^{∞} {P}_{s} ( k ) \times kt \\ = {\sum }_{k = 1}^{∞} ( 1 - p ) {p}^{k - 1} \times kt \\ = ( 1 - p ) t {\sum }_{k = 1}^{∞} {kp}^{k - 1} \\ ≅ \frac{( 1 - p ) t}{{( 1 - p )}^{2}} = \frac{t}{1 - p}\end{matrix} \qquad [ Equation 2 ]$$

E(T) may indicate a transmission latency, and t may indicate an HARQ round trip time (RTT). In the downlink retransmission procedure shown in FIGS. 14A and 14B, T_{DL,3}, (T_{DL,4}+T_{DL,5}), T_{DL,6}, and (T_{DL,7}+T_{DL,8}) may be defined as shown in Equation 3 below. T_{DL,symbol} may indicate the symbol length in downlink communication.

$${T}_{DL , 3} = {T}_{DL , TTI} = 1 TTI , \\ {T}_{DL , 4} + {T}_{DL , 5} = ⌈ \frac{{T}_{DL , 4} + {T}_{DL , 5}}{{T}_{UL , TTI}} ⌉ \times {T}_{UL , TTI} = ⌈ \frac{1.5 {T}_{UL , TTI}}{{T}_{UL , TTI}} ⌉ \times {T}_{UL , TTI} = {T}_{UL , TTI} = 2 TTI , \\ {T}_{DL , 6} = {T}_{UL , TTI} = 1 TTI , \\ {T}_{DL , 7} + {T}_{DL , 8} = ⌈ \frac{{T}_{DL , 7} + {T}_{DL , 8}}{{T}_{DL , symbol}} ⌉ \times {T}_{DL , symbol} = ⌈ \frac{1.5 {T}_{DL , TTI}}{{T}_{DL , symbol}} ⌉ \times {T}_{DL , symbol} \leq 2 {T}_{DL , TTI} \qquad [ Equation 3 ]$$

Based on Equation 3, the DL radio retransmission latency may be defined as Equation 4 below.

$$DL Radio Retransmission latency = {T}_{DL , 3} + {T}_{DL , 4} + {T}_{DL , 5} + {T}_{DL , 6} + {T}_{DL , 7} + {T}_{DL , 8} , \\ 1 {T}_{DL , TTI} + {T}_{UL , TTI} + ⌈ \frac{{T}_{DL , 4} + {T}_{DL , 5}}{{T}_{UL , TTI}} ⌉ \times {T}_{UL , TTI} + ⌈ \frac{{T}_{DL , 7} + {T}_{DL , 8}}{{T}_{DL , symbol}} ⌉ \times {T}_{DL , symbol} = 1 {T}_{DL , TTI} + 3 {T}_{UL , TTI} + ⌈ \frac{1.5 {T}_{DL , TTI}}{{T}_{DL , symbol}} ⌉ \times {T}_{DL , symbol} \qquad [ Equation 4 ]$$

For example, when the downlink TTI (i.e., T_{DL,TTI}) is equal to the uplink TTI (i.e., T_{UL,TTI}), the maximum value of the DL radio retransmission latency may be 5 TTIs. That is, in the embodiment shown in FIG. 12, the maximum value of the DL radio retransmission latency may be 5 TTIs.

In the uplink retransmission procedure shown in FIGS. 15A and 15B, T_{UL,8}, (T_{UL,9}+T_{UL,10}), T_{DL,11}, and (T_{UL,11}+T_{UL,12}+T_{UL,13}) may be defined as shown in Equation 5 below. T_{UL,symbol} may indicate the symbol length in uplink communication, and T_{DL,CTRL} may indicate the length of the downlink control channel.

$${T}_{UL , 8} = {T}_{UL , TTI} = 1 TTI , \\ {T}_{UL , 9} + {T}_{UL , 10} = ⌈ \frac{{T}_{UL , 9} + {T}_{UL , 10}}{{T}_{DL , TTI}} ⌉ \times {T}_{DL , TTI} = ⌈ \frac{1.5 {T}_{DL , TTI}}{{T}_{DL , TTI}} ⌉ \times {T}_{DL , TTI} = 2 {T}_{DL , TTI} = 2 TTI , \\ {T}_{UL , 11} ( = {T}_{DL , CTRL} ) \leq 3 {T}_{DL , symbol} , \\ {T}_{UL , 11} + {T}_{UL , 12} + {T}_{UL , 13} = ⌈ \frac{{T}_{UL , 11} + {T}_{UL , 12} + {T}_{UL , 13}}{{T}_{UL , symbol}} ⌉ \times {T}_{UL , symbol} = ⌈ \frac{{T}_{UL , 11} + 0.9 {T}_{UL , 11} + 0.6 {T}_{UL , 14}}{{T}_{UL , symbol}} ⌉ \times {T}_{UL , symbol} \leq 1 {T}_{UL , TTI} \qquad [ Equation 5 ]$$

Based on Equation 5, the UL radio retransmission latency may be defined as Equation 6 below.

$$UL Radio Retransmission latency = {T}_{UL , 8} + {T}_{UL , 9} + {T}_{UL , 10} + {T}_{UL , 11} + {T}_{UL , 12} + {T}_{UL , 13} , \\ {T}_{UL , TTI} + ⌈ \frac{{T}_{UL , 9} + {T}_{UL , 10}}{{T}_{DL , TTI}} ⌉ \times {T}_{DL , TTI} + ⌈ \frac{{T}_{UL , 11} + {T}_{UL , 12} + {T}_{UL , 13}}{{T}_{UL , symbol}} ⌉ \times {T}_{UL , symbol} \leq 2 {T}_{DL , TTI} + 2 {T}_{UL , TTI} \qquad [ Equation 6 ]$$

For example, when the downlink TTI (i.e., T_{DL,TTI}) is equal to the uplink TTI (i.e., T_{UL,TTI}), the downlink symbol length (T_{DL,symbol}) is equal to the uplink symbol length (T_{UL,symbol}), and the length of the DL control channel (T_{DL,CTRL}) is the length of 2 symbols, the maximum value of the UL radio retransmission latency may be 4 TTIs. That is, in the embodiment shown in FIG. 12, the maximum value of the UL radio retransmission latency may be 4 TTIs.

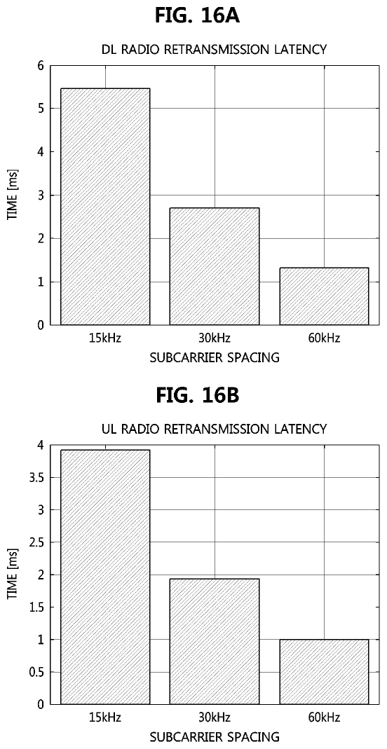

FIG. 16A is a graph showing measurement results of DL radio retransmission latencies in a communication system, and FIG. 16B is a graph showing measurement results of UL radio retransmission latencies in a communication system.

Referring to FIGS. 16A and 16B, when a subcarrier spacing of 60 kHz is used, each of the DL radio retransmission latency and the UL radio retransmission latency may be less than 1.5 ms. However, even when the subcarrier spacing of 60 kHz is used, each of the DL radio retransmission latency and UL radio retransmission latency is equal to or greater than 1 ms, and therefore, a method for further reducing the latency is required.

Method for Reducing a Latency Between Data Transmissions

In order to reduce the latency, data transmission may be performed on a mini-slot basis. The length of a slot (e.g., mini-slot) may vary depending on the number of symbols included in the corresponding slot (e.g., mini-slot). For example, the length of the slot may be as follows.

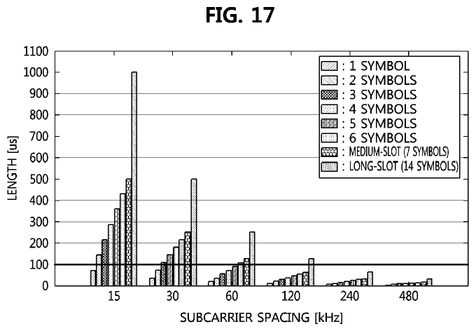

FIG. 17 is a table showing a length of a slot for each subcarrier spacing in a communication system.

Referring to FIG. 17, a long-slot may comprise 14 symbols (OS), and a medium-slot may comprise 7 symbols (OS). A mini-slot may comprise up to 6 symbols (OS). The length of the slot may vary depending on the subcarrier spacing. In the following embodiments, a transmission unit may be a long-slot, a medium-slot, or a mini-slot, and a processing operation and a feedback operation may be performed for each transmission unit.

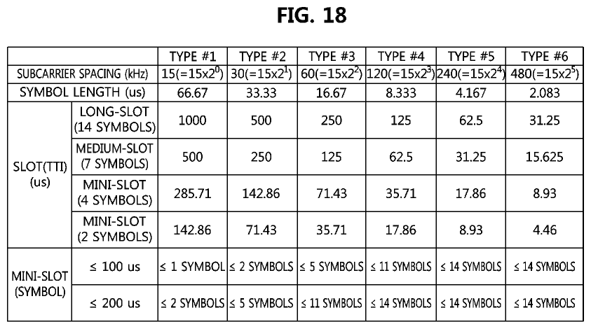

FIG. 18 is a conceptual diagram showing a first embodiment of numerologies of a mini-slot in a communication system.

Referring to FIG. 18, a mini-slot may comprise 2 symbols or 4 symbols. The length of the mini-slot may vary depending on the subcarrier spacing.

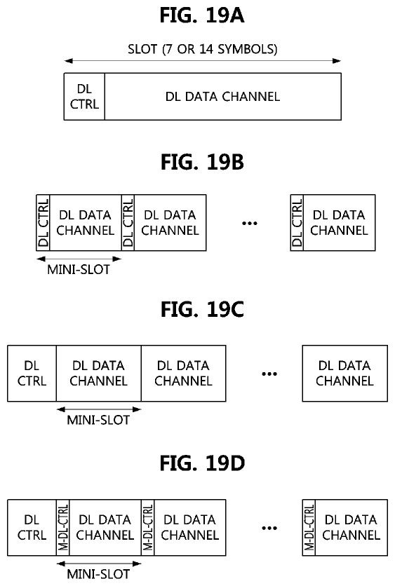

FIG. 19A is a conceptual diagram showing a first embodiment of a downlink subframe structure in a frequency division duplex (FDD) based communication system, FIG. 19B is a conceptual diagram showing a second embodiment of a downlink subframe structure in an FDD based communication system, FIG. 19C is a conceptual diagram showing a third embodiment of a downlink subframe structure in an FDD based communication system, and FIG. 19D is a conceptual diagram showing a fourth embodiment of a downlink subframe structure in an FDD based communication system.

Referring to FIG. 19A, a subframe may comprise one slot, and one slot may comprise 14 symbols (symbols #0 to #13). The symbols #0 to #3 in the slot may be configured as a downlink control channel, and the symbols #4 to #13 in the slot may be configured as a downlink data channel. Referring to FIGS. 19B to 19D, a subframe may comprise a plurality of mini-slots. The subframe including the mini-slots may be configured in the entire system band. Alternatively, the subframe including the mini-slots may be configured in some frequency region of the system band.

Configuration information of the mini-slot (e.g., the number of symbols constituting the mini-slot, the subcarrier spacing applied to the mini-slot, etc.) may be transmitted through a higher-layer message (e.g., a radio resource control (RRC) message), a medium access control (MAC) control element (CE), or a downlink control channel (e.g., downlink control information (DCI) included in the downlink control channel). Alternatively, the configuration information of the mini-slot may be preconfigured in the communication system.

The mini-slot shown in FIG. 19B may include a downlink control channel (DL CTRL) and a downlink data channel. The mini-slot shown in FIG. 19C may include a downlink data channel. For example, the mini-slot shown in FIG. 19C may be configured in the downlink data channel except the downlink control channel in the subframe. The mini-slot shown in FIG. 19D may be configured in the remaining region except the downlink control channel in the subframe. For example, the mini-slot shown in FIG. 19D may include a ‘mini-slot downlink control channel (hereinafter referred to as ‘M-DL CTRL’)’ and a downlink data channel.

The M-DL CTRL may include transmission characteristic information (e.g., modulation and coding scheme (MCS), HARQ-related information, transport block (TB) size, coded block size, and the like). Thus, when the M-DL CTRL is received, the communication node (e.g., base station or terminal) may receive the corresponding mini-slot based on the transmission characteristic information included in the M-DL CTRL. The M-DL CTRL may be configured as follows.

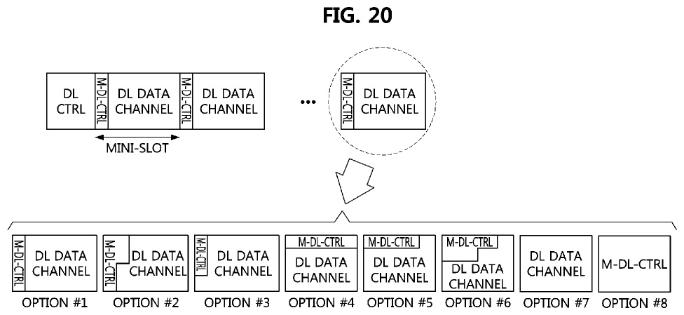

FIG. 20 is a conceptual diagram showing a first embodiment of an M-DL CTRL in a communication system.

Referring to FIG. 20, a mini-slot including the M-DL CTRL may be configured variously. In an option #1, the M-DL CTRL may be located in the front region within the mini-slot in the time axis. In options #2 and #3, the M-DL CTRL may be located in the front region within the mini-slot in the time axis, and the M-DL CTRL and the downlink data channel may be located together in some symbols. That is, in the frequency axis, the M-DL CTRL may be multiplexed with the downlink data channel.

In an option #4, the M-DL CTRL may be located in an arbitrary frequency region (e.g., upper, middle, or lower frequency region) within the mini-slot in the frequency axis. In options #5 and #6, the M-DL CTRL may be located in an arbitrary frequency region (e.g., upper, middle, or lower frequency region) within the mini-slot in the frequency axis, and the M-DL CTRL and the downlink data channel may be located together in some frequency region. That is, in the time axis, the M-DL CTRL may be multiplexed with the downlink data channel. In an option #7, all regions in the mini-slot may be configured as the downlink data channel. In an option #8, all regions in the mini-slot may be configured as the M-DL CTRL.

The M-DL CTRL may include one or more of the following information elements.
Resource information (e.g., region information)
   Time resource information (e.g., the number of symbols) of a mini-slot (e.g., a data channel in the mini-slot)
   Frequency resource information (e.g., the number of subcarriers, the number of resource blocks (RBs), the number of subbands) of a mini-slot (e.g., a data channel in the mini-slot)
Transmission-related information
   MCS
   TB size
   CB size
ACK/NACK feedback-related information for data transmission
   Feedback time (feedback transmission time after downlink data transmission)
   Feedback resource
   The feedback-related information may be maintained 1) before new feedback-related information is received in a downlink control channel scheduling an arbitrary downlink data transmission, 2) until a transmission completion time of the downlink data (e.g., HARQ retransmission completion time), or 3) before a preset timer expires.
   Also, the feedback-related information may be included in the M-DL CTRL and may be transmitted via the M-DL CTRL with scheduling information of data.
Receiving terminal information
   Radio network temporary identifier (RNTI) or cell-RNTI (C-RNTI)
Scheduling information
   Information indicating time-frequency resources to which the data channel is allocated

The receiving terminal information may indicate a terminal to receive the M-DL CTRL, and the terminal receiving (e.g., decoding) the M-DL CTRL may be restricted by the receiving terminal information. When the terminal receiving the M-DL CTRL belonging to a mini-slot is the same as the terminal receiving the data channel belong to the mini-slot, the receiving terminal information may not be included in the M-DL CTRL. When the M-DL CTRL indicates some terminals to receive the data channel among the terminals receiving the M-DL CTRL or when the M-DL CTRL indicates the data channel for the purpose of improving reliability, the M-DL CTRL may include the receiving terminal information.

The M-DL CTRL may be configured by a higher-layer message (e.g., an RRC message), a MAC CE, or a downlink control channel (e.g., DCI included in the downlink control channel). Alternatively, the M-DL CTRL may be preconfigured in the communication system.

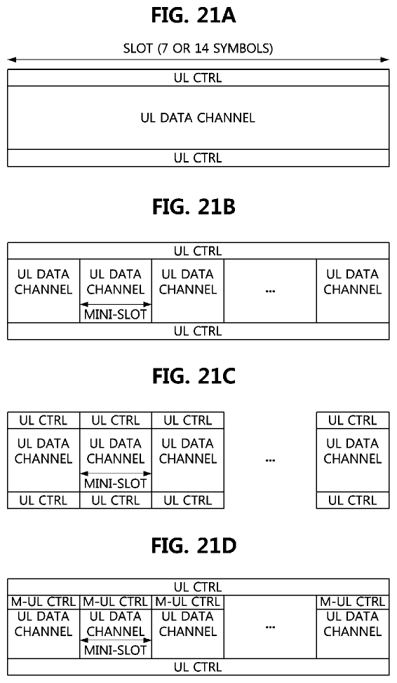

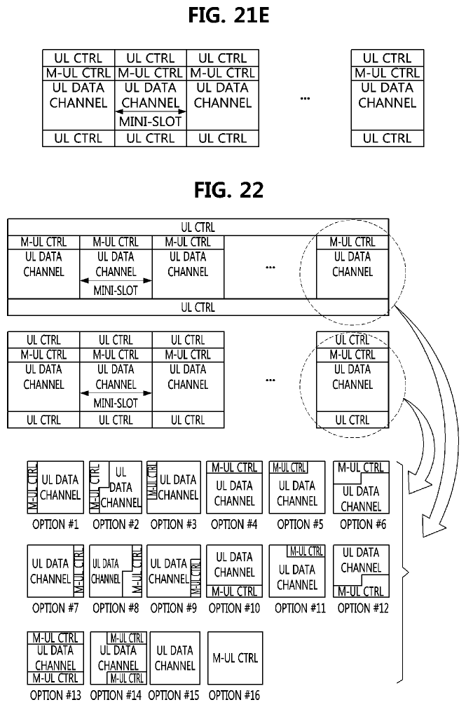

FIG. 21A is a conceptual diagram showing a first embodiment of an uplink subframe structure in an FDD-based communication system, FIG. 21B is a conceptual diagram showing a second embodiment of an uplink subframe structure in an FDD-based communication system, FIG. 21C is a conceptual diagram showing a third embodiment of an uplink subframe structure in an FDD-based communication system, FIG. 21D is a conceptual diagram showing a fourth embodiment of an uplink subframe structure in an FDD-based communication system, and FIG. 21E is a conceptual diagram showing a fifth embodiment of an uplink subframe structure in an FDD-based communication system.

Referring to FIG. 21A, one subframe may comprise one slot, and one slot may be composed of 14 symbols (symbols #0 to #13). An uplink control channel (UL CTRL) may be configured in a specific frequency region (e.g., some subcarriers, RBs, and subbands in the system band) in the slot, and an uplink data channel may be configured in a frequency region other than the specific frequency region in which the uplink control channel (UL CTRL) is configured.

Referring to FIGS. 21B to 21E, a subframe may comprise a plurality of mini-slots, and the subframe comprising the mini-slots may be configured in the entire system band. Alternatively, the subframe including the mini-slots may be configured in some frequency region of the system band. A mini-slot may be assigned to one or more specific terminals. The mini-slot may be used for transmission of a scheduling request (SR), transmission of channel measurement information, transmission of a sounding reference signal (SRS), and transmission of an HARQ response for downlink data.

The uplink mini-slot may be configured to be the same as the downlink mini-slot. In this case, the uplink mini-slot may be configured based on the configuration information of downlink mini-slot. Therefore, configuration information for the uplink mini-slot may not be signaled separately. Alternatively, the uplink mini-slot may be configured independently of the downlink mini-slot. In this case, the uplink mini-slot may be configured based on at least one of a higher-layer message (e.g., RRC message), a MAC CE, and a downlink control channel (e.g., DCI included in the downlink control channel). Alternatively, the uplink mini-slot may be preconfigured in the communication system.

The mini-slot shown in FIG. 21B may include an uplink data channel. The mini-slot shown in FIG. 21C may include an uplink control channel (UL CTRL) and an uplink data channel. The mini-slot shown in FIG. 21D may include a ‘mini-slot uplink control channel (hereinafter referred to as an ‘M-UL CTRL’)’ and an uplink data channel. The mini-slot shown in FIG. 21E may include an uplink control channel (UL CTRL), an M-UL CTRL, and an uplink data channel.

The M-UL CTRL may indicate a terminal performing communication (e.g., downlink/uplink communication), and the terminal indicated by the M-UL CTRL may perform at least one of an SR transmission operation, a channel measurement information reporting operation, an SRS transmission operation, and an HARQ response transmission operation for downlink data. The M-DL CTRL may be configured as follows.

FIG. 22 is a conceptual diagram showing a first embodiment of an M-UL CTRL in a communication system.

Referring to FIG. 22, a mini-slot including the M-UL CTRL may be configured variously. The mini-slot including the M-UL CTRL may be configured similarly to the mini-slot including the M-DL CTRL described above. In order to secure a processing time for transmitting an HARQ response for downlink data, the mini-slot including the M-UL CTRL may be configured according to an option #7, #8, #9, #11, or #14.

The M-UL CTRL may include one or more of the following information elements. Also, the M-UL CTRL may be used for transmission of the SRS.
HARQ response (e.g., ACK or NACK) for downlink data;
Channel measurement information (e.g., channel quality indicator (CQI), channel state information (CSI))

The above information elements may be transmitted through an uplink data channel instead of the M-UL CTRL. In this case, the mini-slot may be configured as shown in FIG. 21B or 21C. That is, the mini-slot may not include the M-UL CTRL.

The HARQ response information for downlink data (e.g., feedback-related information) may include the following information.
Feedback time (feedback time after transmission of the downlink data)
Feedback resource
The feedback-related information may be maintained 1) before new feedback-related information is received in a downlink control channel scheduling an arbitrary downlink data transmission, 2) until a transmission completion time of downlink data (e.g., HARQ retransmission completion time), or 3) before a preset timer expires.
Also, the feedback-related information may be included in the M-DL CTRL. The feedback-related information included in the M-DL CTRL may be maintained either 1) before new feedback-related information (or next feedback-related information) is included in the M-DL CTRL, or 2) before a preset timer expires.

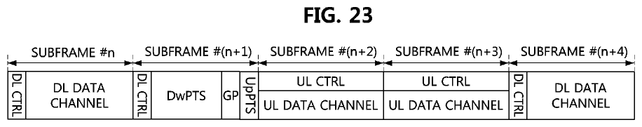

FIG. 23 is a conceptual diagram showing a first embodiment of a subframe structure in a time division duplex (TDD) based communication system.

Referring to FIG. 23, a downlink subframe may be configured to be the same as or similar to the subframes shown in FIGS. 19A to 19D, and an uplink subframe may be configured to be the same as or similar to the subframes shown in FIGS. 21A to 21E. A special subframe may be used for switching between downlink and uplink communications. The special subframe may include a downlink pilot time slot (DwPTS), a guard period (GP), and an uplink pilot time slot (UpPTS). The special subframe may be referred to as a ‘self-contained (SC) subframe.’

The DwPTS (e.g., the DwPTS in the subframe #n+1 shown in FIG. 23) may be used for downlink communication, and may be configured to be the same as or similar to the downlink subframe (e.g., the subframe #n shown in FIG. 23). Alternatively, the DwPTS may be configured independently of the downlink subframe. The GP (e.g., the GP in the subframe #n+1 shown in FIG. 23) may be a time required for RF change for switching between downlink communication and uplink communication. The UpPTS (e.g., the UpPTS in the subframe #n+1 shown in FIG. 23) may be used for uplink communication, and may be configured to be the same as or similar to the uplink subframe (e.g., the subframes #n+2 to #n+3 shown in FIG. 23). Alternatively, the UpPTS may be configured independently of the uplink subframe.

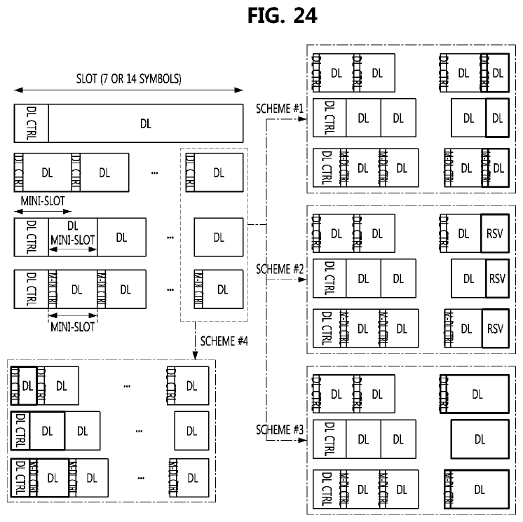

FIG. 24 is a conceptual diagram showing a first embodiment of a mini-slot structure in a downlink subframe.

Referring to FIG. 24, the length of one subframe (or one slot) may not be divided by the length of one mini-slot. In this case, the last mini-slot in the subframe may be configured as follows. The configuration information of the mini-slot described below may be transmitted from the base station to the terminal.

Scheme #1

The length (i.e., the number of symbols) of the last mini-slot in the subframe may be configured to be shorter than the length of other mini-slots. For example, when the mini-slot is configured as in the embodiment shown in FIG. 19B, the slot comprises 14 symbols, and the mini-symbol configuration unit is 3 symbols, the last mini-slot in the slot may be composed of 2 symbols, and each of the mini-slots except the last mini-slot may be composed of 3 symbols.

For example, when the mini-slot is configured as in the embodiment shown in FIG. 19C or 19D, the slot comprises 14 symbols, the downlink control channel is composed of 3 symbols, and the mini-symbol configuration unit is 3 symbols, the last mini-slot in the slot may be composed of 2 symbols, and each of the mini-slots except the last mini-slot may be composed of 3 symbols.

Scheme #2

When the length (i.e., the number of symbols) of the last mini-slot in the slot is set to be shorter than the length of other mini-slots in the slot, the last mini-slot may not be used for data transmission.

Scheme #3

When the length (i.e., the number of symbols) of the last mini-slot in the slot is set to be shorter than the length of other mini-slots in the slot, the last mini-slot and the mini-slot in front of the last mini-slot may be integrated into one mini-slot. For example, when the mini-slot is configured as in the embodiment shown in FIG. 19B, the slot comprises 14 symbols, and the mini-slot configuration unit is 3 symbols, the last mini-slot in the slot may be composed of 5 symbols, and each of the mini-slots except for the last mini-slot may be composed of 3 symbols.

For example, when the mini-slot is configured as in the embodiment shown in FIG. 19C or 19D, the slot comprises 14 symbols, the downlink control channel is composed of 3 symbols, and the mini-symbol configuration unit is 3 symbols, the last mini-slot in the slot may be composed of 5 symbols, and each of the mini-slots except the last mini-slot may be composed of 3 symbols.

Scheme #4

When the length (i.e., the number of symbols) of the last mini-slot in the slot is set to be shorter than the length of other mini-slots in the slot, the lengths of the remaining mini-slots except the first mini-slot may be configured to be the same, and the length of the first mini-slot and/or the length of the downlink control channel may be adjusted according to the length of the remaining mini-slots.

For example, when all mini-slots belonging to the slot are composed of 3 symbols, the downlink control channel in the slot may be composed of 2 or 5 symbols. Alternatively, the sum of the length of the first mini-slot in the slot and the length of the downlink control channel may be set to 5 symbols, and each of the remaining mini-slots except the first mini-slot may be composed of 3 symbols. In this case, the ratio of the number of symbols constituting the first mini-slot to the number of symbols constituting the downlink control channel may be 1:4, 2:3, 3:2 or 4:1.

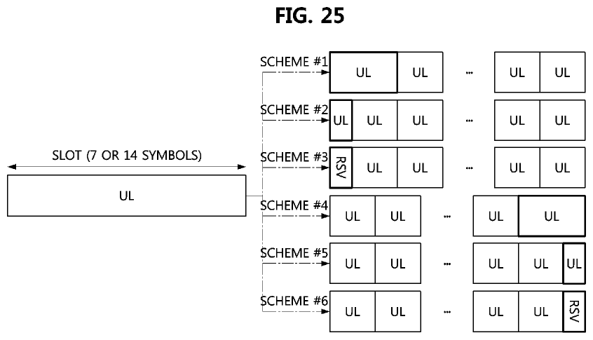

FIG. 25 is a conceptual diagram showing a first embodiment of a mini-slot structure in an uplink subframe.

Referring to FIG. 25, the length of one subframe (or one slot) may not be divided by the length of one mini-slot. In this case, the last mini-slot in the subframe may be configured as follows. The configuration information of the mini-slot described below may be transmitted from the base station to the terminal.

Schemes #1˜#3

The lengths (i.e., the number of symbols) of the remaining mini-slots except the first mini-slot may be configured to be the same. For example, when each of the remaining mini-slots comprises 3 symbols, the first mini-slot may be composed of 5 symbols in a scheme #1, and the first mini-slot may be composed of 2 symbols in schemes #2 to #3. In the scheme #3, the first mini-slot may not be used for data transmission. For example, the first mini-slot in the scheme #3 may be used for a processing time for switching between downlink and uplink communications, transmission of uplink control information (e.g., channel measurement information, SR), or transmission of SRS.

Schemes #4˜#6

The lengths (i.e., the number of symbols) of the remaining mini-slots except the last mini-slot may be configured to be the same. For example, when each of the remaining mini-slots comprises 3 symbols, the last mini-slot may be composed of 5 symbols in a scheme #4, and the last mini-slot may be composed of 2 symbols in schemes #5 to #6. In the scheme #6, the last mini-slot may not be used for data transmission. For example, the last mini-slot in the scheme #6 may be used for a processing time for uplink transmission through the mini-slot prior to the last mini-slot, transmission of uplink control information (e.g., channel measurement information, SR), or transmission of SRS.

Meanwhile, the mini-slots included in the special subframe may be configured as follows.

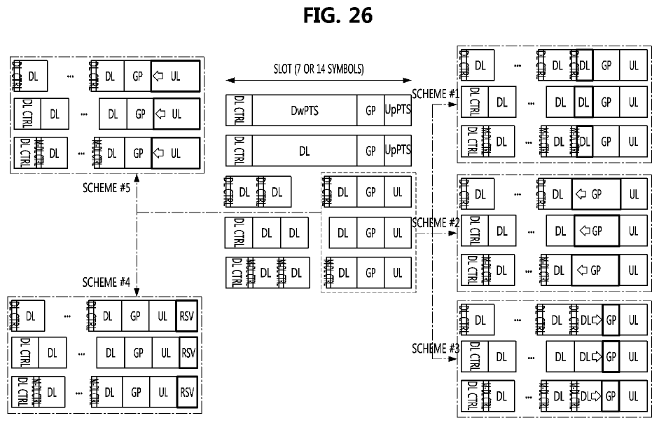

FIG. 26 is a conceptual diagram showing a first embodiment of a mini-slot structure in a special subframe.

Referring to FIG. 26, the DwPTS of the special subframe may be configured as in the embodiments shown in FIG. 24. That is, the DwPTS of the special subframe may include the mini-slots shown in FIG. 24. The UpPTS of the special subframe may be configured as in the embodiments shown in FIG. 25. That is, the UpPTS of the special subframe may include the mini-slots shown in FIG. 25.

Scheme #1

The lengths (e.g., the number of symbols) of the mini-slots other than the last mini-slot among the min-slots belonging to the DwPTS may be configured to be the same.

Scheme #2

The length of the GP may be adjusted so that the lengths (e.g., number of symbols) of all mini-slots belonging to the DwPTS are the same. For example, when the length of the last mini-slot configured according to the scheme #1 is different from the length of the remaining mini-slots, the last mini-slot may be configured as the GP. That is, the length of the GP may increase.

Scheme #3

The length of the GP may be adjusted so that the lengths (e.g., number of symbols) of all mini-slots belonging to the DwPTS are the same. For example, when the length of the last mini-slot configured according to the scheme #1 is different from the length of the remaining mini-slots, the length of the GP may be reduced so that the length of the last mini-slot is equal to the length of the remaining mini-slots.

Scheme #4

When the length of the last mini-slot configured according to the scheme #1 is different from the length of the remaining mini-slots, the last mini-slot may be configured as the GP and the UpPTS. That is, the GP and UpPTS may be moved, and the last region (RSV) of the special subframe formed by the movement of the GP and UpPTS may not be used for data transmission. Alternatively, the last region (RSV) of the special subframe may be used for other purposes (e.g., transmission of an uplink control channel or SRS transmission).

Scheme #5

When the length of the last mini-slot configured according to the scheme #1 is different from the length of the remaining mini-slots, the last mini-slot may be configured as the GP and the UpPTS. The UpPTS may be configured from the end point of the GP to the end point of the special subframe.

Meanwhile, a processing latency for each functional block in the signal transmission and reception procedure may be as follows.

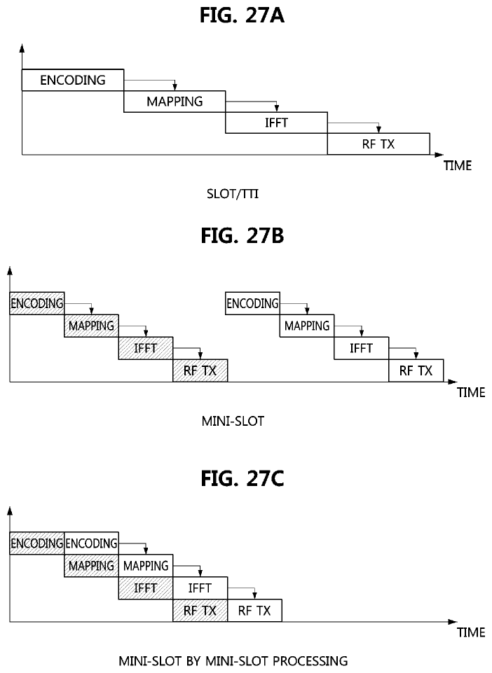

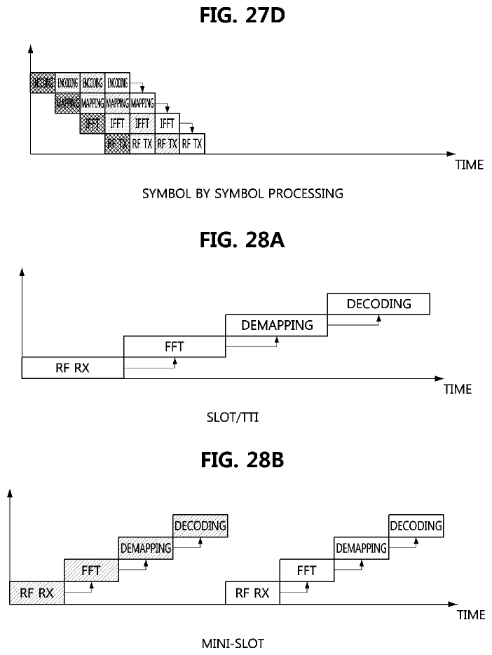

FIG. 27A is a timing diagram showing a first embodiment of a processing latency in a signal transmission procedure, FIG. 27B is a timing diagram showing a second embodiment of a processing latency in a signal transmission procedure, FIG. 27C is a timing diagram showing a third embodiment of a processing latency in a signal transmission procedure, and FIG. 27D is a timing diagram showing a fourth embodiment of a processing latency in a signal transmission procedure.

Referring to FIGS. 27A to 27D, a processing latency in the signal transmission procedure may be ‘encoding latency+mapping latency+inverse fast Fourier transform (IFFT) latency+RF transmission latency.’ The encoding operation, the mapping operation, the IFFT operation, and the RF transmission operation may be respectively performed by different functional blocks. When the signal transmission procedure is performed on a slot basis (e.g., in a TTI unit), a processing latency on a slot basis may occur. When the signal transmission procedure is performed on a mini-slot basis, a processing latency on a mini-slot basis may occur. Further, the signal transmission procedure on the mini-slot basis may be performed in parallel. That is, a ‘mini-slot by mini-slot processing’ may be performed, and the processing latency in this case may be the same as the embodiment shown in FIG. 27C.

When the signal transmission procedure is performed on a symbol basis, a processing latency on a symbol basis may occur. Also, the signal transmission procedure on the symbol basis may be performed in parallel. That is, a ‘symbol by symbol processing’ may be performed, and the processing latency in this case may be the same as the embodiment shown in FIG. 27D.

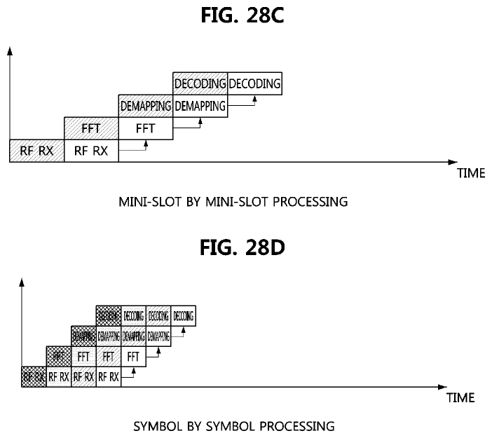

FIG. 28A is a timing diagram showing a first embodiment of a processing latency in a signal reception procedure, FIG. 28B is a timing diagram showing a second embodiment of a processing latency in a signal reception procedure, FIG. 28C is a timing diagram showing a third embodiment of a processing latency in a signal reception procedure, and FIG. 28D is a timing diagram showing a fourth embodiment of a processing latency in a signal reception procedure.

Referring to FIGS. 28A to 28D, a processing latency in the signal reception procedure may be ‘RF reception latency+fast Fourier transform (FFT) latency+demapping latency+decoding latency.’ The RF reception operation, the FFT operation, the demapping operation, and the decoding operation may be respectively performed by different functional blocks. When the signal reception procedure is performed on a slot basis (e.g., in a TTI unit), a processing latency on a slot basis may occur. When the signal reception procedure is performed on a mini-slot basis, a processing latency on a mini-slot basis may occur. Further, the signal reception procedure on the mini-slot basis may be performed in parallel. That is, a ‘mini-slot by mini-slot processing’ may be performed, and the processing latency in this case may be the same as the embodiment shown in FIG. 28C.

When the signal reception procedure is performed on a symbol basis, a processing latency on a symbol basis may occur. Also, the signal reception procedure on the symbol basis may be performed in parallel. That is, a ‘symbol by symbol processing’ may be performed, and the processing latency in this case may be the same as the embodiment shown in FIG. 28D.

The processing latency for each transmission unit may be as shown in Table 6 below.

TABLE 6

| Transmission | | | |
|---|---|---|---|
| unit | T_{proc} = T_{TX,proc} + T_{RX,proc} | T_{proc} for 1TTI(2s1ots) | T_{proc} for T_{data} |
| TTI | 1.5T_{TTI} = 0.6T_{TTI} + 0.9T_{TTI} | 15T_{TTI} | $1.5 {T}_{T T I} ⌈ \frac{{T}_{D A T A}}{{T}_{T T I}} ⌉$ |
| Slot | 1.5Tₛₗₒₜ = 0.6Tₛₗₒₜ + 0.9Tₛₗₒₜ | $1.5 {T}_{slot} ⌈ \frac{{T}_{T T I}}{{T}_{slot}} ⌉$ | $1.5 {T}_{slot} ⌈ \frac{{T}_{D A T A}}{{T}_{slot}} ⌉$ |
| Mini-slot | 1.5Tₘᵢₙᵢ₋ₛₗₒₜ = 0.6Tₘᵢₙᵢ₋ₛₗₒₜ + 0.9Tₘᵢₙᵢ₋ₛₗₒₜ | $1.5 {T}_{mini - slot} ⌈ \frac{{T}_{T T I}}{{T}_{mini - slot}} ⌉$ | $1.5 {T}_{mini - slot} ⌈ \frac{{T}_{D A T A}}{{T}_{mini - slot}} ⌉$ |
| Mini-slot by mini-slot processing | 1.5Tₘᵢₙᵢ₋ₛₗₒₜ | $1.5 {T}_{mini - slot} ( 1 + \frac{1}{4} ( ⌈ \frac{{T}_{T T I}}{{T}_{mini - slot}} ⌉ - 1 ) )$ | $1.5 {T}_{mini - slot} ( 1 + \frac{1}{4} ( ⌈ \frac{{T}_{D A T A}}{{T}_{mini - slot}} ⌉ - 1 ) )$ |
| Symbol by symbol processing | 1.5Tₘᵢₙᵢ₋ₛₗₒₜ | $1.5 {T}_{symbol} ( 1 + \frac{1}{4} ( ⌈ \frac{{T}_{T T I}}{{T}_{symbol}} ⌉ - 1 ) )$ | $1.5 {T}_{s y mbol} ( 1 + \frac{1}{4} ( ⌈ \frac{{T}_{D A T A}}{{T}_{symbol}} ⌉ - 1 ) )$ |

T_{proc} may indicate the total processing latency, T_{TXproc} may indicate the processing latency in the signal transmission procedure, and T_{RXproc} may indicate the processing latency in the signal reception procedure. T_{TTI} may indicate the length of one TTI, Tₛ₁ₒₜ may indicate the length of one slot, and Tₘᵢₙᵢ₋ₛₗₒₜ may indicate the length of one mini-slot. T_{symbol} may indicate the length of one symbol, and T_{DATA} may indicate the length of the data.

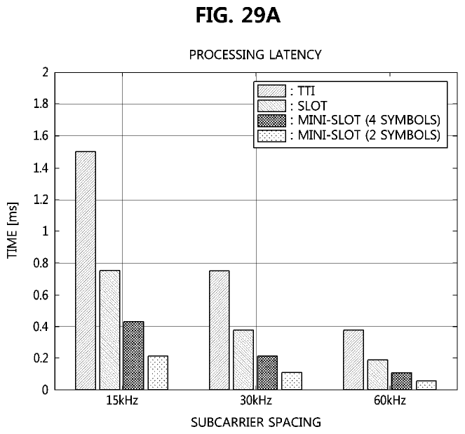

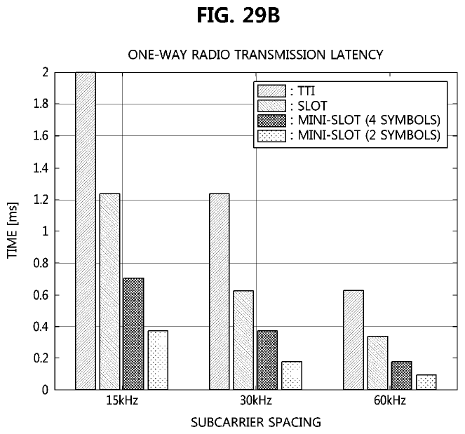

FIG. 29A is a graph showing a processing latency for each transmission unit, and FIG. 29B is a graph showing a one-way transmission latency for each transmission unit.

Referring to FIGS. 29A and 29B, when a transmission unit is reduced, the processing latency and the one-way transmission latency may be reduced. For example, when the transmission unit is a mini-slot comprising 2 symbols, the processing latency and the one-way transmission latency may be minimized.

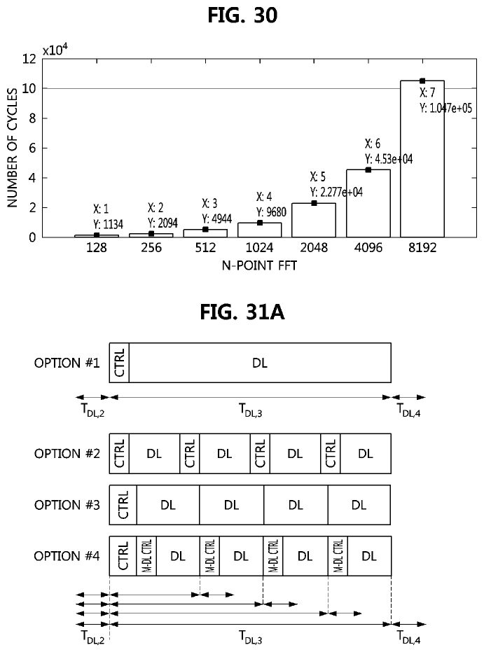

Meanwhile, the symbol length and the number of REs constituting the same frequency region may vary according to the subcarrier spacing. For example, as the subcarrier spacing increases, the symbol length may be shortened and the number of REs constituting the same frequency region may be reduced. Thus, the processing latency requirements may be mitigated, and the throughput of the data may be reduced. Therefore, the number of cycles of an FFT processing apparatus may be reduced as shown in FIG. 30. FIG. 30 is a graph showing the number of cycles of an FFT processing apparatus.

Meanwhile, a downlink radio transmission latency according to a subframe structure may be as follows.

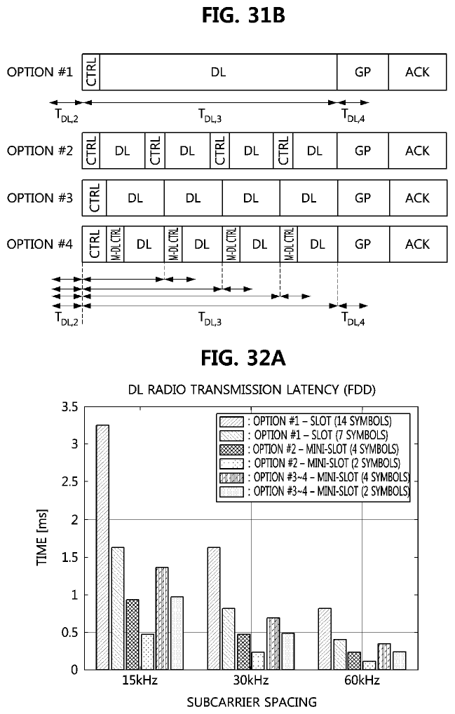

FIG. 31A is a conceptual diagram showing a first embodiment of a downlink radio transmission latency in an FDD based communication system, and FIG. 31B is a conceptual diagram showing a first embodiment of a downlink radio transmission latency in a self-contained (SC) TDD based communication system.

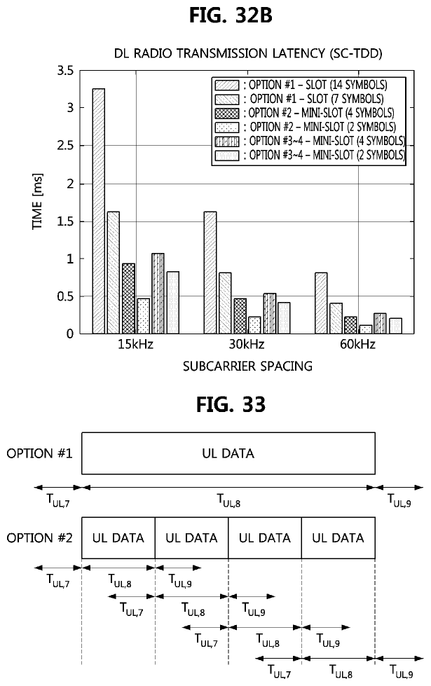

Referring to FIGS. 31A and 31B, a downlink radio transmission latency may be ‘T_{DL,2}+T_{DL,3}+T_{DL,4}.’ The T_{DL,2}, T_{DL,3}, and T_{DL,4} may be the values defined in Table 3, respectively. The downlink radio transmission latency may vary depending on the subframe structure (e.g., the scheme of configuring mini-slots included in the subframe). The downlink radio transmission latency according to the subframe structure may be the same as the graphs shown in FIGS. 32A and 32B.

FIG. 32A is a graph showing a first embodiment of a downlink radio transmission latency in an FDD based communication system, and FIG. 32B is a graph showing a first embodiment of a downlink radio transmission latency in an SC TDD based communication system.

Referring to FIGS. 32A and 32B, options #1 to #4 may indicate the options #1 to #4 shown in FIGS. 31A and 31B, respectively. When the mini-slot is configured according to the option #2, and the mini-slot comprises 2 symbols, the downlink radio transmission latency may be the shortest. For example, when a sub-carrier spacing of 15 kHz is used, the mini-slot is configured according to the option #2, and the mini-slot comprises 2 symbols, the downlink radio transmission latency may be equal to or less than 0.8 ms.

There is a need for a method for reducing the transmission latency of the HARQ response for the downlink data or the radio retransmission latency. Particularly, in the TDD-based communication system, when the option #3 or #4 is used, a method for reducing the radio retransmission latency is needed.

Meanwhile, an uplink radio transmission latency according to a subframe structure may be as follows.

FIG. 33 is a conceptual diagram showing a first embodiment of an uplink radio transmission latency in a communication system.

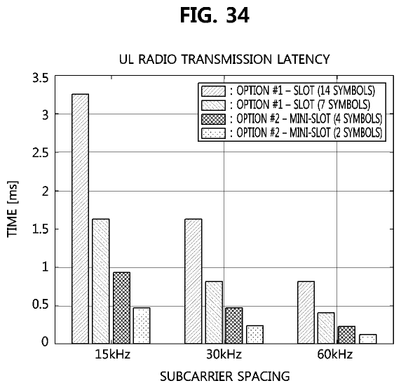

Referring to FIG. 33, an uplink radio transmission latency may be ‘T_{UL,7}+T_{UL,8}+T_{UL,9}.’ T_{UL,7}, T_{UL,8}, and T_{UL,9} may be the values defined in Table 4, respectively. The uplink radio transmission latency may vary depending on the subframe structure (e.g., the scheme of configuring mini-slots included in the subframe). The uplink radio transmission latency according to the subframe structure may be the same as the graphs shown in FIG. 34.

FIG. 34 is a graph showing a first embodiment of an uplink radio transmission latency in a communication system.

Referring to FIG. 34, options #1 to #2 may indicate the options #1 to #2 shown in FIG. 33, respectively. When the mini-slot is configured according to the option #2, and the mini-slot comprises 2 symbols, the uplink radio transmission latency may be the shortest. For example, when a sub-carrier spacing of 15 kHz is used, the mini-slot is configured according to the option #2, and the mini-slot comprises 2 symbols, the uplink radio transmission latency may be equal to or less than 0.8 ms. There is a need for a method for reducing the transmission latency of the HARQ response for the uplink data or the radio retransmission latency.

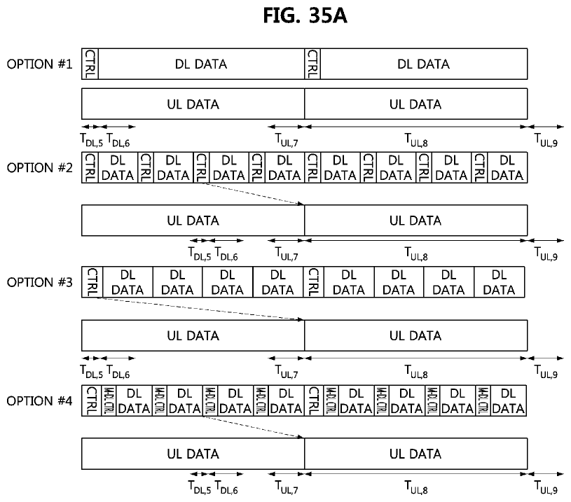

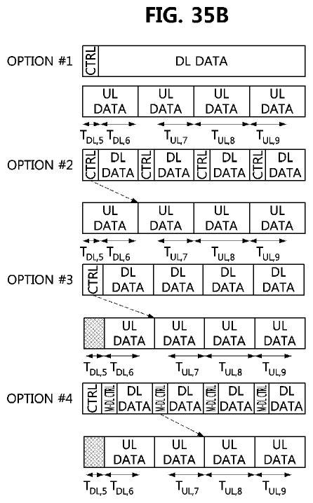

FIG. 35A is a conceptual diagram showing a second embodiment of an uplink radio transmission latency in a communication system, and FIG. 35B is a conceptual diagram showing a third embodiment of an uplink radio transmission latency in a communication system.

In the embodiment shown in FIG. 35A, uplink transmission may be performed on a slot basis, and in the embodiment shown in FIG. 35B, uplink transmission may be performed on a mini-slot basis. For example, a downlink transmission unit and an uplink transmission unit may be defined as shown in Table 7 below.

TABLE 7

| | Case #1 | Case #2 | Case #3 | Case #4 |
|---|---|---|---|---|
| Uplink | Slot | Slot | Mini- | Mini- |
| transmission | | | slot | slot |
| unit | | | | |
| Downlink | Slot | Mini- | Slot | Slot |
| transmission | | slot | | |
| unit | | | | |

Regardless of the downlink transmission unit, when the mini-slot is configured according to the option #2 and the mini-slot comprises 2 symbols, the uplink radio transmission latency may be the shortest.

Meanwhile, the processing latency may vary depending on a resource element (RE) mapping scheme.

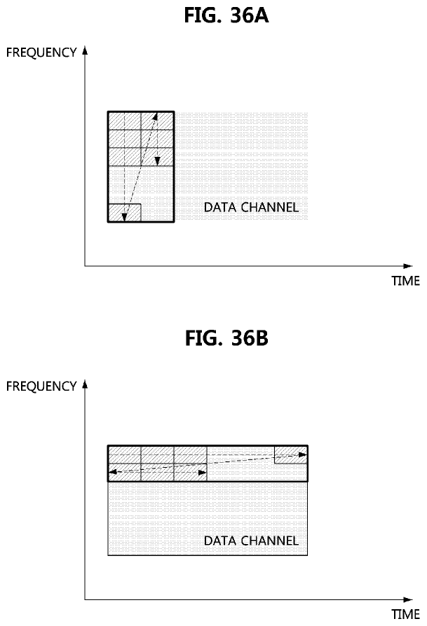

FIG. 36A is a conceptual diagram showing a first embodiment of a frequency-first RE mapping scheme, and FIG. 36B is a conceptual diagram showing a first embodiment of a time-first RE mapping scheme.

Referring to FIG. 36A, data symbols may be mapped first to REs in the frequency axis. Referring to FIG. 36B, data symbols may be mapped first to REs in the time axis. The transmission unit of data may be a slot, a mini-slot, or a coded block (CB). The time resources of the CB may include 2 or more symbols. The processing latency according to the RE mapping scheme may be as follows.

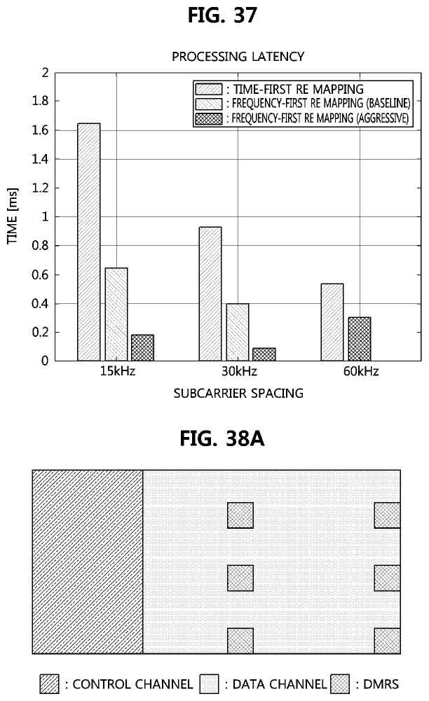

FIG. 37 is a graph showing a first embodiment of a processing latency according to an RE mapping scheme.

Referring to FIG. 37, a processing latency according to the frequency-first RE mapping scheme may be shorter than a processing latency according to the time-first RE mapping scheme. A processing latency according to an aggressive scheme among the frequency-first RE mapping schemes may be shorter than a processing latency according to a baseline among the frequency-first RE mapping schemes.

Meanwhile, a radio transmission latency may vary according to a reference signal (RS) mapping scheme.

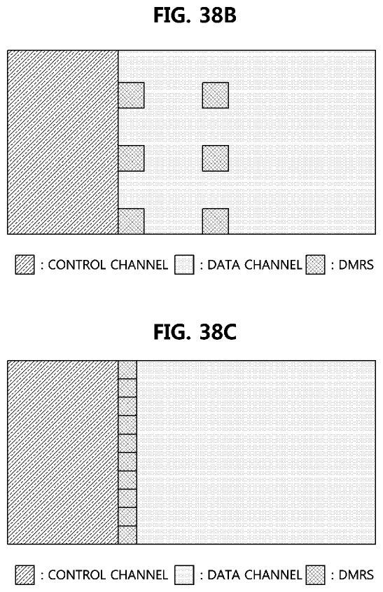

FIG. 38A is a conceptual diagram showing a first embodiment of an RS mapping scheme, FIG. 38B is a conceptual diagram showing a second embodiment of an RS mapping scheme, and FIG. 38C is a conceptual diagram showing a third embodiment of an RS mapping scheme.

Referring to FIG. 38A, front-loaded demodulation RSs (DMRSs) and additional DMRSs may be mapped to a data channel, and a subframe including a control channel, the data channel, and the DMRSs may be transmitted. In this case, a communication node (e.g., base station or terminal) may perform a demodulation operation on the data channel based on the DMRSs after receiving the entire data channel.

Referring to FIG. 38B, front-loaded DMRSs and additional DMRSs may be mapped to a data channel, and a subframe (or, slot) including a control channel, the data channel, and the DMRSs may be transmitted. The transmission time point of the DMRSs shown in FIG. 38B may be earlier than the transmission time point of the DMRSs shown in FIG. 38A. In this case, a communication node (e.g., base station or terminal) may perform a demodulation operation on the data channel based on the DMRSs, and determine whether to receive the remaining data channel based on a result of the demodulation (e.g., a decoding result for the demodulated data channel).

Referring to FIG. 38C, front-loaded demodulation DMRSs may be mapped to a data channel, and a subframe (or, slot) including a control channel, the data channel, and the DMRSs may be transmitted. In this case, a communication node (e.g., base station or terminal) may perform a demodulation operation on the data channel based on the DMRSs, and determine whether to receive the remaining data channel based on a result of the demodulation (e.g., a decoding result for the demodulated data channel). The processing latency according to an RS mapping scheme may be as follows.

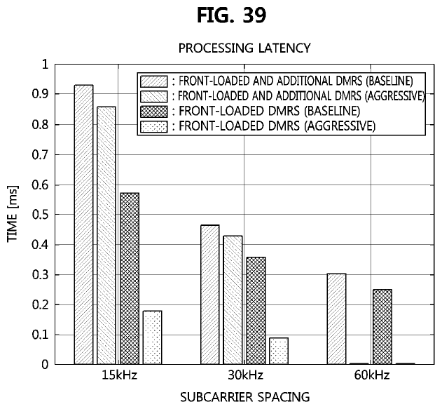

FIG. 39 is a graph showing a first embodiment of a processing latency according to an RS mapping scheme.

Referring to FIG. 39, a processing latency when the front-loaded DMRS is used may be shorter than a processing delay when the front-loaded DMRSs and additional DMRSs are used.

The CB size may be reduced when a short transmission unit (e.g., slot, mini-slot) is used, so that a processing latency for channel coding at the transmitting end may be reduced and a processing latency for channel decoding at the receiving end may be reduced. As in the embodiments of FIGS. 27C, 27D, 28C, and 28D described above, the processing latency may be reduced when the parallel processing operations are performed. When the transport block (TB) size is large, and a short transmission unit or a small size CB is used, the TB may be segmented according to the transmission unit or the CB.

Considering the TB transmission latency together with the radio transmission latency, the TB size may be set to be equal to or less than the CB size, the (re)transmission of the segmented TBs may be performed, and the segmented TBs may be combined at the receiving end. When the data is transmitted based on a high MCS level, the decoding latency may increase. When the data is transmitted based on a low MCS level, the decoding latency may be reduced. However, the number of CBs when a low MCS level is used may be larger than the number of CBs when a high MCS level is used. Accordingly, since the number of edges increases when a low density parity check (LDPC) is applied, the decoding latency may be increased. Even when the parallel processing operations are applied, the reduction of the decoding latency is limited, so it may be necessary to use a high MCS level.

Method for Data (Re)Transmission Latency

When the data transmission unit is larger than TTI, an unnecessary latency may occur from the end time point of the data processing to the start time point of the next TTI. For example, the unnecessary delay may be a time from T_{DL,4} or T_{DL,5} to the feedback time, a time from T_{UL,9} or T_{UL,10} to the feedback time, a time from T_{UL,9} or T_{UL,10} to the resource reallocation time, and a time from T_{UL,12} or T_{UL,13} to the uplink data transmission time. A GP considering the processing latency may be added between TTIs.

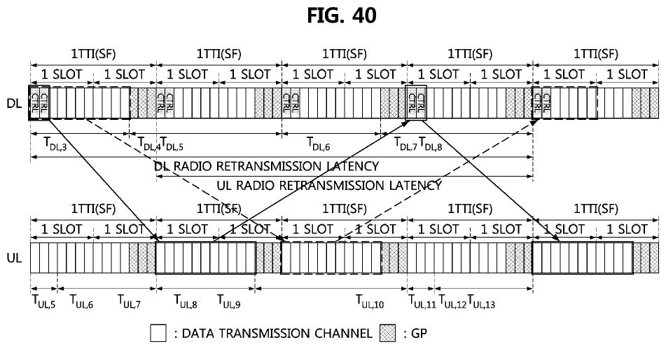

FIG. 40 is a conceptual diagram showing a first embodiment of a radio retransmission latency in an FDD-based communication system.

Referring to FIG. 40, a processing latency may occur in a specific region of a subframe (e.g., the last region of the subframe). Here, one subframe may correspond to one TTI, and a subframe may be referred to as an ‘SF.’ For example, unused resources due to the processing latency may be 21% of total resources. The DL radio retransmission latency may be ‘T_{DL,3}+T_{DL,4}+T_{DL,5}+T_{DL,6}+T_{DL,7}+T_{DL,8},’ and each of T_{DL,3}, T_{DL,4}, T_{DL,5}, T_{DL,6}, T_{DL,7}, and T_{DL,8} may be the value defined in Table 3. (T_{DL,3}+T_{DL,4}+T_{DL,5}) and (T_{DL,6}+T_{DL,7}+T_{DL,8}) may be defined as shown in Equation 7 below.

$${T}_{DL , 3} + {T}_{DL , 4} + {T}_{DL , 5} = ⌈ \frac{{T}_{DL , 3} + {T}_{DL , 4} + {T}_{DL , 5}}{{T}_{TTI}} ⌉ \times {T}_{TTI} = ⌈ \frac{{T}_{DL , 3} + {T}_{DL , Proc}}{{T}_{TTI}} ⌉ \times {T}_{TTI} = ⌈ \frac{2.5 {T}_{DL , 3}}{{T}_{TTI}} ⌉ \times {T}_{TTI} , \\ {T}_{DL , 6} + {T}_{DL , 7} + {T}_{DL , 8} = ⌈ \frac{{T}_{DL , 6} + {T}_{DL , 7} + {T}_{DL , 8}}{{T}_{TTI}} ⌉ \times {T}_{TTI} = ⌈ \frac{{T}_{DL , 6} + {T}_{UL , Proc}}{{T}_{TTI}} ⌉ \times {T}_{TTI} = ⌈ \frac{2.5 {T}_{DL , 6}}{{T}_{TTI}} ⌉ \times {T}_{TTI} \qquad [ Equation 7 ]$$

The DL radio retransmission latency may be defined as Equation 8 below.

$$DL Radio Retransmission latency = {T}_{DL , 3} + {T}_{DL , 4} + {T}_{DL , 5} + {T}_{DL , 6} + {T}_{DL , 7} + {T}_{DL , 8} , \\ ⌈ \frac{{T}_{DL , 3} + {T}_{DL , 4} + {T}_{DL , 5}}{{T}_{TTI}} ⌉ \times {T}_{TTI} + ⌈ \frac{{T}_{DL , 6} + {T}_{DL , 7} + {T}_{DL , 8}}{{T}_{TTI}} ⌉ \times {T}_{TTI} = ⌈ \frac{2.5 {T}_{DL , 3}}{{T}_{TTI}} ⌉ \times {T}_{TTI} + ⌈ \frac{2.5 {T}_{DL , 6}}{{T}_{TTI}} ⌉ \times {T}_{TTI} \qquad [ Equation 8 ]$$

The UL radio retransmission latency may be ‘T_{UL,8}+T_{UL,9}+T_{UL,10}+T_{UL,11}+T_{UL,12}+T_{UL,13}.’ Each of T_{UL,8}, T_{UL,9}, T_{UL,10}, T_{UL,11}, T_{1L,12}, and T_{UL,13} may be the value defined in Table 4. (T_{UL,8}+T_{UL,9}+T_{UL,10}), and (T_{UL,11}+T_{UL,12}+T_{UL,13}) may be defined as shown in Equation 9 below. T_{UL,CTRL} may indicate the length of the downlink control channel.

$${T}_{UL , 8} + {T}_{UL , 9} + {T}_{UL , 10} = ⌈ \frac{{T}_{UL , 8} + {T}_{UL , 9} + {T}_{UL , 10}}{{T}_{TTI}} ⌉ \times {T}_{TTI} = ⌈ \frac{{T}_{UL , 8} + {T}_{Proc}}{{T}_{TTI}} ⌉ \times {T}_{TTI} = ⌈ \frac{2.5 {T}_{UL , 8}}{{T}_{TTI}} ⌉ \times {T}_{TTI} , \\ {T}_{UL , 11} ( = {T}_{DL , CTRL} ) \leq 4 {T}_{DL , symbol} , \\ {T}_{UL , 11} + {T}_{UL , 12} + {T}_{UL , 13} = ⌈ \frac{{T}_{UL , 11} + {T}_{UL , 12} + {T}_{UL , 13}}{{T}_{TTI}} ⌉ \times {T}_{TTI} = ⌈ \frac{1.9 {T}_{UL , 11} + 0.6 {T}_{UL , 8}}{{T}_{TTI}} ⌉ \times {T}_{TTI} \qquad [ Equation 9 ]$$

The UL radio retransmission latency may be defined as Equation 10 below.

$$UL Radio Retransmission latency = {T}_{UL , 8} + {T}_{UL , 9} + {T}_{UL , 10} + {T}_{UL , 11} + {T}_{UL , 12} + {T}_{UL , 13} , \\ ⌈ \frac{{T}_{UL , 8} + {T}_{Proc}}{{T}_{TTI}} ⌉ \times {T}_{TTI} + ⌈ \frac{{T}_{UL , 11} + {T}_{UL , 12} + {T}_{UL , 13}}{{T}_{TTI}} ⌉ \times {T}_{TTI} = ⌈ \frac{2.5 {T}_{UL , 8}}{{T}_{TTI}} ⌉ \times {T}_{TTI} + ⌈ \frac{1.9 {T}_{UL , 11} + 0.6 {T}_{UL , 8}}{{T}_{TTI}} ⌉ \times {T}_{TTI} \qquad [ Equation 10 ]$$

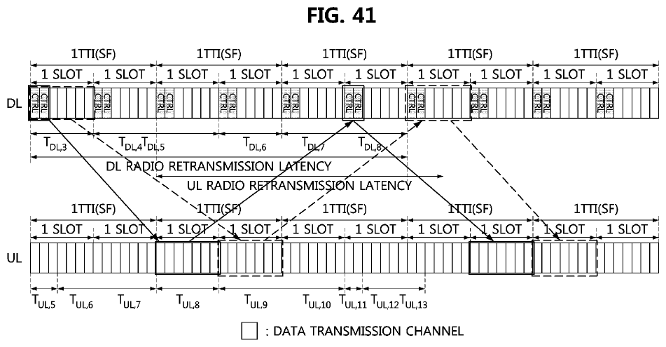

FIG. 41 is a conceptual diagram showing a second embodiment of a radio retransmission latency in an FDD based communication system.

Referring to FIG. 41, ‘processing latency+transmission latency’ may correspond to the length of one subframe (1 TTI). That is, the resources corresponding to the remaining time after the ‘processing latency+transmission latency’ in the subframe may be used for transmission of new data. That is, the data transmission unit may be set to be longer than the processing latency. For example, the transmission unit of data may be one slot in the subframe. Here, the DL radio retransmission latency and the UL radio retransmission latency may be reduced, and the resource utilization rate may be improved. For example, the resource utilization may be 100%.

A subframe (e.g., TTI) may be configured in consideration of a processing latency as in the embodiment shown in FIG. 40 or the embodiment shown in FIG. 41. The transmission latency and resource consumption according to the embodiment may be as shown in Table 8.

TABLE 8

| | | | UL radio | |
|---|---|---|---|---|
| | | DL radio | retransmission | |
| Type | | retransmission latency | latency | remark |
| FDD | Typical transmission | $5 TT I \geq 3 TTI + ⌈ \frac{{T}_{p r o c}}{{T}_{s y m b o l}} ⌉$ | $4 TTI \geq 1 TTI + ⌈ \frac{{T}_{p r o c}}{1 TTI} ⌉ + ⌈ \frac{{T}_{U L , 11} + {T}_{p r o c}}{1 TTI} ⌉$ | No GP |
| FDD | GP in the end of subframe (transmission | $4 TTI \geq ⌈ \frac{{T}_{D L , 3} + {T}_{p r o c}}{1 TTI} ⌉ + ⌈ \frac{{T}_{D L , 6} + {T}_{p r o c}}{1 TTI} ⌉$ | $3 TT I \geq ⌈ \frac{{T}_{U L , 8} + {T}_{p r o c}}{1 TTI} ⌉ + ⌈ \frac{{T}_{U L , 11} + {T}_{p r o c}}{1 TTI} ⌉$ | 21% GP OH |
| | unit = TTI) | | | |
| | GP in the end of subframe | $3 TTI \geq ⌈ \frac{{T}_{D L , 3} + {T}_{p r o c}}{1 TTI} ⌉ + ⌈ \frac{{T}_{D L , 6} + {T}_{p r o c}}{1 TTI} ⌉$ | $3 TT I \geq ⌈ \frac{{T}_{U L , 8} + {T}_{p r o c}}{1 TTI} ⌉ + ⌈ \frac{{T}_{U L , 11} + {T}_{p r o c}}{1 TTI} ⌉$ | 0% GP OH |
| | (transmission | | | |
| | unit = slot (i.e., | | | |
| | 1/2 TTI)( | | | |

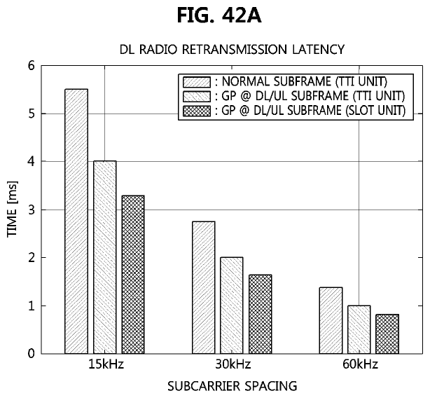

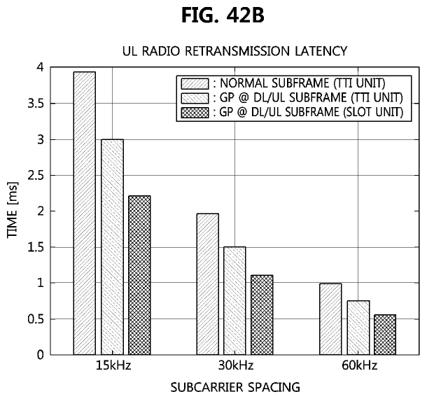

FIG. 42A is a graph showing a first embodiment of a DL radio retransmission latency according to a subframe configuration, and FIG. 42B is a graph showing a first embodiment of a UL radio retransmission latency according to a subframe configuration.

Referring to FIG. 42A, a DL radio retransmission latency when a ‘GP @ DL/UL subframe’ is used may be shorter than a DL radio retransmission latency when a normal subframe is used. Referring to FIG. 42B, a UL radio retransmission latency when a ‘GP @ DL/UL subframe’ is used may be shorter than a UL radio retransmission latency when a normal subframe is used. When a subframe spacing of 15 kHz or a subframe spacing of 30 kHz is used, each of the DL radio retransmission latency and the UL radio retransmission latency may be equal to or greater than 1 ms.

The radio transmission latency in the case of using the subframe configured considering the processing latency may be shorter than the radio transmission latency in the case of using the normal subframe. However, when the subframe configured in consideration of the processing latency is used, the radio transmission latency may be equal to or greater 2 TTIs, and resources of 10.7 to 21% of the total resources may be wasted. In order to solve such the problem, a resource allocation method and a data transmission method on a mini-slot basis will be described in the following embodiments.

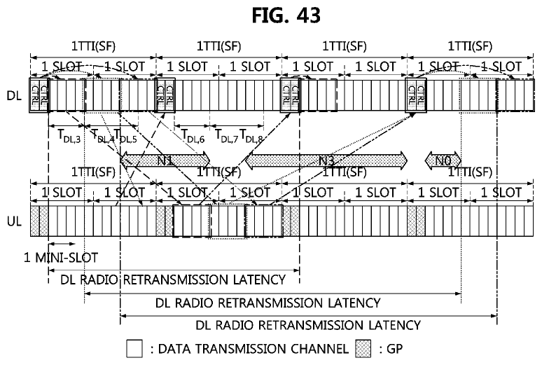

FIG. 43 is a conceptual diagram showing a first embodiment of a downlink retransmission method when a mini-slot comprising 4 symbols is used in an FDD-based communication system.

Referring to FIG. 43, a mini-slot may comprise 4 symbols. For example, the mini-slot may be the mini-slot shown in FIG. 19B, the mini-slot shown in FIG. 19C, or the mini-slot shown in FIG. 19D. A downlink control channel (CTRL) may be composed of an arbitrary number (e.g., 2) of symbols and may be located at the beginning of the TTI. The downlink control channel (e.g., DCI included in the downlink control channel) may include the length of the mini-slot (e.g., the number of symbols included in the mini-slot), the number of mini-slots included in the TTI, MCS, transport block size (TBS), and the like. Also, the downlink control channel (e.g., DCI included in the downlink control channel) may include resource allocation information for uplink data transmission and resource allocation information for transmission of uplink control information (e.g., HARQ response). The structure of the uplink subframe may be the same as the structure of the uplink subframe shown in FIGS. 21A to 21E.

The DL radio retransmission latency may be ‘T_{DL,3} T_{DL,4} T_{DL,5} T_{DL,6} T_{DL,7} T_{DL,8}.’ The HARQ response to the downlink data may be transmitted through a mini-slot belonging to the first uplink subframe after a processing latency. The HARQ response to the downlink data may be transmitted on a mini-slot basis. The T_{DL,3}, (T_{DL,4} T_{DL,5}), T_{DL,6}, and (T_{DL,7}+T_{DL,8}) may be defined as Equation 11 below. T_{DL,mini-slot} may indicate the length of the mini-slot in the downlink, and T_{UL,mini-slot} may indicate the length of the mini-slot in the uplink.

$${T}_{DL , 3} = {T}_{DL , mini \text{-} slot} , \\ {T}_{DL , 4} + {T}_{DL , 5} = ⌈ \frac{{T}_{Proc}}{{T}_{UL , mini \text{-} slot}} ⌉ \times {T}_{UL , mini \text{-} slot} = 2 {T}_{UL , mini \text{-} slot} , \\ {T}_{DL , 6} = {T}_{UL , mini \text{-} slot} , \\ {T}_{DL , 7} + {T}_{DL , 8} = ⌈ \frac{{T}_{Proc}}{{T}_{DL , mini \text{-} slot}} ⌉ \times {T}_{DL , mini \text{-} slot} = 2 {T}_{DL , mini \text{-} slot} \qquad [ Equation 11 ]$$

The DL radio retransmission latency may be defined as Equation 12 below.

$$DL Radio Retransmission latency = {T}_{CTRL} + {T}_{DL , 3} + {T}_{DL , 4} + {T}_{DL , 5} + {T}_{DL , 6} + {T}_{DL , 7} + {T}_{DL , 8} , \\ {T}_{CTRL} + ( ⌈ \frac{{T}_{DL , 3}}{{T}_{DL , mini \text{-} slot}} ⌉ + ⌈ \frac{{T}_{Proc}}{{T}_{DL , mini \text{-} slot}} ⌉ + ⌈ \frac{N 3 + N 0 \text{-} {T}_{Proc}}{{T}_{DL , mini \text{-} slot}} ⌉ ) \times {T}_{DL , mini \text{-} slot} + ( ⌈ \frac{{T}_{DL , 6}}{{T}_{UL , mini \text{-} slot}} ⌉ + ⌈ \frac{{T}_{Proc}}{{T}_{UL , mini \text{-} slot}} ⌉ + ⌈ \frac{N 1 \text{-} {T}_{Proc}}{{T}_{UL , mini \text{-} slot}} ⌉ ) \times {T}_{UL , mini \text{-} slot} = {T}_{CTRL} + ( ⌈ \frac{{T}_{DL , 3}}{{T}_{DL , mini \text{-} slot}} ⌉ + ⌈ \frac{N 3 + N 0}{{T}_{DL , mini \text{-} slot}} ⌉ ) \times {T}_{DL , mini \text{-} slot} + ( ⌈ \frac{{T}_{DL , 6}}{{T}_{UL , mini \text{-} slot}} ⌉ + ⌈ \frac{N 1}{{T}_{UL , mini \text{-} slot}} ⌉ ) \times {T}_{UL , mini \text{-} slot} \leq \{ \begin{matrix}28 {T}_{symbol} & , if ( N 0 , N 1 , N 3 ) = \{ ( 0 , 10 , 10 ) \} \\ 42 {T}_{symbol} & , if ( N 0 , N 1 , N 3 ) = \{ ( 4 , 10 , 18 \} , ( 8 , 10 , 14 ) \}\end{matrix} \qquad [ Equation 12 ]$$

Here, 2 symbols (e.g. 2T_{symbol}/2T_{TTI} (≈7%)) in the uplink subframe corresponding to the downlink control channel may not be used.

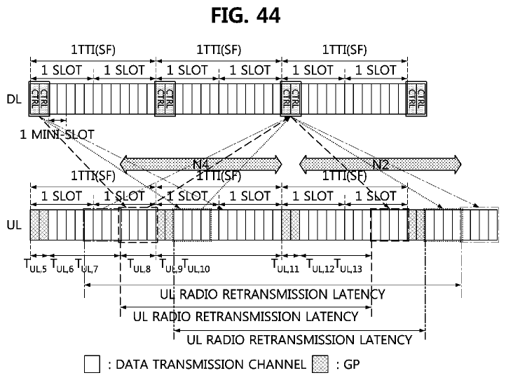

FIG. 44 is a conceptual diagram showing a first embodiment of an uplink retransmission method when a mini-slot comprising 4 symbols is used in an FDD based communication system.

Referring to FIG. 44, a mini-slot may comprise 4 symbols. For example, the mini-slot may be the mini-slot shown in FIG. 19B, the mini-slot shown in FIG. 19C, or the mini-slot shown in FIG. 19D. A downlink control channel (CTRL) may be composed of 2 symbols and may be located at the beginning of the TTI. The downlink control channel (e.g., DCI included in the downlink control channel) may include the length of the mini-slot (e.g., the number of symbols included in the mini-slot), the number of mini-slots included in the TTI, MCS, TBS, and the like. Also, the downlink control channel (e.g., DCI included in the downlink control channel) may include resource allocation information for uplink data transmission and resource allocation information for transmission of uplink control information (e.g., feedback information). The structure of the uplink subframe may be the same as the structure of the uplink subframe shown in FIGS. 21A to 21E.

The UL radio retransmission latency may be ‘T_{UL,8}+T_{UL,9}+T_{UL,10}+T_{UL,11}+T_{UL,12}+T_{UL,13}.’ The uplink data may be transmitted on a mini-slot basis after the processing latency of the downlink control channel. The HARQ response to the uplink data may be transmitted through a mini-slot belonging to the first downlink subframe after the processing latency. The HARQ response to the uplink data may be transmitted on a mini-slot basis. The T_{UL,8}, (T_{UL,9}+T_{UL,10}), T_{UL,11}, and (T_{UL,12}+T_{UL,13}) may be defined as Equation 13 below.

$${T}_{UL , 8} = {T}_{UL , mini \text{-} slot} , \\ {T}_{UL , 9} + {T}_{UL , 10} = ⌈ \frac{{T}_{Proc}}{{T}_{DL , mini \text{-} slot}} ⌉ \times {T}_{DL , mini \text{-} slot} = 2 {T}_{DL , mini \text{-} slot} , \\ {T}_{DL , 11} ( = {T}_{DL , CTRL} ) \leq 4 {T}_{DL , symbol} , \\ {T}_{UL , 12} + {T}_{UL , 13} = ⌈ \frac{{T}_{UL , 12} + {T}_{UL , 13}}{{T}_{UL , symbol}} ⌉ \times {T}_{UL , symbol} = ⌈ \frac{0.6 {T}_{UL , 11} + 0.9 {T}_{UL , 8}}{{T}_{UL , symbol}} ⌉ \times {T}_{UL , symbol} \qquad [ Equation 13 ]$$

The UL radio retransmission latency may be defined as Equation 14 below.

$$UL Radio Retransmission latency = {T}_{UL , 8} + {T}_{UL , 9} + {T}_{UL , 10} + {T}_{UL , 11} + {T}_{UL , 12} + {T}_{UL , 13} , \\ ( ⌈ \frac{{T}_{UL , 8} + {T}_{Proc}}{{T}_{UL , mini \text{-} slot}} ⌉ + ⌈ \frac{N 2 \text{-} {T}_{Proc}}{{T}_{UL , mini \text{-} slot}} ⌉ ) \times {T}_{UL , mini \text{-} slot} + ( ⌈ \frac{{T}_{UL , 11}}{{T}_{symbol}} ⌉ + ⌈ \frac{{T}_{UL , 12} + {T}_{UL , 13}}{{T}_{symbol}} ⌉ ) \times {T}_{symbol} + ⌈ \frac{N 4 \text{-} {T}_{Proc}}{{T}_{DL , mini \text{-} slot}} ⌉ \times {T}_{DL , mini \text{-} slot} = ⌈ \frac{{T}_{UL , 8}}{{T}_{mini \text{-} slot}} ⌉ \times {T}_{mini \text{-} slot} + ( ⌈ \frac{{T}_{CTRL}}{{T}_{symbol}} ⌉ + 2 ⌈ \frac{{T}_{Proc}}{{T}_{symbol}} ⌉ ) \times {T}_{symbol} + [ N 2 \text{-} {T}_{Proc} ] + [ N 4 \text{-} {T}_{Proc} ] \leq \{ \begin{matrix}28 {T}_{symbol} , if ( N 2 , N 4 ) = \{ ( 8 , 14 ) , ( 14 , 8 ) \} OSs \\ 42 {T}_{symbol} , if ( N 2 , N 4 ) = \{ ( 18 , 18 ) \} OSs\end{matrix} \qquad [ Equation 14 ]$$

Here, 2 symbols (e.g. 2T_{symbol}/2T_{TTI} (≈7%)) in the uplink subframe corresponding to the downlink control channel may not be used.

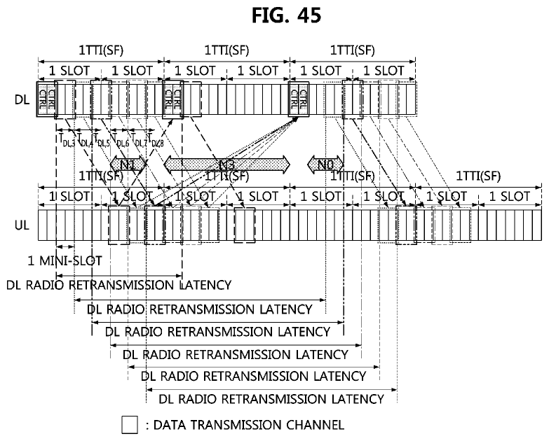

FIG. 45 is a conceptual diagram showing a first embodiment of a downlink retransmission method when a mini-slot comprising 2 symbols is used in an FDD based communication system.

Referring to FIG. 45, a mini-slot may comprise 2 symbols. For example, the mini-slot may be the mini-slot shown in FIG. 19B, the mini-slot shown in FIG. 19C, or the mini-slot shown in FIG. 19D. A downlink control channel (CTRL) may be composed of 2 symbols and may be located at the beginning of the TTI. The downlink control channel (e.g., DCI included in the downlink control channel) may include the length of the mini-slot (e.g., the number of symbols included in the mini-slot), the number of mini-slots included in the TTI, MCS, TBS, and the like. Also, the downlink control channel (e.g., DCI included in the downlink control channel) may include resource allocation information for uplink data transmission and resource allocation information for transmission of uplink control information (e.g., HARQ response). The structure of the uplink subframe may be the same as the structure of the uplink subframe shown in FIGS. 21A to 21E.

The DL radio retransmission latency may be ‘T_{DL,3}+T_{DL,4}+T_{DL,5}+T_{DL,6}+T_{DL,7}+T_{DL,8}.’ The HARQ response to the downlink data may be transmitted through a mini-slot belonging to the first uplink subframe after a processing latency. The HARQ response to the downlink data may be transmitted on a mini-slot basis. The T_{DL,3}, (T_{DL,4}+T_{DL,5}), T_{DL,6}, and (T_{DL,7}+T_{DL,8}) may be defined as Equation 15 below.

$${T}_{DL , 3} = {T}_{DL , mini \text{-} slot} , \\ {T}_{DL , 4} + {T}_{DL , 5} = ⌈ \frac{{T}_{Proc}}{{T}_{UL , mini \text{-} slot}} ⌉ \times {T}_{UL , mini \text{-} slot} = 2 {T}_{UL , mini \text{-} slot} , \\ {T}_{DL , 6} = {T}_{UL , mini \text{-} slot} , \\ {T}_{DL , 7} + {T}_{DL , 8} = ⌈ \frac{{T}_{Proc}}{{T}_{DL , mini \text{-} slot}} ⌉ \times {T}_{DL , mini \text{-} slot} = 2 {T}_{DL , mini \text{-} slot} \qquad [ Equation 15 ]$$

The DL radio retransmission latency may be defined as Equation 16 below.

$$DL Radio Retransmission latency = {T}_{CTRL} + {T}_{DL , 3} + {T}_{DL , 4} + {T}_{DL , 5} + {T}_{DL , 6} + {T}_{DL , 7} + {T}_{DL , 8} , \\ {T}_{CTRL} + ( ⌈ \frac{{T}_{DL , 3}}{{T}_{DL , mini \text{-} slot}} ⌉ + ⌈ \frac{{T}_{Proc}}{{T}_{DL , mini \text{-} slot}} ⌉ + ⌈ \frac{N 3 + N 0 \text{-} {T}_{Proc}}{{T}_{DL , mini \text{-} slot}} ⌉ ) \times {T}_{DL , mini \text{-} slot} + ( ⌈ \frac{{T}_{DL , 6}}{{T}_{UL , mini \text{-} slot}} ⌉ + ⌈ \frac{{T}_{Proc}}{{T}_{UL , mini \text{-} slot}} ⌉ + ⌈ \frac{N 1 \text{-} {T}_{Proc}}{{T}_{UL , mini \text{-} slot}} ⌉ ) \times {T}_{UL , mini \text{-} slot} = {T}_{CTRL} + ( ⌈ \frac{{T}_{DL , 3}}{{T}_{DL , mini \text{-} slot}} ⌉ + ⌈ \frac{N 3 + N 0}{{T}_{DL , mini \text{-} slot}} ⌉ ) \times {T}_{DL , mini \text{-} slot} + ( ⌈ \frac{{T}_{DL , 6}}{{T}_{UL , mini \text{-} slot}} ⌉ + ⌈ \frac{N 1}{{T}_{UL , mini \text{-} slot}} ⌉ ) \times {T}_{UL , mini \text{-} slot} \leq \{ \begin{matrix}14 {T}_{symbol} & , if ( N 0 , N 1 , N 3 ) = \{ ( 0 , 4 , 4 ) \} \\ 28 {T}_{symbol} & , if ( N 0 , N 1 , N 3 ) = \{ ( 4 , 2 , 16 ) , ( 4 , 4 , 14 ) , ( 4 , 6 , 12 ) , ( 4 , 8 , 10 ) , ( 4 , 10 , 8 ) \}\end{matrix} \qquad [ Equation 16 ]$$

All resources may not be used when a 3-symbol mini-slot is used, but all resources may be used in a DL retransmission procedure when a mini-slot comprising 2 symbols is used.

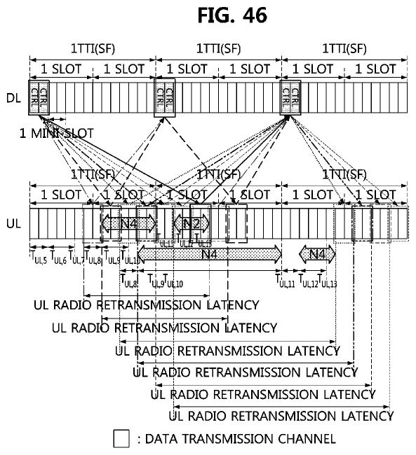

FIG. 46 is a conceptual diagram showing a first embodiment of an uplink retransmission method when a mini-slot comprising 2 symbols is used in an FDD-based communication system.

Referring to FIG. 46, a mini-slot may comprise 2 symbols. For example, the mini-slot may be the mini-slot shown in FIG. 19B, the mini-slot shown in FIG. 19C, or the mini-slot shown in FIG. 19D. A downlink control channel (CTRL) may be composed of 2 symbols and may be located at the beginning of the TTI. The downlink control channel (e.g., DCI included in the downlink control channel) may include the length of the mini-slot (e.g., the number of symbols included in the mini-slot), the number of mini-slots included in the TTI, MCS, TBS, and the like. Also, the downlink control channel (e.g., DCI included in the downlink control channel) may include resource allocation information for uplink data transmission and resource allocation information for transmission of uplink control information (e.g., feedback information). The structure of the uplink subframe may be the same as the structure of the uplink subframe shown in FIGS. 21A to 21E.

The UL radio retransmission latency may be ‘T_{UL,8}+T_{UL,9}+T_{UL,10}+T_{UL,11}+T_{UL,12}+T_{UL,13}.’ The uplink data may be transmitted on a mini-slot basis after the processing latency of the downlink control channel. The HARQ response to the uplink data may be transmitted through a mini-slot belonging to the first downlink subframe after the processing latency. The HARQ response to the uplink data may be transmitted on a mini-slot basis. The T_{UL,8}, (T_{UL,9}+T_{UL,10}), T_{UL,11}, and (T_{UL,12}+T_{UL,13}) may be defined as Equation 17 below.

$${T}_{UL , 8} = {T}_{UL , mini \text{-} slot} , \\ {T}_{UL , 9} + {T}_{UL , 10} = ⌈ \frac{{T}_{Proc}}{{T}_{DL , mini \text{-} slot}} ⌉ \times {T}_{DL , mini \text{-} slot} = 2 {T}_{DL , mini \text{-} slot} , \\ {T}_{DL , 11} ( = {T}_{DL , CTRL} ) \leq 4 {T}_{DL , symbol} , \\ {T}_{UL , 12} + {T}_{UL , 13} = ⌈ \frac{{T}_{UL , 12} + {T}_{UL , 13}}{{T}_{UL , symbol}} ⌉ \times {T}_{UL , symbol} = ⌈ \frac{0.6 {T}_{UL , 11} + 0.9 {T}_{UL , 8}}{{T}_{UL , symbol}} ⌉ \times {T}_{UL , symbol} \qquad [ Equation 17 ]$$

The UL radio retransmission latency may be defined as Equation 18 below.

$$UL Radio Retransmission latency = {T}_{UL , 8} + {T}_{UL , 9} + {T}_{UL , 10} + {T}_{UL , 11} + {T}_{UL , 12} + {T}_{UL , 13} , \\ ( ⌈ \frac{{T}_{UL , 8} + {T}_{Proc}}{{T}_{UL , mini \text{-} slot}} ⌉ + ⌈ \frac{N 2 \text{-} {T}_{Proc}}{{T}_{UL , mini \text{-} slot}} ⌉ ) \times {T}_{UL , mini \text{-} slot} + ( ⌈ \frac{{T}_{UL , 11}}{{T}_{symbol}} ⌉ + ⌈ \frac{{T}_{UL , 12} + {T}_{UL , 13}}{{T}_{symbol}} ⌉ ) \times {T}_{symbol} + ⌈ \frac{N 4 \text{-} {T}_{Proc}}{{T}_{DL , mini \text{-} slot}} ⌉ \times {T}_{DL , mini \text{-} slot} = ⌈ \frac{{T}_{UL , 8}}{{T}_{mini \text{-} slot}} ⌉ \times {T}_{mini \text{-} slot} + ( ⌈ \frac{{T}_{CTRL}}{{T}_{symbol}} ⌉ + 2 ⌈ \frac{{T}_{Proc}}{{T}_{symbol}} ⌉ ) \times {T}_{symbol} + [ N 2 \text{-} {T}_{Proc} ] + [ N 4 \text{-} {T}_{Proc} ] \leq \{ \begin{matrix}14 {T}_{symbol} , if ( N 2 , N 4 ) = \{ ( 4 , 6 ) , ( 6 , 4 ) \} OSs \\ 28 {T}_{symbol} , if ( N 2 , N 4 ) = \{ ( 4 , 16 ) , ( 6 , 14 ) , ( 8 , 12 ) , ( 10 , 10 ) , ( 12 , 8 ) , ( 14 , 6 ) , ( 16 , 4 ) \} OSs\end{matrix} \qquad [ Equation 18 ]$$

All resources may be used in the uplink retransmission procedure when a mini-slot comprising 2 symbols is used.

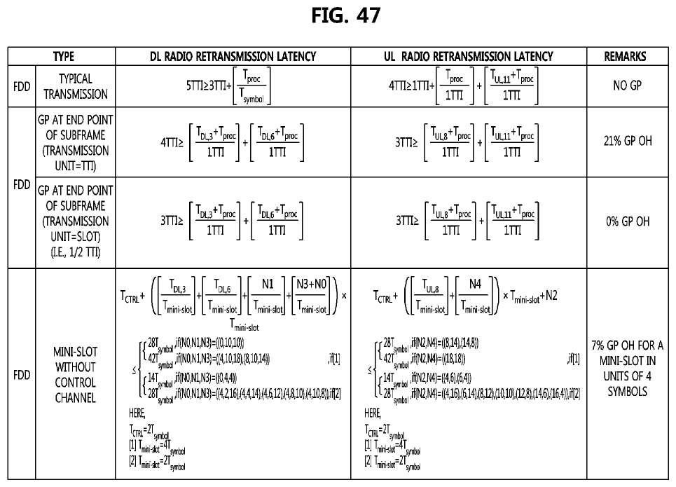

Meanwhile, when a subframe (e.g., TTI) is configured in consideration of the processing latency, a method of configuring the subframe by considering resources required for the processing operation or a method for configuring the subframe on a mini-slot basis may be used. In this case, the DL radio retransmission latency and the UL radio retransmission latency may be defined as shown in FIG. 47. FIG. 47 is a table showing a DL radio retransmission latency and a UL radio retransmission latency according to a subframe configuration.

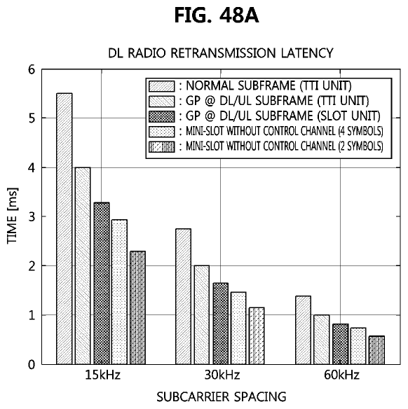

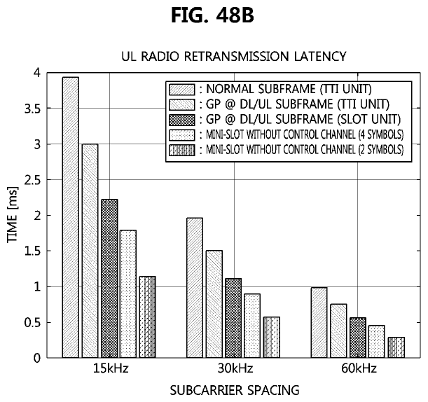

FIG. 48A is a graph showing a second embodiment of a DL radio retransmission latency according to a subframe configuration, and FIG. 48B is a graph showing a second embodiment of a UL radio retransmission latency according to a subframe configuration.

Referring to FIGS. 48A and 48B, when a subframe is configured in units of mini-slots, the DL radio retransmission latency and the UL radio retransmission latency may be reduced. The latencies N0, N1, N2, N3, and N4 between data transmission periods may be longer than the processing latency. In order to reduce the radio (re)transmission latency, a method for reducing the latencies N0, N1, N2, N3, and N4 between data transmission periods as well as the processing latency may be considered.

Meanwhile, in the following embodiments, latency reduction methods will be proposed when the subframe is composed of mini-slots including a control channel (e.g., M-DL CTRL, M-UL CTRL).

The downlink control channel (e.g., DCI included in the downlink control channel) may include information on a mini-slot used for transmission of downlink data. When the downlink data is retransmitted, the information on the mini-slot may be omitted in the downlink control channel. However, for a case where an HARQ response to the previous data transmission is not received, the downlink control channel may include information on a mini-slot used for retransmission of the downlink data. The MCS, TB/CB size, HARQ process ID, new data indication (NDI) and redundancy version (RV) for the downlink data may be included in the M-DL CTRL in the mini-slot. In this case, the retransmission latency of the downlink data may be reduced. Also, the resource allocation information of the uplink control channel (e.g., resource allocation information for the HARQ response to the downlink data) may be included in at least one of the downlink control channel and the M-DL CTRL.

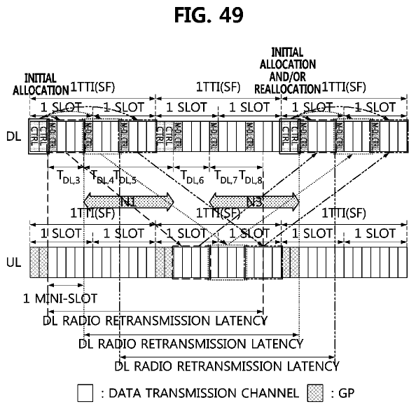

FIG. 49 is a conceptual diagram showing a second embodiment of a downlink retransmission method when a mini-slot comprising 4 symbols is used in an FDD based communication system.

Referring to FIG. 49, a mini-slot may comprise 4 symbols. For example, the mini-slot may be the mini-slot shown in FIG. 19B, the mini-slot shown in FIG. 19C, or the mini-slot shown in FIG. 19D. A downlink control channel (CTRL) may be composed of 2 symbols and may be located at the beginning of the TTI. The information (e.g., DCI) included in the downlink control channel may include the length of the mini-slot (e.g., the number of symbols included in the mini-slot), the number of mini-slots included in the TTI, MCS, TBS, and the like. Also, the information (e.g., DCI) included in the downlink control channel may further include resource allocation information for uplink data transmission and resource allocation information for transmission of uplink control information (e.g., feedback information). The structure of the uplink subframe may be the same as the structure of the uplink subframe shown in FIGS. 21A to 21E.

The terminal may know whether to retransmit the downlink data based on the information included in the M-DL CTRL in the mini-slot, instead of the information included in the downlink control channel. For example, the terminal may receive the M-DL CTRL in the first mini-slot after ‘T_{DL,6}+T_{DL,7}+T_{DL,8},’ and based on the information included in the M-DL CTRL, the terminal may receive the retransmitted data. In this case, N3 may be reduced to 10 symbols, and NO may not occur.

Accordingly, the DL radio retransmission latency may be ‘T_{DL,3}+T_{DL,4}+T_{DL,5}+T_{DL,6}+T_{DL,7}+T_{DL,8}.’ The T_{DL,3}, (T_{DL,4}+T_{DL,5}), T_{DL,6}, and (T_{DL,7}+T_{DL,8}) may be defined as Equation 19 below. The HARQ response to the downlink data may be transmitted through a mini-slot belonging to the first uplink subframe after a processing latency. The HARQ response to the downlink data may be transmitted on a mini-slot basis.

$${T}_{DL , 3} = {T}_{DL , mini \text{-} slot} , \\ {T}_{DL , 4} + {T}_{DL , 5} = ⌈ \frac{{T}_{Proc}}{{T}_{UL , mini \text{-} slot}} ⌉ \times {T}_{UL , mini \text{-} slot} = 2 {T}_{UL , mini \text{-} slot} , \\ {T}_{DL , 6} = {T}_{UL , mini \text{-} slot} , \\ {T}_{DL , 7} + {T}_{DL , 8} = ⌈ \frac{{T}_{Proc}}{{T}_{DL , mini \text{-} slot}} ⌉ \times {T}_{DL , mini \text{-} slot} = 2 {T}_{DL , mini \text{-} slot}$$

The DL radio retransmission latency may be defined as Equation 20 below.

$$DL Radio Retransmission latency = {T}_{CTRL} + {T}_{DL , 3} + {T}_{DL , 4} + {T}_{DL , 5} + {T}_{DL , 6} + {T}_{DL , 7} + {T}_{DL , 8} , \\ ⌈ \frac{{T}_{DL , 3}}{{T}_{UL , mini \text{-} slot}} ⌉ \times {T}_{DL , mini \text{-} slot} + ⌈ \frac{{T}_{DL , 6}}{{T}_{UL , mini \text{-} slot}} ⌉ \times {T}_{UL , mini \text{-} slot} + ⌈ \frac{{T}_{Proc}}{{T}_{DL , symbol}} ⌉ \times {T}_{DL , symbol} + ⌈ \frac{N 1}{{T}_{UL , symbol}} ⌉ \times {T}_{UL , symbol} = ( ⌈ \frac{{T}_{DL , 3}}{{T}_{mini \text{-} slot}} ⌉ + ⌈ \frac{{T}_{DL , 6}}{{T}_{mini \text{-} slot}} ⌉ ) \times {T}_{mini \text{-} slot} + ( ⌈ \frac{{T}_{Proc}}{{T}_{symbol}} ⌉ + ⌈ \frac{N 1}{{T}_{symbol}} ⌉ ) \times {T}_{symbol} \leq 3.5 {T}_{mini \text{-} slot} + N 1 {T}_{symbol} \leq 28 {T}_{symbol} , where ( N 0 , N 1 , N 3 ) = \{ ( 0 , 8 + {T}_{CTRL} , 8 + {T}_{CTRL} ) \} \qquad [ Equation 20 ]$$

Here, 2 symbols (e.g. 2T_{symbol}/2T_{TTI} (≈7%)) in the uplink subframe corresponding to the downlink control channel may not be used.

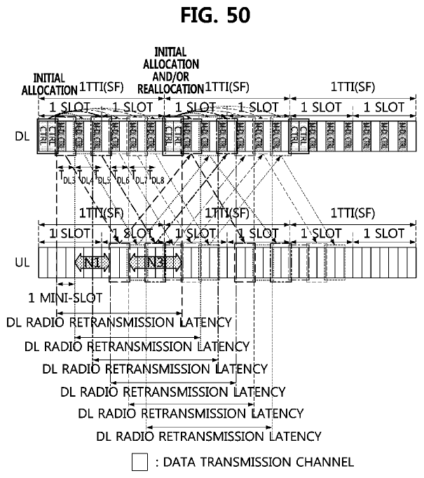

FIG. 50 is a conceptual diagram showing a second embodiment of a downlink retransmission method when a mini-slot comprising 2 symbols is used in an FDD based communication system.

Referring to FIG. 50, a mini-slot may comprise 2 symbols. For example, the mini-slot may be the mini-slot shown in FIG. 19B, the mini-slot shown in FIG. 19C, or the mini-slot shown in FIG. 19D. A downlink control channel (CTRL) may be composed of 2 symbols and may be located at the beginning of the TTI. The information (e.g., DCI) included in the downlink control channel may include the length of the mini-slot (e.g., the number of symbols included in the mini-slot), the number of mini-slots included in the TTI, MCS, TBS, and the like. Also, the information (e.g., DCI) included in the downlink control channel may further include resource allocation information for uplink data transmission and resource allocation information for transmission of uplink control information (e.g., feedback information). The structure of the uplink subframe may be the same as the structure of the uplink subframe shown in FIGS. 21A to 21E.

The DL radio retransmission latency may be ‘T_{DL,3}+T_{DL,4}+T_{DL,5}+T_{DL,6}+T_{DL,7}+T_{DL,8}.’ The T_{DL,3}, (T_{DL,4}+T_{DL,5}), T_{DL,6}, and (T_{DL,7}+T_{DL,8}) may be defined as Equation 21 below. The HARQ response to the downlink data may be transmitted through a mini-slot belonging to the first uplink subframe after a processing latency. The HARQ response to the downlink data may be transmitted on a mini-slot basis.

$${T}_{DL , 3} = {T}_{DL , mini \text{-} slot} , \\ {T}_{DL , 4} + {T}_{DL , 5} = ⌈ \frac{{T}_{Proc}}{{T}_{UL , mini \text{-} slot}} ⌉ \times {T}_{UL , mini \text{-} slot} = 2 {T}_{UL , mini \text{-} slot} , \\ {T}_{DL , 6} = {T}_{UL , mini \text{-} slot} , \\ {T}_{DL , 7} + {T}_{DL , 8} = ⌈ \frac{{T}_{Proc}}{{T}_{DL , mini \text{-} slot}} ⌉ \times {T}_{DL , mini \text{-} slot} = 2 {T}_{DL , mini \text{-} slot} \qquad [ Equation 21 ]$$

The DL radio retransmission latency may be defined as Equation 22 below.

$$DL Radio Retransmission latency = {T}_{CTRL} + {T}_{DL , 3} + {T}_{DL , 4} + {T}_{DL , 5} + {T}_{DL , 6} + {T}_{DL , 7} + {T}_{DL , 8} , \\ ⌈ \frac{{T}_{DL , 3}}{{T}_{DL , mini \text{-} slot}} ⌉ \times {T}_{DL , mini \text{-} slot} + ⌈ \frac{{T}_{DL , 6}}{{T}_{UL , mini \text{-} slot}} ⌉ \times {T}_{UL , mini \text{-} slot} + ⌈ \frac{N 3 + N 0}{{T}_{DL , symbol}} ⌉ \times {T}_{DL , symbol} + ⌈ \frac{N 1}{{T}_{UL , symbol}} ⌉ \times {T}_{UL , symbol} = ( ⌈ \frac{{T}_{DL , 3}}{{T}_{mini \text{-} slot}} ⌉ + ⌈ \frac{{T}_{DL , 6}}{{T}_{mini \text{-} slot}} ⌉ ) \times {T}_{mini \text{-} slot} + ( ⌈ \frac{N 3 + N 0}{{T}_{symbol}} ⌉ + ⌈ \frac{N 1}{{T}_{symbol}} ⌉ ) \times {T}_{symbol} \leq 2 {T}_{mini \text{-} slot} + ( N 1 + N 3 ) {T}_{symbol} \leq 14 {T}_{symbol} , where ( N 0 , N 1 , N 3 ) = \{ ( 0 , 4 , 4 + {T}_{CTRL} ) \} \qquad [ Equation 22 ]$$

Here, when N1, N3≥T_{proc}, the latency may be the length of 4 symbols (=2 Tₘᵢₙᵢ₋ₛₗₒₜ). When a time of the downlink control channel (e.g., transmission time or processing time) is included in N3, the latency may be the length of 6 symbols. For example, when one TTI includes 14 symbols, the retransmission latency may be 1 TTI. All resources may not be used when a mini-slot comprising 4 symbols is used, but all resources may be used in a retransmission procedure of the downlink data when a mini-slot comprising 2 symbols is used.

The downlink control channel (e.g., DCI included in the downlink control channel) may include information on a mini-slot used for transmission of downlink data. When the downlink data is retransmitted, the information on the mini-slot may be omitted in the downlink control channel. However, for a case where an HARQ response to the previous data transmission is not received, the downlink control channel may include information on a mini-slot used for retransmission of the downlink data. The MCS, TB/CB size, HARQ process ID, new data indication (NDI) and redundancy version (RV) for the downlink data may be included in the M-DL CTRL in the mini-slot. In this case, the retransmission latency of the downlink data may be reduced. Also, the resource allocation information of the uplink control channel (e.g., resource allocation information for the HARQ response to the downlink data) may be included in at least one of the downlink control channel and the M-DL CTRL. HARQ-related information (e.g., ACK, NACK, NDI, RV, etc.) may be configured when the resource allocation information of the uplink control channel is transmitted.

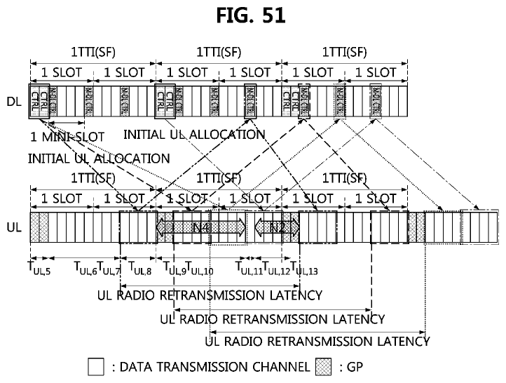

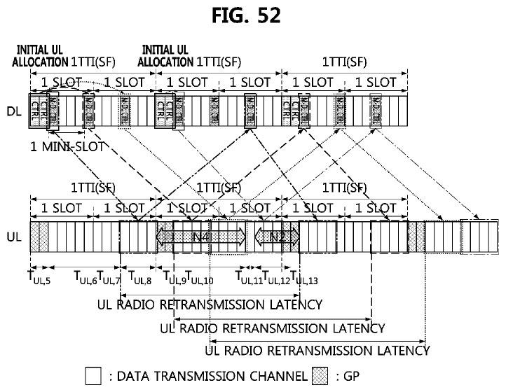

FIG. 51 is a conceptual diagram showing a second embodiment of an uplink retransmission method when a mini-slot comprising 4 symbols is used in an FDD based communication system, and FIG. 52 is a conceptual diagram showing a third embodiment of an uplink retransmission method when a mini-slot comprising 4 symbols is used in an FDD based communication system.

Referring to FIG. 51, a downlink control channel may be composed of 2 symbols, a mini-slot may be composed of 4 symbols, and initial uplink resources may be allocated by the downlink control channel. Referring to FIG. 52, a downlink control channel may be composed of 2 symbols, a mini-slot may be composed of 4 symbols, and initial uplink resources may be allocated by the M-DL CTRL.

The UL radio retransmission latency may be ‘T_{UL,8}+T_{UL,9}+T_{UL,10}+T_{UL,11}+T_{UL,12}+T_{UL,13}.’ The uplink data may be transmitted on a mini-slot basis after the processing latency of the downlink control channel. The HARQ response to the uplink data may be transmitted through a mini-slot belonging to the first downlink subframe after the processing latency. The HARQ response to the uplink data may be transmitted on a mini-slot basis. The T_{UL,8}, (T_{UL,9}+T_{UL,10}), T_{UL,11}, and (T_{UL,12}+T_{UL,13}) may be defined as Equation 23 below.

$${T}_{UL , 8} = {T}_{UL , mini \text{-} slot} , \\ {T}_{DL , 9} + {T}_{DL , 10} = ⌈ \frac{{T}_{Proc}}{{T}_{DL , mini \text{-} slot}} ⌉ \times {T}_{DL , mini \text{-} slot} = 2 {T}_{DL , mini \text{-} slot} , \\ {T}_{UL , 11} ( = {T}_{DL , CTRL} ) \leq 4 {T}_{DL , symbol} , \\ {T}_{UL , 12} + {T}_{UL , 13} = ⌈ \frac{{T}_{UL , 12} + {T}_{UL , 13}}{{T}_{UL , symbol}} ⌉ \times {T}_{UL , symbol} = ⌈ \frac{0.6 {T}_{UL , 11} + 0.9 {T}_{UL , 8}}{{T}_{UL , symbol}} ⌉ \times {T}_{UL , symbol} \qquad [ Equation 23 ]$$

The UL radio retransmission latency may be defined as Equation 24 below.

$$UL Radio Retransmission latency = {T}_{UL , 8} + {T}_{UL , 9} + {T}_{UL , 10} + {T}_{UL , 11} + {T}_{UL , 12} + {T}_{UL , 13} , \\ ( ⌈ \frac{{T}_{UL , 8} + {T}_{Proc}}{{T}_{UL , mini \text{-} slot}} ⌉ + ⌈ \frac{N 2 \text{-} {T}_{Proc}}{{T}_{UL , mini \text{-} slot}} ⌉ ) \times {T}_{UL , mini \text{-} slot} + ( ⌈ \frac{{T}_{UL , 11}}{{T}_{symbol}} ⌉ + ⌈ \frac{{T}_{UL , 12} + {T}_{UL , 13}}{{T}_{symbol}} ⌉ ) \times {T}_{symbol} + ⌈ \frac{N 4 \text{-} {T}_{Proc}}{{T}_{DL , mini \text{-} slot}} ⌉ \times {T}_{DL , mini \text{-} slot} = ⌈ \frac{{T}_{UL , 8}}{{T}_{mini \text{-} slot}} ⌉ \times {T}_{mini \text{-} slot} + ( ⌈ \frac{{T}_{CTRL}}{{T}_{symbol}} ⌉ + 2 ⌈ \frac{{T}_{Proc}}{{T}_{symbol}} ⌉ ) \times {T}_{symbol} + [ N 2 \text{-} {T}_{Proc} ] + [ N 4 \text{-} {T}_{Proc} ] \leq 28 {T}_{symbol} \qquad [ Equation 24 ]$$

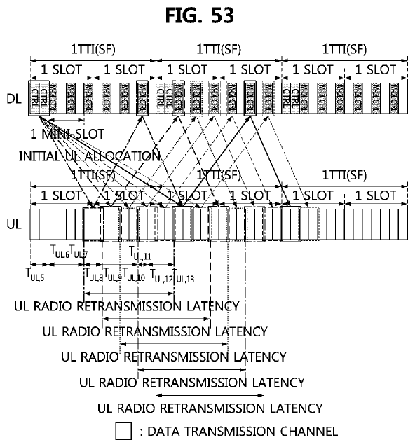

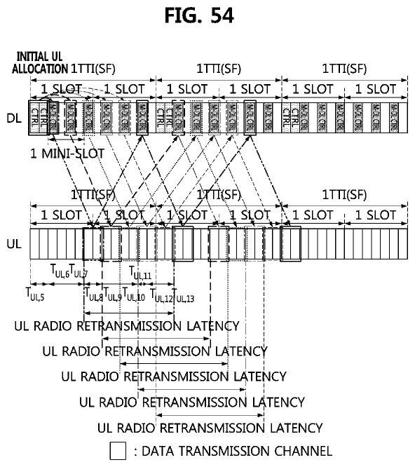

FIG. 53 is a conceptual diagram showing a second embodiment of an uplink retransmission method when a mini-slot comprising 2 symbols is used in an FDD based communication system, and FIG. 54 is a conceptual diagram showing a third embodiment of an uplink retransmission method when a mini-slot comprising 2 symbols is used in an FDD based communication system.

Referring to FIG. 53, a downlink control channel may be composed of 2 symbols, a mini-slot may be composed of 2 symbols, and initial uplink resources may be allocated by the downlink control channel. Referring to FIG. 54, a downlink control channel may be composed of 2 symbols, a mini-slot may be composed of 2 symbols, and initial uplink resources may be allocated by the M-DL CTRL. Considering only the processing latency for retransmission (e.g., N2=3) in the case where the mini-slot is composed of 2 symbols, the radio retransmission latency may be shorter than 14 T_{symbol}. N2 and N4 may be defined as Equation 25 below.

(N2,N4)={(4,4),(4+T_{CTRL},4),(4,4+T_{CTRL})} [Equation 25]

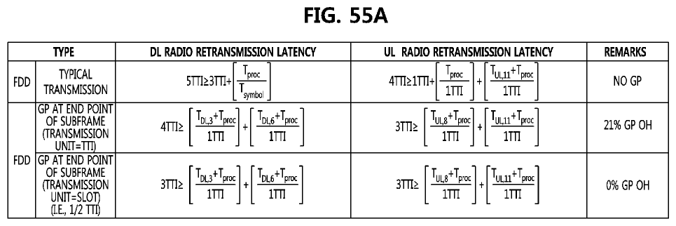

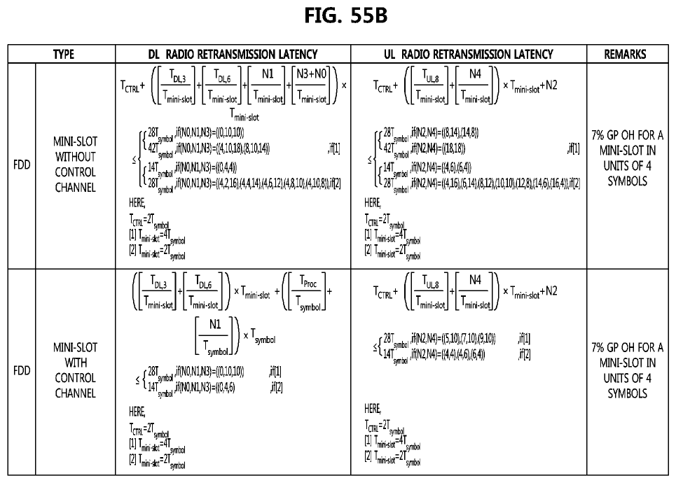

Meanwhile, when a subframe (e.g., TTI) is configured in consideration of the processing latency, a method of configuring the subframe by considering resources required for the processing operation or a method for configuring the subframe on a mini-slot basis may be used. In this case, the DL radio retransmission latency and the UL radio retransmission latency may be defined as shown in FIGS. 55A and 55B. FIGS. 55A and 55B are tables showing a DL radio retransmission latency and a UL radio retransmission latency according to a subframe configuration.

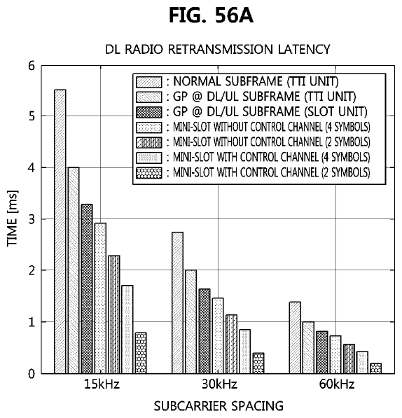

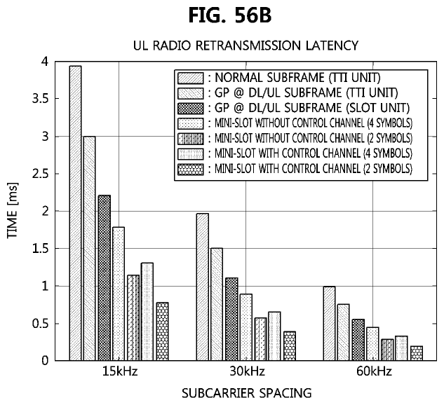

FIG. 56A is a graph showing a third embodiment of a DL radio retransmission latency according to a subframe configuration, and FIG. 56B is a graph showing a third embodiment of a UL radio retransmission latency according to a subframe configuration.

Referring to FIGS. 56A and 56B, when a subframe is configured in units of mini-slots, the DL radio retransmission latency and the UL radio retransmission latency may be reduced.

Meanwhile, in the latency reduction method through a subframe (e.g., TTI) configured in consideration of the processing latency, a feedback period may basically be assumed as a transmission unit of uplink data. When the subframe configured in consideration of the processing latency is used, unnecessary resources (about 10 to 20%) may be wasted. In the following embodiments, a downlink radio retransmission latency reduction method will be described when the feedback period is set to a transmission unit (e.g., one or more symbols) smaller than a transmission unit of uplink data. Here, the feedback period set to be a transmission unit smaller than the transmission unit of the uplink data may be referred to as a ‘short feedback period.’ The short feedback period may be equal to or longer than a time corresponding to 1 symbol, and may be equal to or less than the transmission unit of data.

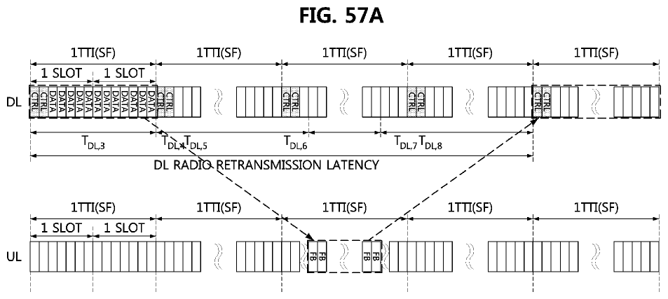

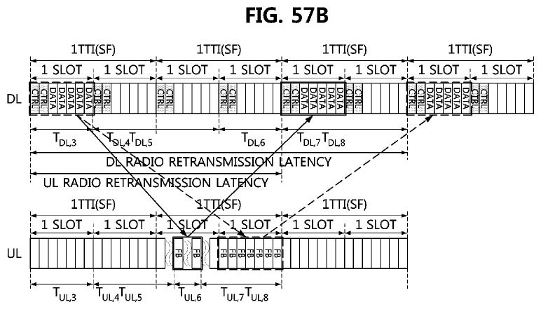

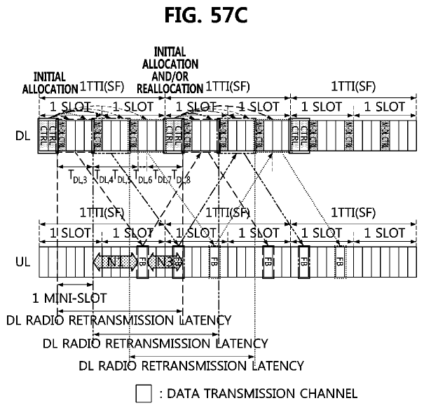

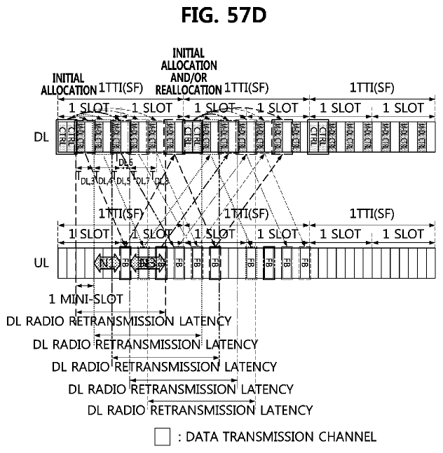

FIG. 57A is a conceptual diagram showing a first embodiment of a downlink retransmission method when a short feedback period is used in an FDD based communication system, FIG. 57B is a conceptual diagram showing a second embodiment of a downlink retransmission method when a short feedback period is used in an FDD based communication system, FIG. 57C is a conceptual diagram showing a third embodiment of a downlink retransmission method when a short feedback period is used in an FDD based communication system, and FIG. 57D is a conceptual diagram showing a fourth embodiment of a downlink retransmission method when a short feedback period is used in an FDD based communication system.

In FIG. 57A, the short feedback period may be configured on a TTI basis (e.g., 14 symbols). In FIG. 57B, the short feedback period may be configured on a slot basis (e.g., 7 symbols). In FIG. 57C, the short feedback period may be configured on a basis of a mini-slot comprising 4 symbols. In FIG. 57D, the short feedback period may be configured on a basis of a mini-slot comprising 2 symbols.

The DL radio retransmission latency may be ‘T_{DL,3}+T_{DL,4}+T_{DL,5}+T_{DL,6}+T_{DL,7}+T_{DL,8}.’ The T_{DL,3}, (T_{DL,4}+T_{DL,5}), T_{DL,6}, and (T_{DL,7}+T_{DL,8}) may be defined as Equation 26 below. The HARQ response to the downlink data may be transmitted through the first uplink symbol after the processing latency.

$${T}_{DL , 3} = {T}_{DL , TTI} , \\ {T}_{DL , 4} + {T}_{DL , 5} = ⌈ \frac{{T}_{Proc}}{{T}_{UL , symbol}} ⌉ \times {T}_{UL , symbol} = ⌈ \frac{0.9 {T}_{DL , 3} + 0.6 {T}_{DL , 6}}{{T}_{UL , symbol}} ⌉ \times {T}_{UL , symbol} , \\ {T}_{DL , 6} = ⌈ \frac{{T}_{DL , 6}}{{T}_{UL , symbol}} ⌉ \times {T}_{UL , symbol} , \\ {T}_{DL , 7} + {T}_{DL , 8} = ⌈ \frac{{T}_{Proc}}{{T}_{DL , symbol}} ⌉ \times {T}_{DL , symbol} = ⌈ \frac{0.9 {T}_{DL , 6} + 0.6 {T}_{DL , 3}}{{T}_{DL , symbol}} ⌉ \times {T}_{DL , symbol} \qquad [ Equation 26 ]$$

The DL radio retransmission latency may be defined as Equation 27 below.

$$DL Radio Retransmission latency = {T}_{CTRL} + {T}_{DL , 3} + {T}_{DL , 4} + {T}_{DL , 5} + {T}_{DL , 6} + {T}_{DL , 7} + {T}_{DL , 8} , \\ ⌈ \frac{{T}_{DL , 3}}{{T}_{DL , TTI}} ⌉ \times {T}_{DL , TTI} + ⌈ \frac{{T}_{DL , 6}}{{T}_{UL , symbol}} ⌉ \times {T}_{UL , symbol} + ⌈ \frac{0.9 {T}_{DL , 3} + 0.6 {T}_{DL , 6}}{{T}_{UL , symbol}} ⌉ \times {T}_{UL , symbol} + ⌈ \frac{0.9 {T}_{DL , 6} + 0.6 {T}_{DL , 3}}{{T}_{DL , symbol}} ⌉ \times {T}_{DL , symbol} = ( ⌈ \frac{2.5 {T}_{DL , 3}}{{T}_{TTI}} ⌉ ) \times {T}_{TTI} + ( ⌈ \frac{{T}_{DL , 6}}{{T}_{symbol}} ⌉ + ⌈ \frac{2.5 {T}_{DL , 6}}{{T}_{symbol}} ⌉ ) \times {T}_{symbol} \leq 4 {T}_{TTI} , where {T}_{DL , 6} + 2 {T}_{Proc} \leq 3 {T}_{TTI} \qquad [ Equation 27 ]$$

Here, the short feedback period may be defined as

$$1 \leq {T}_{DL , 6} \leq \frac{3 {T}_{TTI} - 1.5 {T}_{DL , 3}}{2.5} .$$

When the short feedback period is configured on a slot basis and defined as 6Tₛₗₒₜ≤3T_{TTI}, the DL radio retransmission latency may be defined as Equation 28 below. Here, the short feedback period may be defined as

$$1 \leq {T}_{DL , 6} \leq \frac{3 {T}_{slot} - 1.5 {T}_{DL , 3}}{2.5} .$$

$$( ⌈ \frac{{T}_{DL , 3}}{{T}_{slot}} ⌉ + ⌈ \frac{{T}_{DL , 6} + 2 {T}_{Proc}}{{T}_{slot}} ⌉ ) \times {T}_{slot} \qquad [ Equation 28 ]$$

When the short feedback period is configured on a mini-slot basis, the DL radio retransmission latency may be defined based on Equation 29 below. Here, the short feedback period may be defined as 1≤T_{DL,6}≤Tₘᵢₙᵢ₋ₛₗₒₜ.

$$( ⌈ \frac{{T}_{DL , 3}}{{T}_{mini \text{-} slot}} ⌉ + ⌈ \frac{{T}_{DL , 6} + 2 {T}_{Proc}}{{T}_{mini \text{-} slot}} ⌉ ) \times {T}_{mini \text{-} slot} + {T}_{DL , CTRL} \qquad [ Equation 29 ]$$

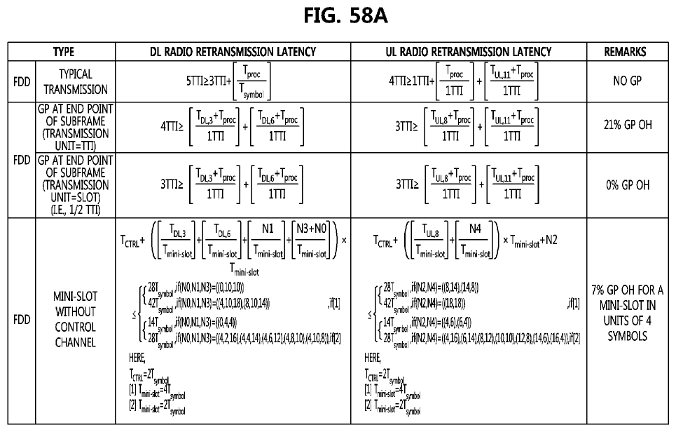

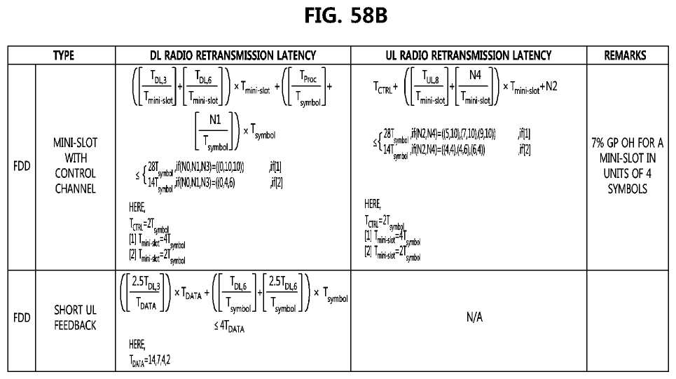

Meanwhile, when a subframe (e.g., TTI) is configured in consideration of the processing latency, a method of configuring the subframe by considering resources required for the processing operation or a method for configuring the subframe on a mini-slot basis may be used. In this case, the DL radio retransmission latency and the UL radio retransmission latency may be defined as shown in FIGS. 58A and 58B. FIGS. 58A and 58B are tables showing a DL radio retransmission latency and a UL radio retransmission latency according to a subframe configuration.

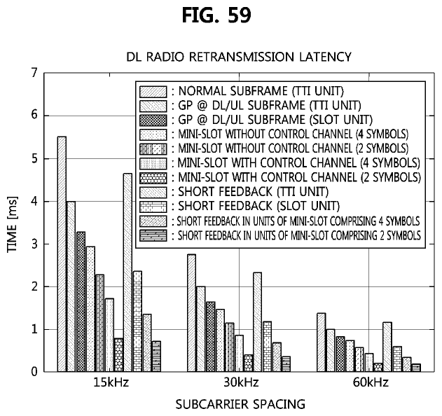

FIG. 59 is a graph showing a fourth embodiment of a DL radio retransmission latency according to a subframe configuration.

Referring to FIG. 59, when the short feedback period is used, the radio retransmission latency may be shorter than the radio retransmission latency on a subframe basis or on a mini-slot basis. It may be necessary to improve a success rate of feedback transmission when the short feedback period is used.

Dynamic Resource Allocation Scheme for Downlink Transmission

Meanwhile, the resource allocation information for transmission of the downlink data may be transmitted through the downlink control channel, and the resource allocation information for transmission of the HARQ response to the downlink data may be transmitted through the M-DL CTRL in the mini-slot. A downlink retransmission method based on a mini-slot comprising 4 symbols or based on a mini-slot comprising 2 symbols may be as follows.

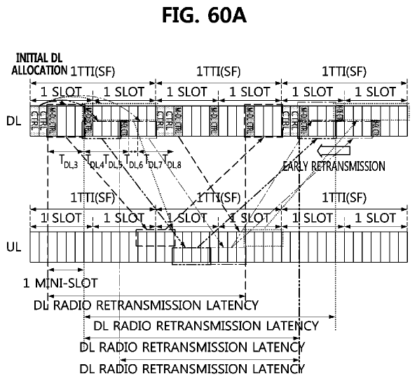

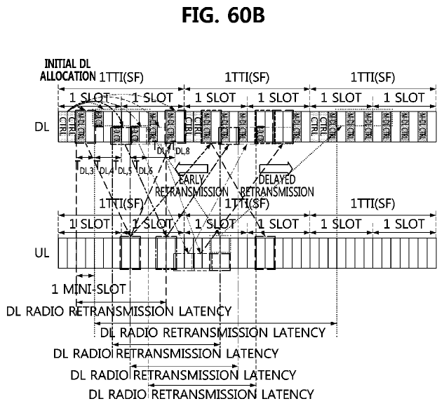

FIG. 60A is a conceptual diagram showing a third embodiment of a downlink retransmission method when a mini-slot comprising 4 symbols is used in an FDD based communication system, and FIG. 60B is a conceptual diagram showing a third embodiment of a downlink retransmission method when a mini-slot comprising 2 symbols is used in an FDD based communication system.

Referring to FIGS. 60A and 60B, the base station may transmit a downlink control channel (CTRL) for scheduling one or more mini-slots used for transmission of downlink data. Here, one downlink control channel (CTRL) may be used to schedule a plurality of mini-slots. The base station may transmit an M-DL CTRL and data in a mini-slot scheduled by the downlink control channel (CTRL). The M-DL CTRL may include characteristic information (e.g., MCS, TB size, CB size, NDI, RV, etc.) of the data transmitted in the mini-slot. Also, the M-DL CTRL may further include resource allocation information for transmission of an HARQ response to the data transmitted in the mini-slot.

The terminal may identify the resource allocation information (e.g., scheduling information) by receiving the downlink control channel (CTRL) from the base station, and identify the characteristic information of the data and the resource allocation information for transmission of the HARQ response by receiving the M-DL CTRL in the mini-slot indicated by the resource allocation information. The terminal may receive data in the mini-slot based on the identified characteristic information of the data, and may transmit the HARQ response to the received data through the resource indicated by the M-DL CTRL. Alternatively, the resource allocation information for transmission of the HARQ response may not be indicated by the M-DL CTRL. In this case, the terminal may transmit the HARQ response to the base station in the first uplink subframe, the first mini-slot, or the first symbol after a predetermined time (e.g., the processing time T_{proc}). After transmitting the HARQ response, proc) the terminal may monitor the control channel (e.g., CTRL, M-DL CTRL) to receive new data or retransmission data.

The retransmission information (e.g., NDI, RV, etc.) may be transmitted from the base station to the terminal via at least one of the downlink control channel (CTRL) and the control channel (M-DL CTRL) in the mini-slot. At least one of the downlink control channel (CTRL) and the control channel (M-DL CTRL) in the mini-slot may include information identical or similar to the feedback-related information (e.g., feedback information such as ACK/NACK for the data) described in the method for reducing the latency between data transmissions. That is, when information on the mini-slot is indicated in the downlink control channel (CTRL), not only the resource allocation information but also the feedback-related information (e.g., feedback time, feedback transmission position, etc.) may be transmitted through the downlink control channel (CTRL).

The position of the mini-slot (e.g., TTI or the location of the mini-slot within the slot) used for the transmission of the retransmission data may be different from the position of the mini-slot used for the previous transmission of the data (e.g., TTI or the location of the mini-slot within the slot). For example, the retransmission data may be transmitted in a mini-slot located prior to the mini-slot used for the previous transmission of the data. This scheme may be referred to as an ‘early retransmission scheme.’ Alternatively, the retransmission data may be transmitted in a mini-slot located after the mini-slot used for the previous transmission of the data. This scheme may be referred to as a ‘delayed retransmission scheme.’

Dynamic Resource Allocation Scheme for Uplink Transmission

Meanwhile, the resource allocation information for transmission of the uplink data may be transmitted through the control channel (M-DL CTRL) in the mini-slot. An uplink retransmission method based on a mini-slot comprising 4 symbols or based on a mini-slot comprising 2 symbols may be as follows.

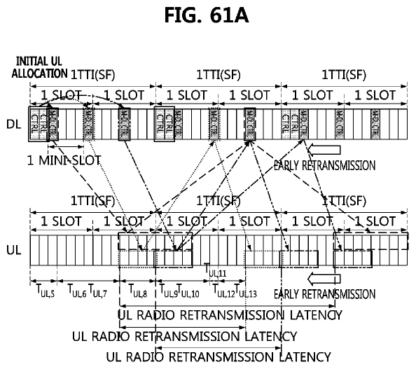

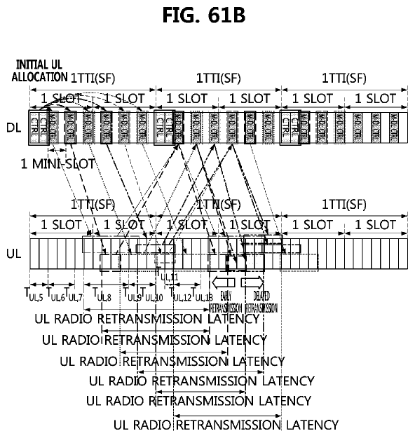

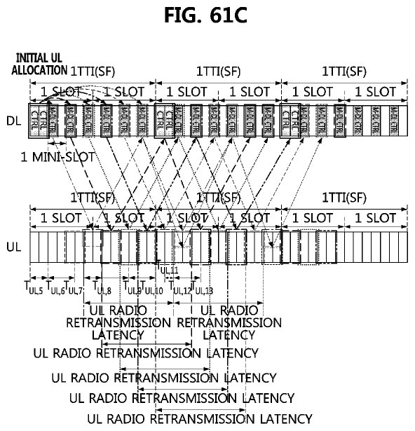

FIG. 61A is a conceptual diagram showing a fourth embodiment of an uplink retransmission method when a mini-slot comprising 4 symbols is used in an FDD based communication system, FIG. 61B is a conceptual diagram showing a fourth embodiment of an uplink retransmission method when a mini-slot comprising 2 symbols is used in an FDD based communication system, FIG. 61C is a conceptual diagram showing a fifth embodiment of an uplink retransmission method when a mini-slot comprising 2 symbols is used in an FDD based communication system.

Referring to FIGS. 61A and 61B, the base station may transmit resource allocation information for transmission of uplink data through a control channel (M-DL CTRL) in the mini-slot. Also, the control channel (M-DL CTRL) in the mini-slot may further include characteristic information (e.g., MCS, TB size, CB size, NDI, RV, etc.) of the uplink data. The control channel (M-DL CTRL) in the mini-slot may be scheduled by the downlink control channel (CTRL). The terminal may obtain the resource allocation information for transmission of the uplink data and the characteristic information of the uplink data through the control channel (M-DL CTRL) in the mini-slot, generate the uplink data based on the obtained characteristic information, and transmit the uplink data through a resource (e.g., a mini-slot) indicated by the obtained resource allocation information.

When retransmission of the uplink data is required, the base station may transmit resource allocation information for retransmission of the uplink data through a predetermined downlink control channel (CTRL) and a control channel (M-DL CTRL) in the mini-slot. Alternatively, the base station may transmit the resource allocation information for retransmission of the uplink data through a first downlink control channel (CTRL) or a control channel (M-DL CTRL) in a first mini-slot after a predetermined time (e.g., processing time T_{proc}). Also, each of the first downlink control channel (CTRL) and the control channel (M-DL CTRL) in the first mini-slot may further include characteristic information of the uplink data (e.g., NDI, RV, etc.). The terminal may identify the resource allocation information for retransmission of the uplink data by receiving the control channel (CTRL) or the control channel (M-DL CTRL) in the mini-slot, and retransmit the uplink data through a resource (e.g., mini-slot) indicated by the identified resource allocation information.

After (re)transmission of the uplink data, the terminal may monitor the control channel (e.g., CTRL, M-DL CTRL) to receive resource allocation information for transmission of new data or retransmission data. The position of the mini-slot (e.g., TTI or the location of the mini-slot within the slot) used for the retransmission of the uplink data may be different from the position of the mini-slot used for previous transmission of the uplink data (e.g., TTI or the location of the mini-slot within the slot). For example, the retransmission of the uplink data may be performed through a mini-slot located prior to the mini-slot used for the previous transmission of the uplink data. This scheme may be referred to as an ‘early retransmission scheme.’ Alternatively, the retransmission of the uplink data may be performed through a mini-slot located after the mini-slot used for the previous transmission of the uplink data. This scheme may be referred to as a ‘delayed retransmission scheme.’

In the above-described embodiments, all of the uplink subframes may be used, and the feedback resources (e.g., resources for HARQ response) may be resiliently operated. Therefore, the latency ‘N1+N3’ may be reduced by more than 2 symbols as compared with the above-described embodiment, so that the DL radio retransmission latency may be reduced. Further, the latency ‘N2+N4’ may be reduced by more than 2 symbols as compared to the previously described embodiment, so that the UL radio retransmission latency may be reduced.

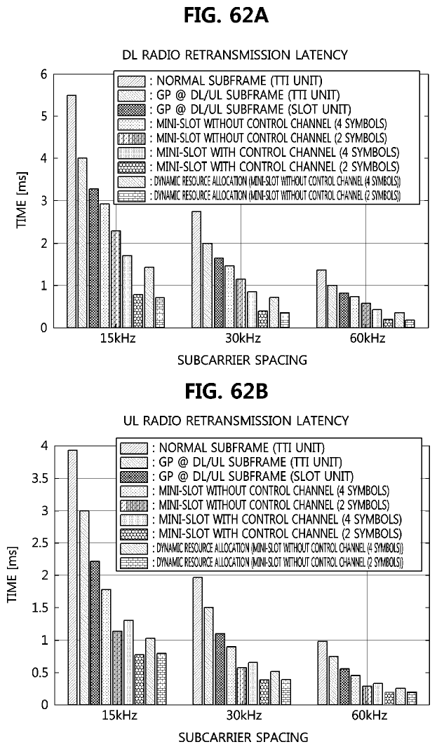

FIG. 62A is a graph showing a fifth embodiment of a DL radio retransmission latency according to a subframe configuration, and FIG. 62B is a graph showing a fourth embodiment of a UL radio retransmission latency according to a subframe configuration.

Referring to FIGS. 62A and 62B, the radio retransmission latency may be reduced when the dynamic resource allocation scheme is used. Also, when the early retransmission scheme is used, the radio retransmission latency may be reduced by more than one mini-slot.

Multi-Resource Allocation for Downlink Transmission

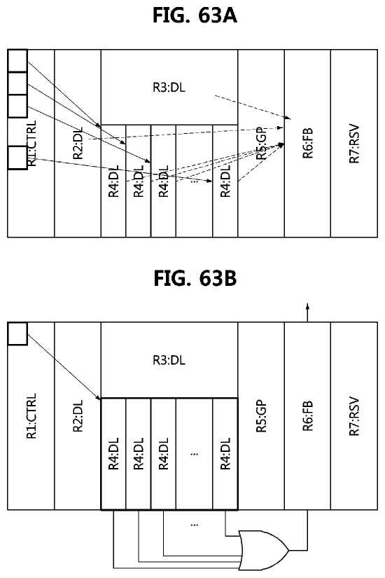

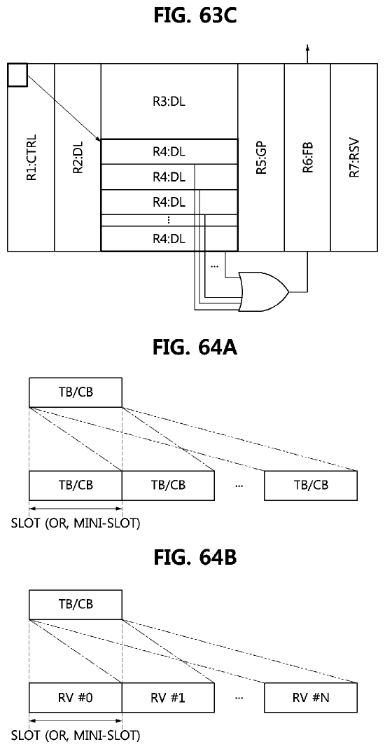

FIG. 63A is a conceptual diagram showing a first embodiment of downlink communication based on a single resource allocation scheme in a self-contained (SC) TDD based communication system.

Referring to FIG. 63A, one resource allocation information transmitted through a downlink control channel (CTRL) may indicate a resource for transmission of one data (e.g., TB or CB). An HARQ response to the data transmitted through the downlink data channel (DL) may be transmitted through an uplink resource (FB) in a subframe, a slot, or a mini-slot.

FIG. 63B is a conceptual diagram showing a first embodiment of downlink communication based on a multi-resource allocation scheme in an SC TDD based communication system.

Referring to FIG. 63B, one resource allocation information transmitted through a downlink control channel (CTRL) may indicate resources for transmission of a plurality of data (e.g., TB or CB). The resources indicated by one resource allocation information may be continuous in the time axis. HARQ responses for the plurality of data transmitted through the resources indicated by one resource allocation information may be multiplexed, aggregated, or bundled, and the multiplexed HARQ responses (e.g., aggregated HARQ responses or bundled HARQ responses) may be transmitted via an uplink resource (FB) in a subframe, slot, or mini-slot.

FIG. 63C is a conceptual diagram showing a second embodiment of downlink communication based on a multi-resource allocation scheme in an SC TDD based communication system.

Referring to FIG. 63C, one resource allocation information transmitted through a downlink control channel (CTRL) may indicate resources for transmission of a plurality of data (e.g., TB or CB). The resources indicated by one resource allocation information may be continuous in the frequency axis. HARQ responses for the plurality of data transmitted through the resources indicated by one resource allocation information may be multiplexed, aggregated, or bundled, and the multiplexed HARQ responses (e.g., aggregated HARQ responses or bundled HARQ responses) may be transmitted via an uplink resource (FB) in a subframe, slot, or mini-slot.

When the multi-resource allocation scheme is used, the downlink data may be transmitted as follows.

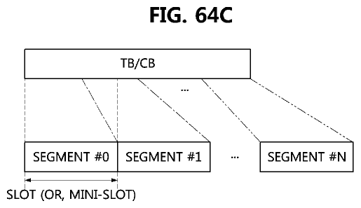

FIG. 64A is a conceptual diagram showing a first embodiment of a downlink data transmission method in a multi-resource allocation scheme, FIG. 64B is a conceptual diagram showing a second embodiment of a downlink data transmission method in a multi-resource allocation scheme, FIG. 64C is a conceptual diagram showing a third embodiment of a downlink data transmission method in a multi-resource allocation scheme.

Referring to FIG. 64A, the same data (e.g., TB or CB) may be repeatedly transmitted in consecutive resources indicated by one resource allocation information. Referring to FIG. 64B, data (e.g., TB or CB) having different RVs may be transmitted in consecutive resources indicated by one resource allocation information. Referring to FIG. 64C, when one piece of data (e.g., TB or CB) is larger than one mini-slot, the one piece of data may be divided into a plurality of segments, and the plurality of segments (e.g., segments #0 to #N) may be repeatedly transmitted in consecutive resources indicated by one resource allocation information.

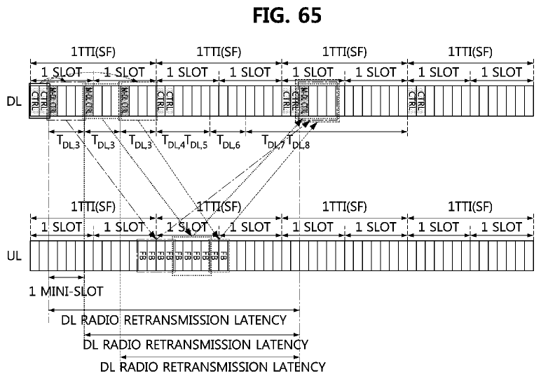

FIG. 65 is a conceptual diagram showing a first embodiment of a downlink retransmission method based on a single resource allocation scheme in a communication system.

Referring to FIG. 65, a mini-slot composed of 4 symbols may be used, resource allocation information for downlink data may be transmitted through a control channel (M-DL CTRL) in a mini-slot, and a short feedback period may be used.

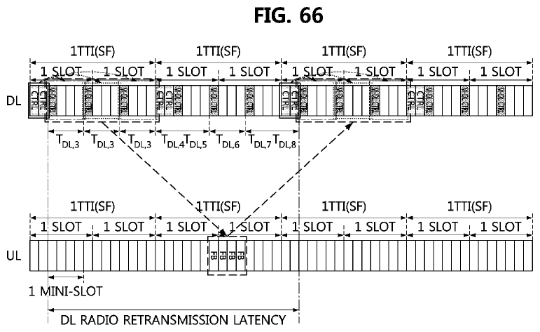

FIG. 66 is a conceptual diagram showing a first embodiment of a downlink retransmission method based on a multi-resource allocation scheme in a communication system.

Referring to FIG. 66, a mini-slot composed of 4 symbols may be used, and a plurality of mini-slots may be scheduled by one resource allocation information. In this case, the base station may repeatedly transmit the same data using the plurality of mini-slots scheduled by the one resource allocation information. The data transmission success rate may be improved when the data is repeatedly transmitted. Alternatively, different data may be transmitted using the plurality of mini-slots. The transmission characteristic information (e.g., NDI, RV, etc.) of the data may be transmitted through a control channel (M-DL CTRL) in the mini-slot.

The terminal may receive the same data through the plurality of mini-slots and may transmit an HARQ response to the data received via the plurality of mini-slots to the base station. Alternatively, the terminal may receive the different data through the plurality of mini-slots, and may transmit an HARQ response to each of the data received through the plurality of mini-slots to the base station.

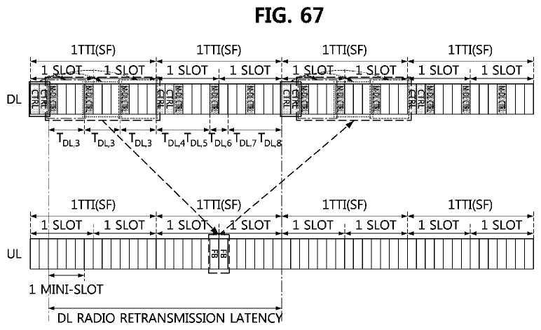

FIG. 67 is a conceptual diagram showing a second embodiment of a downlink retransmission method based on a multi-resource allocation scheme in a communication system.

Referring to FIG. 67, a mini-slot composed of 4 symbols may be used, a plurality of mini-slots may be scheduled by one resource allocation information, and a short feedback period may be used. Here, the short feedback period may correspond to the length of 2 symbols.

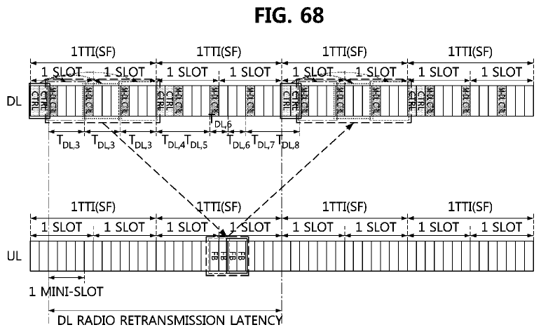

FIG. 68 is a conceptual diagram showing a third embodiment of a downlink retransmission method based on a multi-resource allocation scheme in a communication system.

Referring to FIG. 68, a mini-slot composed of 4 symbols may be used, a plurality of mini-slots may be scheduled by one resource allocation information, and a short feedback period may be used. Here, a plurality of short feedback periods may be used, and each of the plurality of short feedback periods may correspond to the length of 2 symbols.

When the HARQ response to the downlink data is not received from the terminal, the base station may transmit resource allocation information for the retransmission data through at least one of the downlink control channel (CTRL) and the control channel (M-DL CTRL) in the mini-slot. The resource allocation information for the retransmission data may be transmitted in the same manner as the resource allocation information for the initial data.

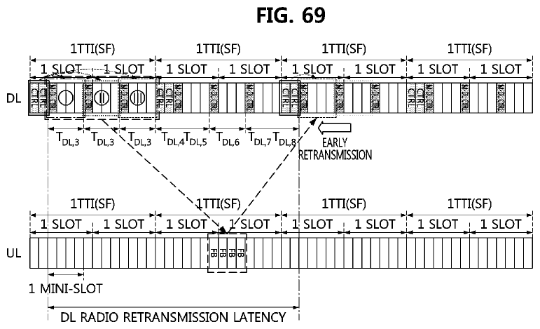

FIG. 69 is a conceptual diagram showing a fourth embodiment of a downlink data retransmission method based on a multi-resource allocation scheme in a communication system.

Referring to FIG. 69, a mini-slot composed of 4 symbols may be used, a plurality of mini-slots may be scheduled by one resource allocation information, and different downlink data (e.g., downlink data I, II, and III) may be transmitted through the plurality of mini-slots. When retransmission of the downlink data II is required, a retransmission procedure for the downlink data II may be performed. The time point of the retransmission may be resiliently operated. For example, the downlink data II may be retransmitted based on the early retransmission scheme or the delayed retransmission scheme.

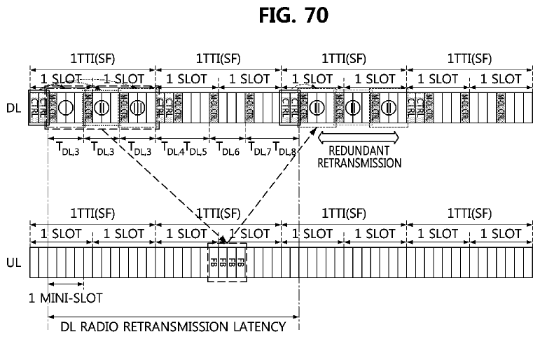

FIG. 70 is a conceptual diagram showing a fifth embodiment of a downlink data retransmission method based on a multi-resource allocation scheme in a communication system.

Referring to FIG. 70, a mini-slot composed of 4 symbols may be used, a plurality of mini-slots may be scheduled by one resource allocation information, and different downlink data (e.g., downlink data I, II, and III) may be transmitted through the plurality of mini-slots. When retransmission of the downlink data II is required, a retransmission procedure for the downlink data II may be performed. The downlink data II may be repeatedly transmitted through the plurality of mini-slots. In this case, the data transmission success rate may be improved.

Multi-Resource Allocation for Uplink Transmission

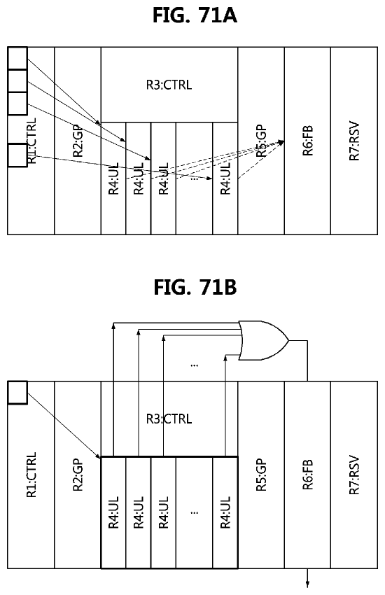

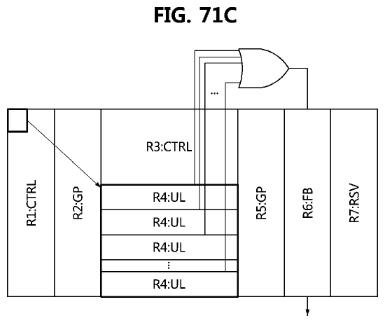

FIG. 71A is a conceptual diagram showing a first embodiment of uplink communication based on a single resource allocation scheme in an SC TDD based communication system.

Referring to FIG. 71A, one resource allocation information transmitted through a downlink control channel (CTRL) may indicate a resource for transmission of one data (e.g., TB or CB). An HARQ response to the data transmitted through the uplink data channel (DL) may be transmitted through a downlink resource (FB) in a subframe, a slot, or a mini-slot.

FIG. 71B is a conceptual diagram showing a first embodiment of uplink communication based on a multi-resource allocation scheme in an SC TDD based communication system.

Referring to FIG. 71B, one resource allocation information transmitted through a downlink control channel (CTRL) may indicate resources for transmission of a plurality of data (e.g., TB or CB). The resources indicated by one resource allocation information may be continuous in the time axis. HARQ responses for the plurality of data transmitted through the resources indicated by one resource allocation information may be multiplexed, aggregated, or bundled, and the multiplexed HARQ responses (e.g., aggregated HARQ responses or bundled HARQ responses) may be transmitted via a downlink resource (FB) in a subframe, slot, or mini-slot.

FIG. 71C is a conceptual diagram showing a second embodiment of uplink communication based on a multi-resource allocation scheme in an SC TDD based communication system.

Referring to FIG. 71C, one resource allocation information transmitted through a downlink control channel (CTRL) may indicate resources for transmission of a plurality of data (e.g., TB or CB). The resources indicated by one resource allocation information may be continuous in the frequency axis. HARQ responses for the plurality of data transmitted through the resources indicated by one resource allocation information may be multiplexed, aggregated, or bundled, and the multiplexed HARQ responses (e.g., aggregated HARQ responses or bundled HARQ responses) may be transmitted via a downlink resource (FB) in a subframe, slot, or mini-slot.

When the multi-resource allocation scheme is used, the uplink data may be transmitted based on FIGS. 64A to 64C described above. For example, the same data (e.g., TB or CB) may be repeatedly transmitted in consecutive resources indicated by one resource allocation information. Alternatively, data (e.g., TB or CB) having different RVs may be transmitted in consecutive resources indicated by one resource allocation information. Alternatively, when one piece of data (e.g., TB or CB) is larger than one mini-slot, the one piece of data may be divided into a plurality of segments, and the plurality of segments (e.g., segments #0 to #N) may be repeatedly transmitted in consecutive resources indicated by one resource allocation information.

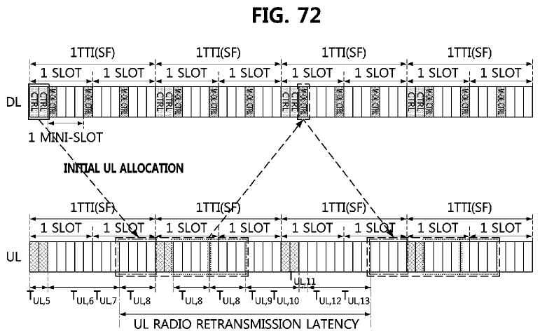

FIG. 72 is a conceptual diagram showing a first embodiment of an uplink retransmission method based on a multi-resource allocation scheme in a communication system.

Referring to FIG. 72, a mini-slot composed of 4 symbols may be used, and a plurality of mini-slots may be scheduled by one resource allocation information. In this case, the base station may repeatedly transmit the same data using the plurality of mini-slots scheduled by the one resource allocation information. The data transmission success rate may be improved when the data is repeatedly transmitted. The transmission characteristic information (e.g., NDI, RV, etc.) of the data may be transmitted through a control channel (M-DL CTRL) in the mini-slot.

The base station may receive the same data through the plurality of mini-slots and may transmit to the terminal one HARQ response for the data received through the plurality of mini-slots. When the HARQ response is a NACK, the base station may transmit resource allocation information for retransmission of the uplink data to the terminal together with the HARQ response. Alternatively, when the HARQ response is a NACK, the base station may transmit resource allocation information for retransmission of the uplink data to the terminal instead of the HARQ response. In addition, when the HARQ response is a NACK, the terminal may regard an uplink resource indicated by the resource allocation information previously received from the base station as a resource for uplink data transmission, and transmit the uplink data using the resource.

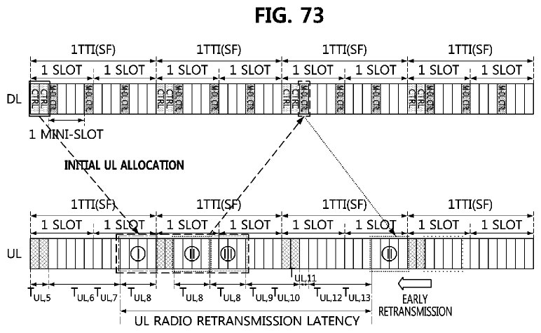

FIG. 73 is a conceptual diagram showing a second embodiment of an uplink retransmission method based on a multi-resource allocation scheme in a communication system.

Referring to FIG. 73, a mini-slot composed of 4 symbols may be used, a plurality of mini-slots may be scheduled by one resource allocation information, and different uplink data (e.g., uplink data I, II, and III) may be transmitted through the plurality of mini-slots. When retransmission of the uplink data II is required, a retransmission procedure for the uplink data II may be performed. The time point of the retransmission may be resiliently operated. For example, the uplink data II may be retransmitted based on the early retransmission scheme or the delayed retransmission scheme.

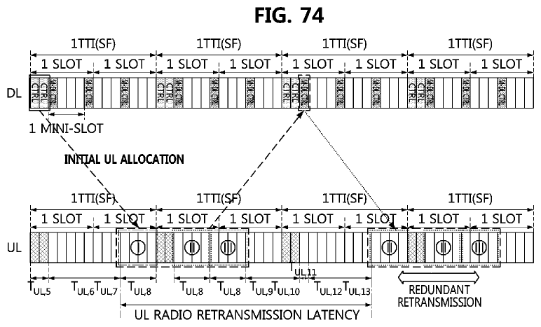

FIG. 74 is a conceptual diagram showing a third embodiment of an uplink retransmission method based on a multi-resource allocation scheme in a communication system.

Referring to FIG. 74, a mini-slot composed of 4 symbols may be used, a plurality of mini-slots may be scheduled by one resource allocation information, and different uplink data (e.g., uplink data I, II, and III) may be transmitted through the plurality of mini-slots. When retransmission of the uplink data II is required, a retransmission procedure for the uplink data II may be performed. The uplink data II may be repeatedly transmitted through the plurality of mini-slots. In this case, the data transmission success rate may be improved.

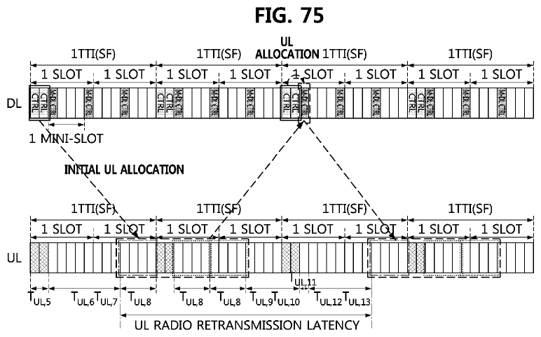

FIG. 75 is a conceptual diagram showing a fourth embodiment of an uplink retransmission method based on a multi-resource allocation scheme in a communication system.

Referring to FIG. 75, a mini-slot composed of 4 symbols may be used, and a plurality of mini-slots may be scheduled by one resource allocation information. When the uplink data is not successfully received from the terminal, the base station may transmit resource allocation information for retransmission data through at least one of the downlink control channel (CTRL) and the control channel (M-DL CTRL) in the mini-slot. The resource allocation information for the retransmission data may be transmitted in the same manner as the resource allocation information for the initial data.

Meanwhile, considering the radio retransmission latency and the failure probability Ps(n) in the case of transmitting n mini-slots in the embodiment shown in FIG. 65, the failure probability in the case of transmitting one mini-slot may be Ps(1). Thus, the radio retransmission latency may be

$$\frac{2 {T}_{TTI}}{1 - {P}_{s} ( 1 )} .$$

In the embodiment shown in FIG. 66, when the same data is repeatedly transmitted through the plurality of mini-slots, the radio retransmission latency may be reduced because the data transmission failure rate is lowered. When the same data is repeatedly transmitted n times, the radio retransmission latency may be

$$\frac{2 {T}_{TTI}}{1 - {P}_{s} ( n )} .$$

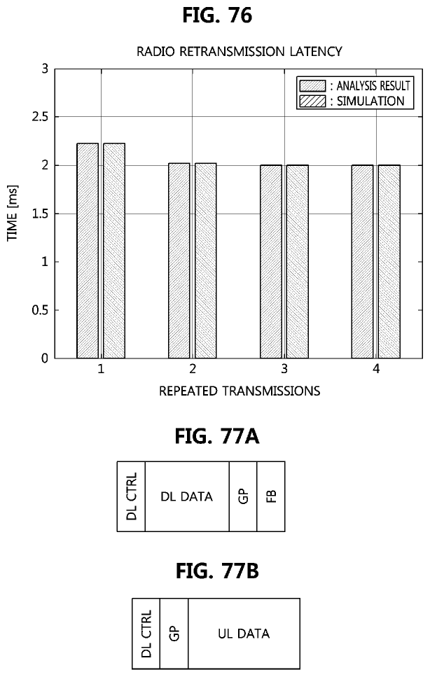

Referring to the graph showing radio retransmission latencies according to the number of repeated transmissions of data shown in FIG. 76, the radio retransmission latency when the same data is repeatedly transmitted twice or more may be smaller than the radio retransmission latency when data is transmitted once. In FIG. 76, a bit error rate (BER) may be 0.1.

SC Subframe-Based Resource Management/Allocation Method

When the uplink and downlink communications operate in the same spectrum, a propagation delay and an RF processing latency (e.g., a latency due to change between downlink and uplink communication, a latency due to bandwidth adaptation, etc.) may occur. The subframe may be composed of a plurality of symbols, and the GP may be configured in the subframe in consideration of the RF processing latency. Also, the GP may be configured in consideration of the RF processing latency as well as a baseband processing latency. The SC subframe may be configured as follows.

FIG. 77A is a block diagram showing a first embodiment of an SC subframe in a communication system.

Referring to FIG. 77A, an SC subframe may include a downlink control channel (DL CTRL), a downlink data channel (DL DATA), a GP, and an HARQ response (FB). The downlink control channel (DL CTRL) may be used for transmission of control information for scheduling the downlink data channel (DL DATA). The downlink data channel (DL DATA) may be used for transmission of downlink data. The GP may be used for switching between downlink and uplink communications. The HARQ response (FB) may be an independent HARQ response channel, or may be included in an uplink control channel or an uplink data channel. Also, the HARQ response (FB) may be used for transmission of the HARQ response to the downlink data received through the downlink data channel (DL DATA).

FIG. 77B is a block diagram showing a second embodiment of an SC subframe in a communication system.

Referring to FIG. 77B, an SC subframe may include a downlink control channel (DL CTRL), a GP, and an uplink data channel (UL DATA). The downlink control channel (DL CTRL) may be used for transmission of control information for scheduling the uplink data channel (UL DATA). The GP may be used for switching between downlink and uplink communications. The uplink data channel (UL DATA) may be used for transmission of uplink data.

An SC subframe considering downlink/uplink retransmission may be configured as follows.

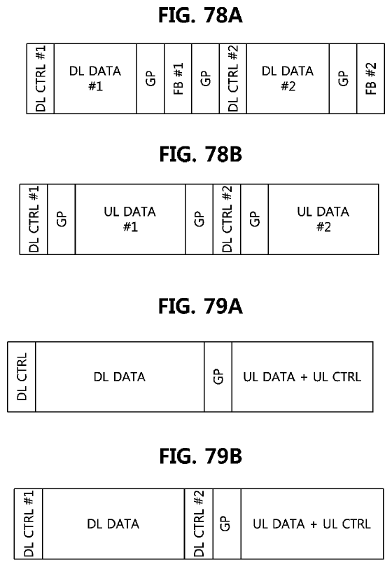

FIG. 78A is a block diagram showing a third embodiment of an SC subframe in a communication system.

Referring to FIG. 78A, an SC subframe may include a downlink control channel #1 (DL CTRL #1), a downlink data channel #1 (DL DATA #1), an HARQ response #1 (FB #1), a downlink control channel #2 (DL CTRL #2), a downlink data channel #2 (DL DATA #2), an HARQ response #2 (FB #2), and a GP.

The downlink control channel #1 (DL CTRL #1) may be used for transmission of control information for scheduling of the downlink data channel #1 (DL DATA #1). The downlink data channel #1 (DL DATA #1) may be used for transmission of downlink data. The HARQ response #1 (FB #1) may be included in the uplink control channel or the uplink data channel, and may be used for transmission of an HARQ response to the downlink data received through the downlink data channel #1 (DL DATA #1).

The downlink control channel #2 (DL CTRL #2) may be used for scheduling retransmission of the downlink data transmitted through the downlink data channel #1 (DL DATA #1). For example, the downlink control channel #2 (DL CTRL #2) may be used for transmission of control information for scheduling of the downlink data channel #2 (DL DATA #2). The downlink data channel #2 (DL DATA #2) may be used for retransmission of the downlink data. The HARQ response #2 (FB #2) may be an independent HARQ response channel, or may be included in the uplink control channel or the uplink data channel. Also, the HARQ response #2 (FB #2) may be used for transmission of an HARQ response to the downlink data received through the downlink data channel #2 (DL DATA #2). The GP may be used for switching between downlink and uplink communications.

FIG. 78B is a block diagram showing a fourth embodiment of an SC subframe in a communication system.

Referring to FIG. 78B, an SC subframe may include a downlink control channel #1 (DL CTRL #1), an uplink data channel #1 (UL DATA #1), a downlink control channel #2 (DL CTRL #2), an uplink data channel #2 (UL DATA #2), and a GP. The downlink control channel #1 (DL CTRL #1) may be used for transmission of control information for scheduling the uplink data channel (UL DATA #1). The uplink data channel #1 (UL DATA #1) may be used for transmission of uplink data.

The downlink control channel #2 (DL CTRL #2) may be used for scheduling retransmission of the uplink data transmitted through the uplink data channel #1 (UL DATA #1). For example, the downlink control channel #2 (DL CTRL #2) may be used for transmission of control information for scheduling the uplink data channel #2 (UL DATA #2). The uplink data channel #2 (UL DATA #2) may be used for retransmission of the uplink data. The GP may be used for switching between downlink and uplink communications.

FIG. 79A is a block diagram showing a fifth embodiment of an SC subframe in a communication system.

Referring to FIG. 79A, an SC subframe may include a downlink control channel (DL CTRL), a downlink data channel (DL DATA), a GP, and an uplink data/control channel (UL DATA+UL CTRL). The downlink control channel (DL CTRL) may be used for transmission of control information for scheduling the downlink data channel (DL DATA) and the uplink data/control channel (UL DATA+UL CTRL). The downlink data channel (DL DATA) may be used for transmission of downlink data. The GP may be used for switching between downlink and uplink communications. The uplink data/control channel (UL DATA+UL CTRL) may be used for transmission of uplink data and an HARQ response to the downlink data received through the downlink data channel (DL DATA).

FIG. 79B is a block diagram showing a sixth embodiment of an SC subframe in a communication system.

Referring to FIG. 79B, an SC subframe may include a downlink control channel #1 (DL CTRL #1), a downlink data channel (DL DATA), a downlink control channel #2 (DL CTRL #2), a GP, and an uplink data/control channel (UL DATA+UL CTRL). The downlink control channel #1 (DL CTRL #1) may be used for transmission of control information for scheduling the downlink data channel (DL DATA). The downlink data channel (DL DATA) may be used for transmission of downlink data. The downlink control channel #2 (DL CTRL #2) may be used for transmission of control information for scheduling of the uplink data/control channel (UL DATA+UL CTRL). The GP may be used for switching between downlink and uplink communications. The uplink data/control channel (UL DATA+UL CTRL) may be used for transmission of uplink data and an HARQ response to the downlink data received through the downlink data channel (DL DATA).

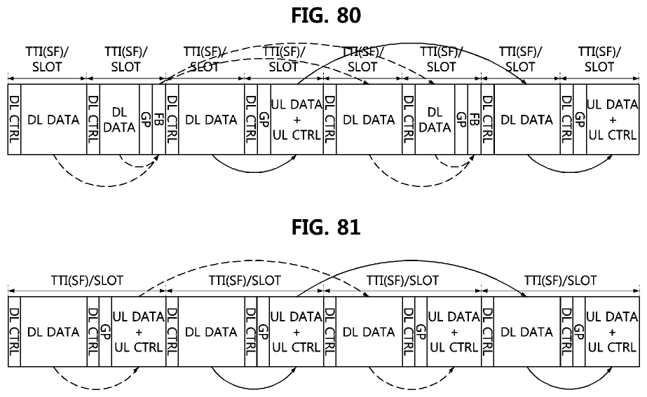

FIG. 80 is a conceptual diagram showing a first embodiment of a radio retransmission latency when an SC subframe is used in a communication system.

Referring to FIG. 80, in a communication system, an SC subframe may be alternately located with a normal downlink subframe. When reception of downlink data and transmission of an HARQ response to the received downlink data are both performed within the same TTI (e.g., the same slot), the radio transmission latency may be reduced. However, when the SC subframe is used alternately with a normal downlink subframe, the reception of the downlink data and the transmission of the HARQ response to the received downlink data may not be performed within the same TTI (e.g., the same slot). In this case, the radio retransmission latency may increase relatively. Also, a GP considering a processing latency between the reception of the downlink data and the transmission of the HARQ response to the received downlink data may be defined.

FIG. 81 is a conceptual diagram showing a second embodiment of a radio retransmission latency when an SC subframe is used in a communication system.

The embodiment shown in FIG. 81 may represent a subframe structure for solving the problem of the increase in the radio retransmission latency according to the embodiment shown in FIG. 80. According to the embodiment shown in FIG. 81, the radio retransmission latency may be relatively reduced.

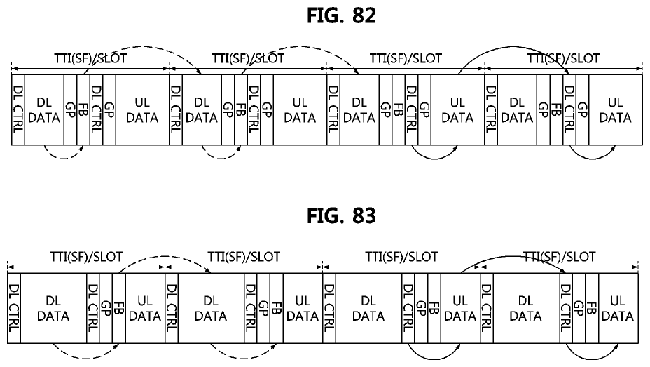

FIG. 82 is a conceptual diagram showing a third embodiment of a radio retransmission latency when an SC subframe is used in a communication system.

Referring to FIG. 82, all slots in a communication system may be configured as SC subframes. The embodiment shown in FIG. 82 may represent a subframe structure for solving the problem of the increase in the radio retransmission latency according to the embodiment shown in FIG. 81. According to the embodiment shown in FIG. 82, the radio retransmission latency may be relatively reduced.

FIG. 83 is a conceptual diagram showing a fourth embodiment of a radio retransmission latency when an SC subframe is used in a communication system.

The embodiment shown in FIG. 83 may represent a subframe structure for solving the problem of increase in the radio retransmission latency according to the embodiment shown in FIG. 82. For example, an uplink data channel (UL DATA) may be configured in the SC subframe in place of the HARQ response to the downlink data channel (DL DATA). In the embodiment shown in FIG. 83, the number of GPs may be smaller than the number of GPs in the embodiment shown in FIG. 82.

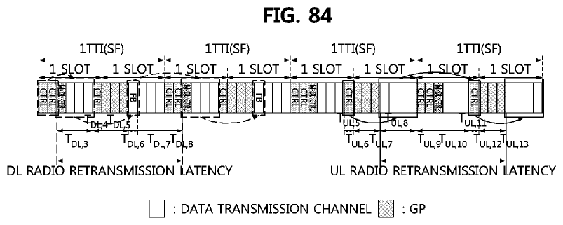

FIG. 84 is a conceptual diagram showing an embodiment of a radio retransmission latency when an SC subframe shown in FIG. 83 is used.

Referring to FIG. 84, a mini-slot may be composed of 4 symbols, and a GP may be composed of 3 symbols. The latency due to the decoding operation on the downlink data+the latency due to the encoding operation on the HARQ response to the downlink data (e.g., T_{DL,4}+T_{DL,5}) may be equal to or less than a GP. The latency due to the decoding operation on resource allocation information of uplink data (e.g., downlink control information)+the latency due to the encoding operation on the uplink data (e.g., T_{UL,6}+T_{UL,7}+T_{UL,12}+T_{UL,13}) may be equal to or less than a GP. The downlink retransmission operation or the uplink retransmission operation may be performed within one TTI. In this case, a GP overhead may be equal to or greater than 21%. Here, the GP may be configured to have symbols less than 3 symbols or more than 3 symbols. In this case, T_{DL,6} in the downlink communication may be configured in an arbitrary symbol of the uplink data channel. Also, T_{UL,8} in the uplink communication may be started from the previous symbol or the following symbol of the conventional symbol.

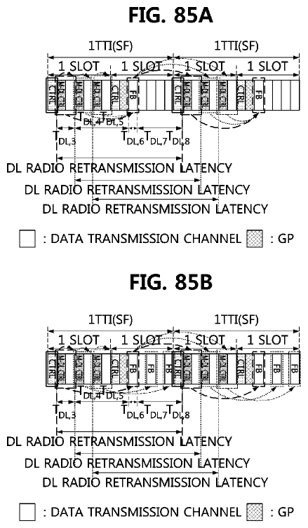

FIG. 85A is a conceptual diagram showing a fifth embodiment of a radio retransmission latency when an SC subframe is used in a communication system, and FIG. 85B is a conceptual diagram showing a sixth embodiment of a radio retransmission latency when an SC subframe is used in a communication system.

Referring to FIGS. 85A and 85B, a mini-slot may be composed of 2 symbols, an aggregated feedback scheme may be used in the embodiment shown in FIG. 85A, and an individual feedback scheme may be used in the embodiment shown in FIG. 85B. For example, in the embodiment shown in FIG. 85A, HARQ responses for a plurality of downlink data may be transmitted at the same time point (e.g., T_{DL,6}). Here, the HARQ responses may be multiplexed, aggregated, or bundled and repeatedly transmitted in 2 or more consecutive mini-slots. Alternatively, in the embodiment shown in FIG. 85B, the HARQ responses for the plurality of downlink data may be transmitted at different time points. That is, the HARQ responses for the plurality of downlink data may be transmitted according to a predetermined timing.

In the downlink retransmission procedure, resources for the downlink data required to be retransmitted may be allocated, and retransmission of the downlink data required to be retransmitted may be performed using the allocated resources. Thus, the downlink radio retransmission latency may be reduced. In this case, the terminal may perform a monitoring operation on the downlink control channel. In order to reduce unnecessary monitoring operations, the location of the mini-slot in which the downlink retransmission is performed (e.g., the location of the TTI or the mini-slot in the slot) may be the same as the location of the mini-slot in which the initial transmission is performed.

Alternatively, the base station may transmit allocation information of a mini-slot in which the downlink retransmission is performed through a downlink control channel (e.g., a downlink control channel in the slot to which the mini-slot in which the downlink retransmission is performed belongs). In this case, the terminal may receive the allocation information of the mini-slot in which the downlink retransmission is performed from the base station, and determine that the downlink retransmission is performed in the mini-slot indicated by the received allocation information. This scheme may be applied not only to the downlink retransmission procedure but also to the downlink initial transmission procedure. In this case, the terminal may not perform an unnecessary mini-slot monitoring operation.

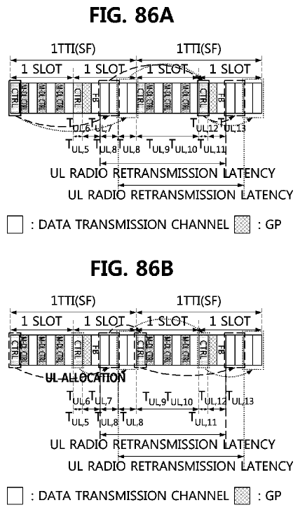

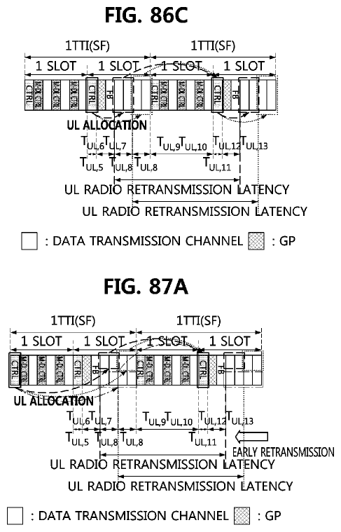

FIG. 86A is a conceptual diagram showing a first embodiment of an uplink radio retransmission latency when an SC subframe is used in a communication system, FIG. 86B is a conceptual diagram showing a second embodiment of an uplink radio retransmission latency when an SC subframe is used in a communication system, and FIG. 86C is a conceptual diagram showing a third embodiment of an uplink radio retransmission latency when an SC subframe is used in a communication system.

Referring to FIG. 86A, a subframe structure shown in FIG. 86A may be the same as the subframe structure shown in FIG. 83. Resource allocation information of uplink data (e.g., resource allocation information for retransmission of uplink data) may be transmitted through a downlink control channel including resource allocation information of downlink data. Resource allocation information for retransmission of the uplink data may be transmitted through a downlink control channel including resource allocation information of the uplink data (e.g., initial data). Here, the resource allocation information for retransmission of the uplink data may be generated in advance before a time point of resource allocation for retransmission of the uplink data after the reception of the initial data. Therefore, the uplink radio retransmission latency may be reduced.

Referring to FIG. 86B, the resource allocation information for retransmission of the uplink data may be transmitted through a downlink control channel including resource allocation information of downlink data or a downlink control channel including resource allocation information of the uplink data (e.g., initial data). Therefore, in the embodiment shown in FIG. 86B, the resources may be flexibly utilized compared to the embodiment shown in FIG. 86A or the embodiment shown in FIG. 86C.

Referring to FIG. 86C, the resource allocation information for retransmission of the uplink data may be transmitted through a downlink control channel including resource allocation information of the uplink data (e.g., initial data). A (re)transmission latency according to the embodiment shown in FIG. 86C may be shorter than a (re)transmission latency according to the embodiment shown in FIG. 86A or the embodiment shown in FIG. 86C. In this case, a GP overhead may be equal to or less than 7%.

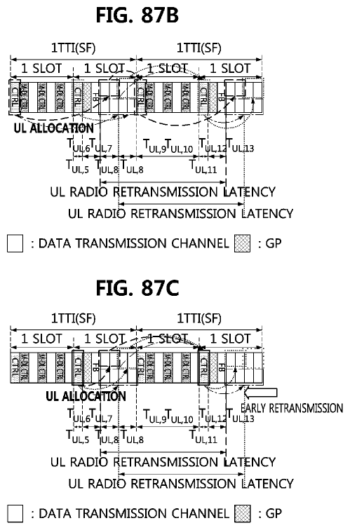

FIG. 87A is a conceptual diagram showing a third embodiment of an uplink radio retransmission latency when an SC subframe is used in a communication system, FIG. 87B is a conceptual diagram showing a fifth embodiment of an uplink radio retransmission latency when an SC subframe is used in a communication system, and FIG. 87C is a conceptual diagram showing a sixth embodiment of an uplink radio retransmission latency when an SC subframe is used in a communication system.

The embodiment shown in FIG. 87A may represent a case where the dynamic resource allocation scheme is applied to the embodiment shown in FIG. 86A, the embodiment shown in FIG. 87B may represent a case where the dynamic resource allocation scheme is applied to the embodiment shown in FIG. 86B, and the embodiment shown in FIG. 87C may represent a case where the dynamic resource allocation scheme is applied to the embodiment shown in FIG. 86C. Here, the mini-slot may be composed of 2 or more symbols, and the early retransmission scheme may be used.

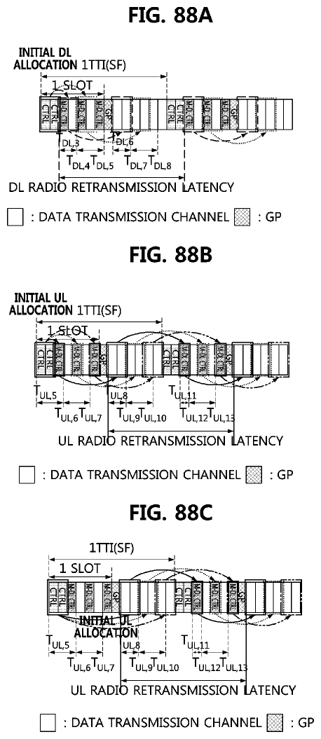

FIG. 88A is a conceptual diagram showing a seventh embodiment of a radio retransmission latency when an SC subframe is used in a communication system, FIG. 88B is a conceptual diagram showing an eighth embodiment of a radio retransmission latency when an SC subframe is used in a communication system, and FIG. 88C is a conceptual diagram showing a ninth embodiment of a radio retransmission latency when an SC subframe is used in a communication system.

Referring to FIGS. 88A to 88C, a downlink data channel and an uplink data channel may coexist in 2 or more consecutive slots, and resource allocation information of data may be transmitted through a downlink control channel (M-DL CTRL) in a mini-slot.

In the embodiment shown in FIG. 88A, resource allocation information for downlink data (e.g., initial data) may be transmitted through a downlink control channel. In the embodiment shown in FIG. 88B, resource allocation information for uplink data (e.g., initial data) may be transmitted on a downlink control channel (M-DL CTRL) in a mini-slot. In the embodiment shown in FIG. 88C, resource allocation information for uplink data (e.g., initial data) may be transmitted through a downlink control channel.

Also, in the embodiment shown in FIG. 88A, resource allocation information for downlink data may be transmitted through a downlink control channel (M-DL CTRL) in a mini-slot. In the embodiment shown in FIG. 88B, resource allocation information for uplink data may be transmitted through a downlink control channel (M-DL CTRL) in a mini-slot. In this case, the downlink control channel (DL CTRL) may include information of a mini-slot for transmitting the downlink data.

Also, the data retransmission procedure may be performed based on the resource allocation information transmitted through the downlink control channel or the downlink control channel (M-DL CTRL) in the mini-slot. In this case, the downlink control channel may include only the information on the initial data, and the information on the retransmission data may be included only in the downlink control channel (M-DL CTRL) in the mini-slot belonging to the downlink control channel. Therefore, a load of the downlink control channel may be reduced.

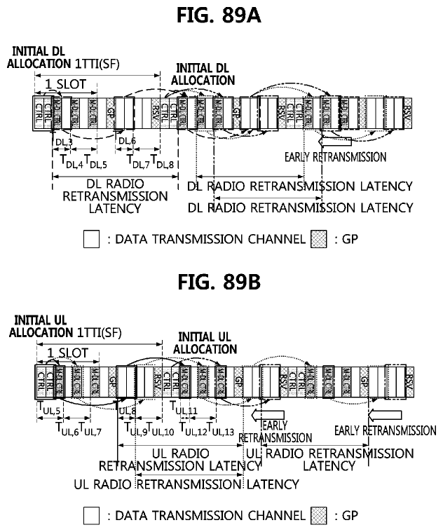

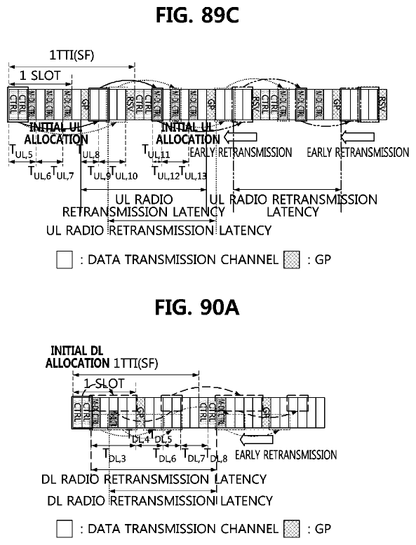

The embodiments shown in FIGS. 89A to 89C below may show cases where a flexible subframe is used as compared with the embodiments shown in FIGS. 88A to 88C.

FIG. 89A is a conceptual diagram showing a tenth embodiment of a radio retransmission latency when an SC subframe is used in a communication system, FIG. 89B is a conceptual diagram showing an eleventh embodiment of a radio retransmission latency when an SC subframe is used in a communication system, and FIG. 89C is a conceptual diagram showing a twelfth embodiment of a radio retransmission latency when an SC subframe is used in a communication system.

Referring to FIGS. 89A to 89C, when a mini-slot is available for retransmission, the data retransmission procedure may be performed through the corresponding mini-slot. That is, the early retransmission scheme may be used. In this case, the radio retransmission latency may be reduced.

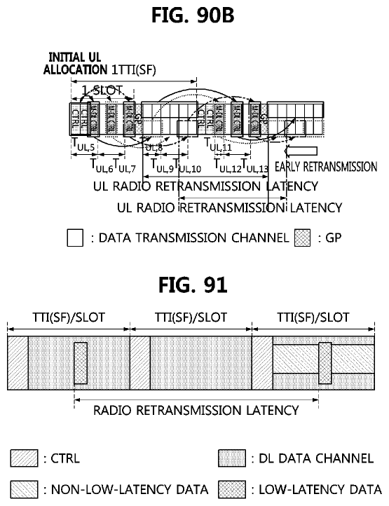

FIG. 90A is a conceptual diagram showing a thirteenth embodiment of a radio retransmission latency when an SC subframe is used in a communication system, and FIG. 90B is a conceptual diagram showing a fourteenth embodiment of a radio retransmission latency when an SC subframe is used in a communication system.

The embodiment shown in FIG. 90A may show a case where the dynamic resource allocation scheme is applied to the embodiment shown in FIG. 88A or the embodiment shown in FIG. 89A. The embodiment shown in FIG. 90B may show a case where the dynamic resource allocation scheme is applied to the embodiment shown in FIG. 88B or the embodiment shown in FIG. 89B. Here, a mini-slot may be composed of 2 or more symbols, and the early retransmission scheme may be used depending on whether resources are used after a processing latency. When the early retransmission scheme is used, the radio retransmission latency may be reduced.

Meanwhile, an SC subframe may be configured as a subframe for transmission of downlink data, a subframe for transmission of uplink data, or a subframe for transmission of downlink/uplink data. Each of a plurality of subframes belonging to a radio frame may be configured as an SC subframe, a downlink dedicated subframe, or an uplink dedicated subframe. Configuration information of a plurality of subframes belonging to a radio frame may be signaled from the base station to the terminal. For example, the configuration information may be transmitted through at least one of a higher-layer message, a MAC CE, and a DCI. The configuration information may indicate that each of the plurality of subframes is configured as an SC subframe, a downlink dedicated subframe, or an uplink dedicated subframe. For example, all subframes belonging to a radio frame may be configured as SC subframes.

The terminal may identify the type of the corresponding slot based on the configuration information of the SC subframe acquired through the first symbol (e.g., the downlink control channel) in the slot, and perform operations based on the identified type. Here, the type of the slot may be classified into a downlink dedicated slot, an uplink dedicated slot, a ‘downlink+FB’ slot, and an ‘uplink+FB’ slot. The ‘downlink+FB’ slot and the ‘uplink+FB’ slot may be configured based on Table 9 below. Here, a slot in the SC subframe may be composed of 7 symbols.

TABLE 9

| Symbol | ‘downlink + FB’ | |
|---|---|---|
| index | slot | ‘uplink + FB’ slot |
| 0 | Control channel | Control channel |
| 1 | Control channel | GP |
| 2 | Control/data channel | Data/control channel |
| 3 | Data channel | Data/control channel |
| 4 | GP | GP |
| 5 | FB(ACK/CSI), SRS | FB(ACK/CSI), SRS |
| 6 | GP | RSV |

The configuration information of the SC subframe may be transmitted through at least one of a higher-layer message, a MAC CE, and a DCI. Also, an application period of the configuration information of the SC subframe may be set to a time corresponding to 2 or more slots, and may be transmitted through at least one of a higher-layer message, a MAC CE, and a DCI.

The configuration information of the SC subframe may be indicated by a bitmap. For example, a bit included in the bitmap may indicate that the corresponding symbol is set to a downlink symbol, an uplink symbol, or a GP. The bitmap may be transmitted through at least one of a higher-layer message, a MAC CE, and a DCI. For example, when a bitmap set to “1111011” is received, the terminal may determine that the symbols #0 to #4 are set to downlink symbols, the symbol #5 is set to the GP, and the symbols #6 to #7 are set to uplink symbols.

That is, a bit set to ‘0’ may indicate that the corresponding symbol is set to the GP, and a transmission direction (e.g., downlink or uplink) may be changed based on the bit set to ‘0.’ For example, when one or more bits located before the bit set to ‘0’ are set to ‘1,’ the one or more bits set to ‘1’ may indicate that the corresponding symbols are set as downlink symbols. When one or more bits located after the bit set to ‘0’ are set to ‘1,’ the one or more bits set to ‘1’ may indicate that the corresponding symbols are set as uplink symbols.

Alternatively, the base station may transmit information indicating a ratio of a downlink data transmission region and an uplink data transmission region to the terminal, and the terminal may identify the downlink data transmission region and the uplink data transmission region in the slot based on the information indicating the ratio. For example, when the ratio of the downlink data transmission region to the uplink data transmission region is ‘1:1,’ the terminal may determine a half region of a preconfigured period (e.g., a TTI, a slot, or a plurality of slots) as the downlink data transmission region, and determine the remaining half region as the uplink data transmission region. Also, the terminal may determine that the GP is configured between the downlink data transmission region and the uplink data transmission region.

When the size of the downlink data transmission region is M, the size of the uplink data transmission region is N, the radio between the downlink data transmission region and the uplink data transmission region is ‘M:N,’ and the total number of symbols in the preconfigured period is N_{symbol}, N_{symbol}×M/M+N symbols may be configured as downlink symbols, and N_{symbol}×N/M+N symbols may be configured as uplink symbols.

Method for Improving Performance of a (Re)Transmission Procedure

Data according to the low-latency service (hereinafter referred to as ‘low-latency data’) may be generated intermittently. The size of the low-latency data may be relatively small, and the low-latency data may be transmitted in accordance with low-latency (e.g., retransmission low-latency) requirements. When the resource allocation scheme based on a mini-slot is used, the base station may transmit resource allocation information for the low-latency data using a downlink control channel (CTRL) or a downlink control channel (M-DL CTRL) in a mini-slot, and the terminal may receive the low-latency data based on the resource allocation information received through the downlink control channel (CTRL) or the downlink control channel (M-DL CTRL) in the mini-slot. On the other hand, resource allocation information for normal data (e.g., non-low-latency data) other than the low-latency data may be transmitted through a downlink control channel (CTRL). Accordingly, the terminal may transmit and receive the normal data based on the resource allocation information received through the downlink control channel (CTRL).

Here, the low-latency data may be ultra-low latency data (i.e., ultra-reliable and low-latency communication (URLLC) data), and the non-low-latency data may be non-ultra-low-latency data (i.e., non-URLLC data).

Meanwhile, transmission of non-low-latency data (i.e., non-low-latency communication (LLC) data) may conflict with transmission of low-latency data (i.e., Low-Latency Communication (LLC) data) in the same slot.

FIG. 91 is a conceptual diagram showing a first embodiment of a collision between transmission of non-low-latency data and transmission of low-latency data in a communication system.

Referring to FIG. 91, transmission of non-low-latency data may conflict with transmission of low-latency data in the third slot (or third TTI). In order to solve the collision problem between transmission of non-low-latency data and transmission of low-latency data, the following embodiments may be considered.

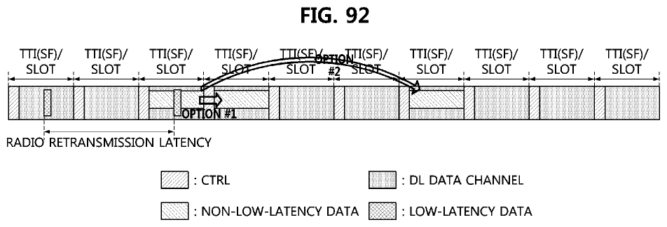

FIG. 92 is a conceptual diagram showing a first embodiment of a method of transmitting non-low-latency data and low-latency data in a communication system.

Referring to FIG. 92, when transmission of non-low-latency data conflicts with transmission of low-latency data in the same slot, the non-low-latency data may not be transmitted in the corresponding slot. In this case, the non-low-latency data may be transmitted through a slot different from the slot in which the low-latency data is transmitted, and a transmission rate of the low-latency data may be improved.

The transmission of the non-low-latency data may be delayed due to the transmission of the low-latency data. In this case, the base station may transmit information indicating that the transmission of the non-low-latency data is delayed to the terminal through a downlink control channel in the slot in which the low-latency data is transmitted. Also, the information indicating a transmission time point of the non-low-latency data may be transmitted through the downlink control channel. The terminal may receive the information indicating that the transmission of the non-low-latency data is delayed and the information indicating the transmission time point of the non-low-latency data through the downlink control channel, and perform a receiving operation of the non-low-latency data based on the information.

When the transmission of the non-low-latency data is delayed, the non-low-latency data may be repeatedly transmitted a predetermined number of times. In particular, when transmission of periodic data (e.g., a search signal, a synchronization signal, a reference signal, etc.) is delayed, a transmission period may be reconfigured according to the delay of the transmission. Alternatively, the periodic data may be transmitted regardless of the transmission period at a specific time, and may be transmitted according to the transmission period after the specific time. Alternatively, when the periodic data cannot be transmitted according to the transmission period at a specific time, the transmission of the periodic data may be omitted at the specific time.

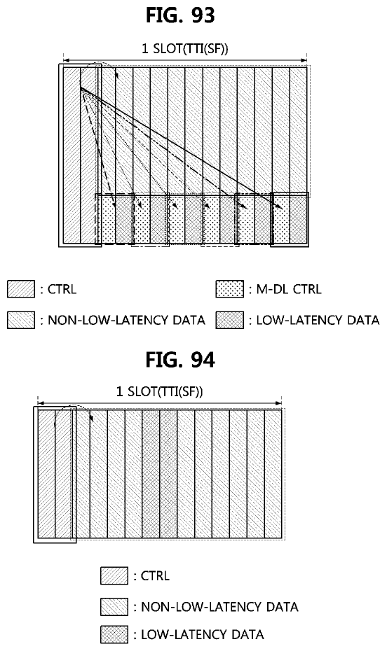

FIG. 93 is a conceptual diagram showing a second embodiment of a method of transmitting non-low-latency data and low-latency data in a communication system.

Referring to FIG. 93, resources for transmission of non-low-latency data may be configured so as not to overlap with resources for transmission of low-latency data in the same slot. Resource allocation information for the non-low-latency data and the low-latency data may be transmitted through at least one of a downlink control channel (CTRL) and a downlink control channel (M-DL CTRL) in a mini-slot. Thus, based on the resource allocation information obtained through the downlink control channel (CTRL) or the downlink control channel (M-DL CTRL) in the mini-slot, the terminal may identify the resources allocated for the transmission of non-low-latency data and the resources allocated for the transmission of the low-latency data.

FIG. 94 is a conceptual diagram showing a first embodiment of a resource element (RE) mapping method of non-low-latency data and low-latency data in a communication system.

Referring to FIG. 94, when non-low-latency data and low-latency data are transmitted in the same slot, RE mapping for the non-low-latency data may be performed independently of RE mapping for the low-latency data. In this case, the terminal may perform a receiving operation (e.g., demapping, demodulation, and decoding operations) on REs to which the non-low-latency data is mapped, and a receiving operation (e.g., demapping, demodulation, and decoding operations) on REs to which the low-latency data is mapped. Here, the non-low-latency data may be mapped to REs based on a rate matching scheme or a puncturing scheme. Also, layered encoding may be applied so that the terminal can distinguish the non-low-latency data from the low-latency data.

Since the low-latency data occurs intermittently, unnecessary resources may be wasted when resources for the transmission of the low-latency data are preconfigured. In order to solve this problem, if the low-latency data does not occur, preconfigured resources may be used for transmission of non-low-latency data. Based on the information obtained through the control channel, the terminal may identify the resources allocated for the transmission of low-latency data and resources allocated for the transmission of non-low-latency data.

However, the terminal may not know that low-latency data and non-low-latency data are transmitted in the same slot. Also, the terminal may not know the resources allocated for the transmission of low-latency data and the resources allocated for the transmission of non-low-latency data. In this case, the terminal may not successfully receive the low-latency data or the non-low-latency data from the base station. In order to solve this problem, the low-latency data or the non-low-latency data may be repeatedly transmitted.

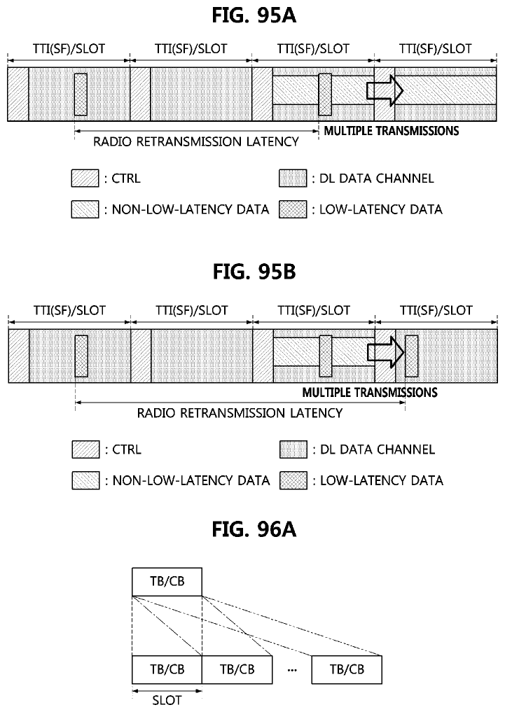

FIG. 95A is a conceptual diagram showing a first embodiment of a method for repeatedly transmitting non-low-latency data in a communication system, and FIG. 95B is a conceptual diagram showing a first embodiment of a method for repeatedly transmitting low-latency data in a communication system.

Referring to FIGS. 95A and 95B, non-low-latency data and low-latency data may be transmitted in the same slot. In this case, RE mapping for the non-low-latency data and RE mapping for the low-latency data may be performed as in the embodiment shown in FIG. 94. In the embodiment shown in FIG. 95A, the non-low-latency data may be repeatedly transmitted in 2 or more slots to improve the transmission rate of the non-low-latency data. In this case, even when the terminal does not receive the non-low-latency data in the third slot, the terminal may receive the non-low-latency data in the next slot (e.g., the fourth slot), and transmit an HARQ response for the non-low-latency data to the base station.

In the embodiment shown in FIG. 95B, the low-latency data may be repeatedly transmitted in 2 or more slots to improve the transmission rate of the low-latency data. In this case, even when the terminal does not receive the low-latency data in the third slot, the terminal may receive the low-latency data in the next slot (e.g., the fourth slot), and transmit an HARQ response for the low-latency data to the base station.

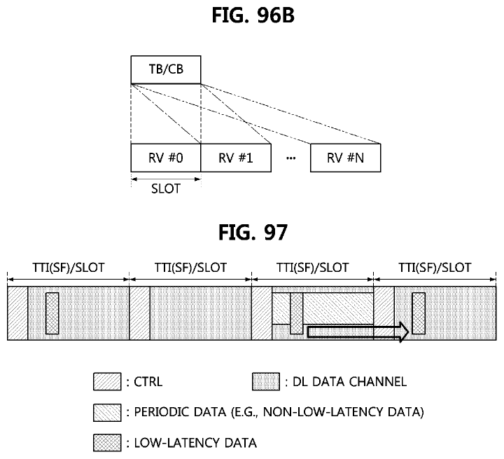

FIG. 96A is a conceptual diagram showing a first embodiment of a method for repeatedly transmitting data in a communication system, and FIG. 96B is a conceptual diagram showing a second embodiment of a method for repeatedly transmitting data in a communication system.

Referring to FIG. 96A, the same non-low-latency data (or, low-latency data) may be repeatedly transmitted. Here, each of TB and CB may be the same non-low-latency data (or, low-latency data). Referring to FIG. 96B, non-low-latency data (or, low-latency data) having different RVs may be transmitted.

Meanwhile, the terminal may transmit HARQ responses for the low-latency data and the non-low-latency data, respectively. When the data is repeatedly transmitted, the terminal may transmit an HARQ response to a recently received data. Alternatively, the terminal may transmit an HARQ response for data received in a slot in which transmission of low-latency data and non-low-latency data do not occur at the same time. Therefore, feedback of an unnecessary HARQ response may be prevented.

When data is repeatedly transmitted and 2 or more HARQ responses to the repeated data (e.g., HARQ responses for all data) are received from the terminal, the base station may determine that the data is successfully received at the terminal when one of the 2 or more HARQ responses is ACK. In this case, the base station may perform an operation for transmission of new data. On the other hand, when all the HARQ responses received from the terminal are NACKs, or when any HARQ response is not received from the terminal, the base station may perform a data retransmission procedure. When the transmission of the HARQ response for the downlink data is not required, the terminal may omit the transmission of the HARQ response for the received downlink data, and the base station may perform a transmission procedure of new downlink data without receiving the HARQ response for the downlink data.

FIG. 97 is a conceptual diagram showing a third embodiment of a method of transmitting non-low-latency data and low-latency data in a communication system.

Referring to FIG. 97, when transmission of low-latency data and transmission of non-low-latency data are required in the same slot #n, the low-latency data may be transmitted in the slot #(n+k) (e.g., a downlink data channel in the slot #(n+k)). That is, the low-latency data may not be transmitted in the slot #n. Here, n may be an integer equal to or greater than 0, and k may be an integer equal to or greater than 1. This method may be advantageously applied when there is a signal (e.g., a search signal, a reference signal, a synchronization signal, etc.) to be transmitted through a specific slot (e.g., a data channel in the specific slot).

Meanwhile, a processing latency from a resource allocation time point of non-low-latency data to a transmission time point of the non-low-latency data may be relatively long. On the other hand, a processing latency from a resource allocation time point of low-latency data to a transmission time point of the low-latency data may be relatively short. When the resource allocation time point of the non-low-latency data is earlier than the resource allocation time point of the low-latency data, the transmission of the non-low-latency data and the transmission of the low-latency data may be required in the same subframe (e.g., TTI, slot, or mini-slot).

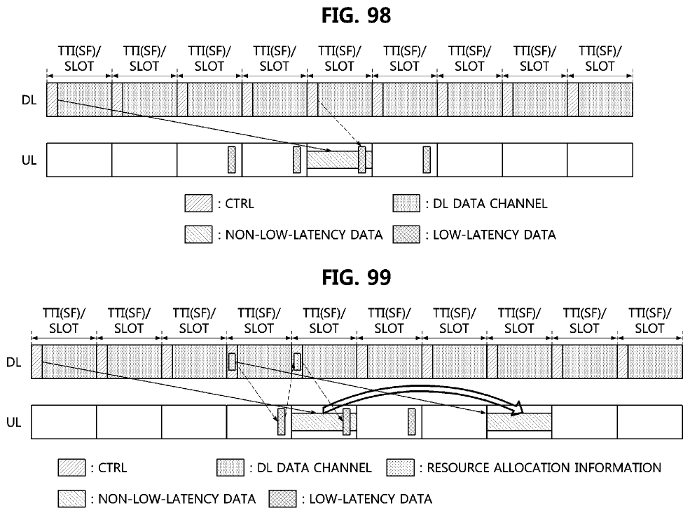

FIG. 98 is a conceptual diagram showing a second embodiment of a collision between transmission of non-low-latency data and transmission of low-latency data in a communication system.

Referring to FIG. 98, resource allocation information for non-low-latency data may be transmitted through a downlink control channel (CTRL) in the slot #n, and the resource allocation information may indicate uplink resources in the slot #(n+4). Here, n may be an integer equal to or greater than 0. Resource allocation information for low-latency data may be transmitted through a downlink control channel (CTRL) in the slot #(n+4), and the resource allocation information may indicate uplink resources in the slot #(n+4). That is, transmission of the resource allocation information for the low-latency data and transmission of the low-latency data according to the resource allocation information may be performed in one slot.

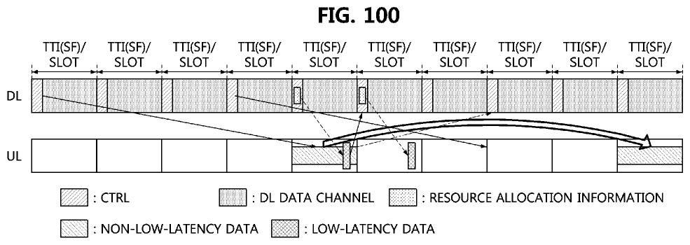

FIG. 99 is a conceptual diagram showing a fourth embodiment of a method of transmitting non-low-latency data and low-latency data in a communication system, and FIG. 100 is a conceptual diagram showing a fifth embodiment of a method of transmitting non-low-latency data and low-latency data in a communication system.

Referring to FIGS. 99 and 100, when transmission of non-low-latency data and transmission of low-latency data are required in the same slot, the non-low-latency data may be transmitted in another slot. That is, the non-low-latency data may not be transmitted with the low-latency data in the same slot. In this case, latency requirements of the low-latency data may be satisfied, and the collision between the transmission of the non-low-latency data and the transmission of the low-latency data may be eliminated.

For the delayed transmission of the non-low-latency data, the base station may transmit transmission delay information including information indicating that the transmission of the non-low-latency data is delayed and resource allocation information for the delayed non-low-latency data through a downlink control channel. The transmission delay information may be transmitted considering a processing latency of the non-low-latency data. When a transmission time point of the non-low-latency data is the slot #(n+4) in the case that the delay due to the transmission of the low-latency data does not occur, a transmission time point of the transmission delay information may be the slot #(n+3) or the slot #(n+4). The terminal having received the transmission delay information may identify that the transmission of the non-low-latency data is delayed, and may transmit the non-low latency data in a resource indicated by the transmission delay information (e.g., a resource in the slot #(n+7). Also, the non-low-latency data may be repeatedly transmitted a predetermined number of times.

When the transmission of the low-latency data is predicted or expected, the low-latency data and the non-low-latency data may be transmitted as in the embodiment shown in FIG. 99. On the other hand, when the transmission of the low-latency data is not predicted or expected, the low-latency data and the non-low-latency data may be transmitted as in the embodiment shown in FIG. 100.

Meanwhile, when transmission of uplink data is performed simultaneously by one or more terminals, the base station receiving the uplink data may determine that two or more uplink data exist in the same slot. In this case, the base station may not be able to distinguish between two or more uplink data received in the same slot. Therefore, a decoding operation on the two or more uplink data may be omitted. Alternatively, the base station may transmit resource allocation information for retransmission of the low-latency data and the non-low-latency data to the terminal. In this case, a latency of the retransmission procedure of the non-low-latency data may be reduced.

Meanwhile, when the uplink data is successfully received, the base station may transmit an HARQ response (e.g., ACK) for the uplink data to the terminal and perform a procedure for transmitting new data.

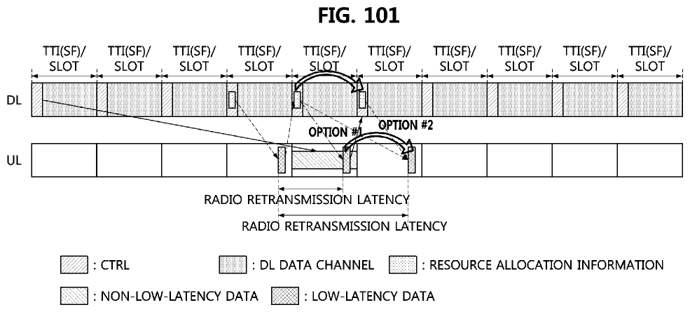

FIG. 101 is a conceptual diagram showing a sixth embodiment of a method of transmitting non-low-latency data and low-latency data in a communication system.

Referring to FIG. 101, when transmission of low-latency data and transmission of non-low-latency data are required in the same slot #(n+4), the low-latency data may not be transmitted in the slot #(n+4). In this case, the low-latency data may be transmitted in a slot (e.g., the slot #(n+5)) after the slot #(n+4). The base station may transmit resource allocation information for the delayed low-latency data to the terminal through a downlink control channel. The terminal may identify that the transmission of the low-latency data is delayed by the resource allocation information received from the base station, and transmit the low-latency data to the base station through a resource indicated by the resource allocation information (e.g., a resource in the slot #(n+5)).

Meanwhile, discontinuous reception (DRX) operation may be supported for power saving.

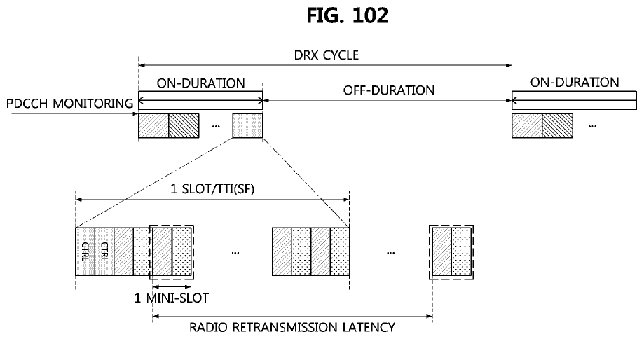

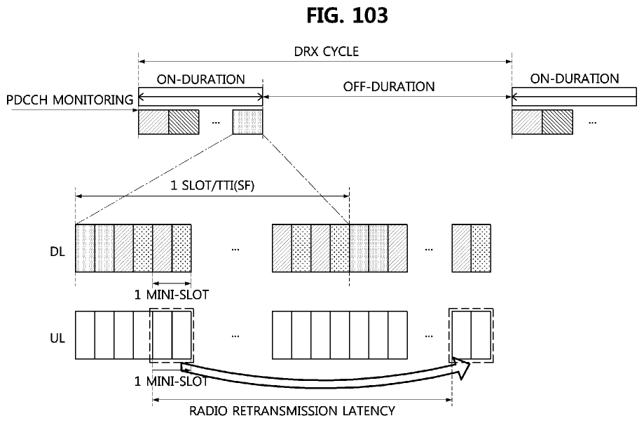

FIG. 102 is a conceptual diagram showing a first embodiment of a downlink communication method according to a DRX cycle in a communication system, and FIG. 103 is a conceptual diagram showing a first embodiment of an uplink communication method according to a DRX cycle in a communication system.

Referring to FIGS. 102 and 103, transmission of downlink/uplink data may be performed in an on-duration according to a DRX cycle. In an off-duration according to the DRX cycle, the terminal may operate in a power saving mode. The off-duration may be referred to as an ‘opportunity for DRX.’ When the data transmission is not complete within the on-duration, a transmission method for improving a transmission rate of the data (e.g., low-latency data) may be required. For example, when the data transmission is not completed within the on-duration, the following operations may be performed.
Operation 1: The communication node (e.g., base station or terminal) may terminate the data transmission when the on-duration ends regardless of a success or failure of the data transmission.
Operation 2: The on-duration may be extended when the data transmission is not completed successfully within the on-duration. The communication node (e.g., base station or terminal) may transmit data within the extended on-duration. Here, the on-duration may be extended to a completion time of the data transmission, a preconfigured time, or a preconfigured retransmission time (e.g., the number of retransmissions or expiration of a timer).

Meanwhile, a time delay may occur between a resource allocation operation for transmitting uplink data and a transmission operation of the uplink data. For example, the resource allocation information for transmission of the uplink data may be transmitted in the on-duration, and an uplink resource indicated by the resource allocation information may be located in the off-duration. In this case, the on-duration may be extended until an end time of the uplink resource indicated by the resource allocation information. Alternatively, when the uplink resource indicated by the resource allocation information is located in the off-duration, the uplink data may not be transmitted.

When resources for transmission of the uplink data are allocated, if the uplink resources are expected to be allocated in the off-duration, the base station may not allocate the uplink resources in the off-duration, and allocate the uplink resource in the next on-duration.

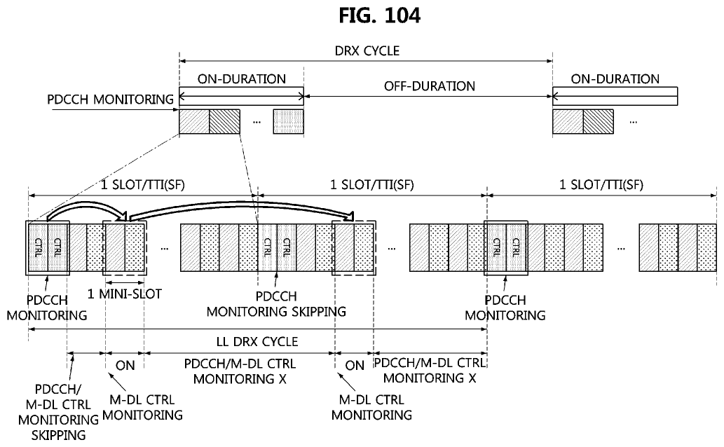

FIG. 104 is a conceptual diagram showing a second embodiment of a downlink communication method according to a DRX cycle in a communication system.

Referring to FIG. 104, downlink data may be transmitted according to a low-latency (LL) DRX cycle. Here, the downlink data may be transmitted on a min-slot basis, and a conventional DRX cycle may be referred to as a ‘normal DRX cycle.’ The operations of the base station and the terminal in the downlink communication may be as follows.
Step 1: The base station may transmit a downlink control channel (CTRL) including resource allocation information for transmission of downlink data in an on-duration according to a DRX cycle. The terminal may perform a monitoring operation in an on-duration according to the DRX cycle to receive the downlink control channel (CTRL). When the downlink control channel (CTRL) is received, the terminal may identify the resource allocation information included in the downlink control channel (CTRL).

[symbol] The resource allocation information may indicate a mini-slot used for transmission of the downlink data, and the mini-slot indicated by the resource allocation information may be located on an on-duration according to an LL DRX cycle. The terminal may perform a monitoring operation in the mini-slot indicated by the resource allocation information to receive the downlink data channel.
Step 2: When the mini-slot includes a downlink control channel (M-DL CTRL), the base station may transmit detailed information (e.g., transmission characteristic information) for transmission of downlink data through the downlink control channel (M-DL CTRL) in the mini-slot indicated by the resource allocation information. The terminal may perform a monitoring operation in an on-duration according to the LL DRX cycle indicated by the resource allocation information received in the step 1 to receive the downlink control channel (M-DL CTRL). The terminal may obtain the detailed information for transmission of downlink data through the downlink control channel (M-DL CTRL) in the mini-slot. The terminal may receive the downlink data (e.g., low-latency data) from the base station based on the information obtained through at least one of the downlink control channel (CTRL) and the downlink control channel (M-DL CTRL).

[symbol] The terminal may stop the monitoring operation for the reception of the downlink control channel and the downlink data channel until the next on-duration in the case where the on-duration according to the LL DRX cycle is terminated, and perform the step 2 in the next on-duration.

[symbol] When the LL DRX cycle is terminated but the on-duration according to the normal DRX cycle is not terminated, the terminal may perform the step 1.
The above-described steps may be performed even when the normal DRX cycle (e.g., power saving mode) is not supported. When the data retransmission procedure is performed, the location of the mini-slot in which data retransmission is performed may be determined according to a preconfigured interval. For example, the location of the mini-slot in which data retransmission is performed may be determined in consideration of the number of retransmissions or a retransmission timer. In this case, the on-duration according to the LL DRX cycle or the LL DRX cycle may be inferred based on the preconfigured interval, the number of retransmissions, or the retransmission timer.

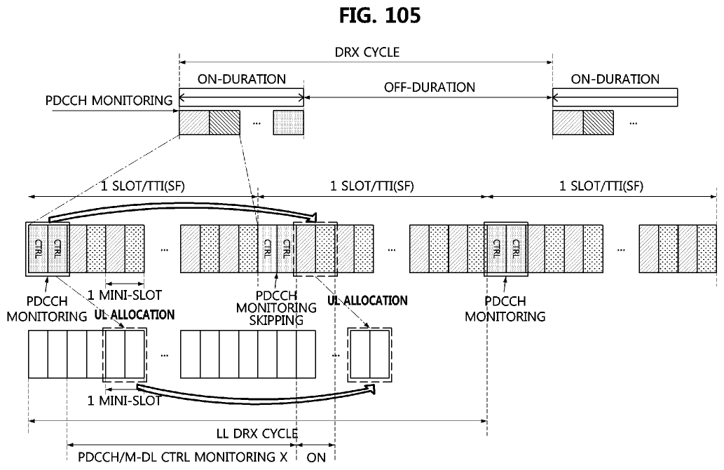

FIG. 105 is a conceptual diagram showing a second embodiment of an uplink communication method according to a DRX cycle in a communication system.

Referring to FIG. 105, the base station may transmit resource allocation information for transmission of uplink data in an on-duration according to an LL DRX cycle, and the terminal receiving the resource allocation information may transmit uplink data in a mini-slot indicated by the resource allocation information. The resource allocation information for transmission of uplink data may be transmitted through a downlink control channel (CTRL), a downlink control channel (M-DL CTRL) in a mini-slot, or a downlink data channel (PDCCH). In this case, the transmission resource of the uplink data and the retransmission timing of the uplink data may be efficiently used. The operations of the base station and the terminal in the uplink communication may be as follows.
Step 1: The base station may transmit a downlink control channel (CTRL) including resource allocation information for transmission of uplink data in an on-duration according to a DRX cycle. The terminal may perform a monitoring operation in an on-duration according to the DRX cycle to receive the downlink control channel (CTRL). When the downlink control channel (CTRL) is received, the terminal may identify the resource allocation information included in the downlink control channel (CTRL).

[symbol] The resource allocation information may indicate a mini-slot used for transmission of the uplink data, and the mini-slot indicated by the resource allocation information may be located on an on-duration according to an LL DRX cycle. The terminal may perform a monitoring operation in the mini-slot indicated by the resource allocation information to receive an uplink data channel.
Step 2: When the mini-slot includes a downlink control channel (M-DL CTRL), the base station may transmit detailed information (e.g., transmission characteristic information) for transmission of the uplink data through the downlink control channel (M-DL CTRL) in the mini-slot indicated by the resource allocation information. The terminal may perform a monitoring operation in an on-duration according to the LL DRX cycle indicated by the resource allocation information received in the step 1 to receive the downlink control channel (M-DL CTRL). The terminal may obtain the detailed information for transmission of the uplink data through the downlink control channel (M-DL CTRL) in the mini-slot. The terminal may transmit the uplink data (e.g., low-latency data) based on the information obtained through at least one of the downlink control channel (CTRL) and the downlink control channel (M-DL CTRL) in the mini-slot.

[symbol] The terminal may stop the monitoring operation for the reception of the downlink control channel until the next on-duration in the case where the on-duration according to the LL DRX cycle is terminated, and perform the step 2 in the next on-duration.

[symbol] When the LL DRX cycle is terminated but the on-duration according to the normal DRX cycle is not terminated, the terminal may perform the step 1.
The above-described steps may be performed even when the normal DRX cycle (e.g., power saving mode) is not supported. When the data retransmission procedure is performed, the location of the mini-slot in which data retransmission is performed may be determined according to a preconfigured interval. For example, the location of the mini-slot in which data retransmission is performed may be determined in consideration of the number of retransmissions or a retransmission timer. Also, a mini-slot for transmission of an HARQ response may be configured. In this case, the on-duration according to the LL DRX cycle or the LL DRX cycle may be inferred based on the preconfigured interval, the number of retransmissions, the retransmission timer, or the transmission time point of the HARQ response.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method performed by a terminal in a communication system, the operation method comprising:
determining a number of symbols used for transmission in a slot #n;
comparing the number of symbols with a threshold; and
when the number of symbols is equal to or larger than the threshold, performing a transmission in a duration corresponding to the number of symbols, wherein
when the number of symbols is smaller than the threshold, the transmission is not performed in the duration corresponding to the number of symbols, and
n is an integer equal to or greater than 0.

2. The operation method according to claim 1, further comprising:
receiving, from a base station, configuration information of the slot #n, wherein
the configuration information includes the threshold used to compare with the number of symbols, and a redundancy version (RV) which is used for performing re-transmission.

3. The operation method according to claim 2, wherein
the configuration information further includes configuration information of a plurality of time periods which is included in the slot #n, wherein
the plurality of time periods includes a first time period and a second time period,
a number of symbols included in the first time period is equal to or larger than the threshold, and
a number of symbols included in the second time period is less than the threshold.

4. The operation method according to claim 1, wherein the transmission is transmission of uplink control information (UCI) or uplink data.

5. The operation method according to claim 4, wherein when the terminal receives downlink data from a base station, the UCI includes at least one of channel measurement information, a scheduling request (SR), and a hybrid automatic repeat request (HARQ) response for the downlink data.

6. The operation method according to claim 4 further comprising:
receiving information indicating retransmission of the uplink data from a base station; and
when a number of symbols included in a slot #n+k is equal to or larger than the threshold, the terminal performing re-transmission of the uplink data in a duration corresponding to the number of symbols included in the slot #n+k, wherein
k is an integer equal to or greater than 1.

7. An operation method performed by a base station in a communication system, the operation method comprising:
transmitting, to a terminal, configuration information of a slot #n including a threshold which is used to compare with a number of symbols; and
when the number of symbols in a slot #n is equal to or larger than the threshold, performing a reception operation in a duration corresponding to the number of symbols, wherein
when the number of symbols in the slot #n is smaller than the threshold, uplink transmission is performed in the duration corresponding to the number of symbols is not expected, and
n is an integer equal to or greater than 0.

8. The operation method according to claim 7, wherein
the configuration information further includes configuration information of a plurality of time periods which is included in the slot #n, wherein
the plurality of time periods includes a first time period and a second time period,
a number of symbols included in the first time period is equal to or larger than the threshold, and
a number of symbols included in the second time period is less than the threshold.

9. The operation method according to claim 7, wherein the reception operation is a reception operation of uplink control information (UCI) or uplink data.

10. The operation method according to claim 9, wherein when the base station transmits downlink data to the terminal, the UCI includes at least one of channel measurement information, a scheduling request (SR) and a hybrid automatic repeat request (HARQ) for the downlink data.

11. The operation method according to claim 9, further comprising:
transmitting information indicating retransmission of the uplink data to the terminal; and
when a number of symbols included in a slot #n+k is equal to or larger than the threshold, performing a reception operation of re-transmitted uplink data in a duration corresponding to the number of symbols in the slot #n+k, wherein
the reception operation of the re-transmitted uplink data is performed based on redundancy version (RV) which is included in the configuration information, and
k is an integer equal to or greater than 1.
